(19) United States
(12) Patent Application Publication
(10) Pub. No.: US 2004/0103013 A1
(43) Pub. Date: May 27, 2004

(54) Optimal scenario forecasting, risk sharing, and risk trading

(76) Inventor: Joel Jameson, Los Altos, CA (US)

Correspondence Address: ADAM K. SACHAROFF, MUCH SHELIST FREED DENENBERG AMENT&RUBENSTEIN,PC, 191 N. WACKER DRIVE, SUITE 1800, CHICAGO, IL, 60606-1615, US

(21) Appl. No.: 10/696,100

(22) Filed: Oct. 29, 2003

Related U.S. Application Data
(60) Provisional application No. 60/429,175, filed on Nov. 25, 2002.

(51) Int. Cl. G06F 17/60

(52) U.S. Cl. 705/7

(57) ABSTRACT

An integrated and unified method of statistical-like analysis, scenario forecasting, risking sharing, and risk trading is presented. Variates explanatory of response variates are identified in terms of the “value of the knowing.” Such a value can be direct economic value. Probabilistic scenarios are generated by multi-dimensionally weighting a dataset. Weights are specified using Exogenous-Forecasted Distributions (EFDs). Weighting is done by a highly improved Iterative Proportional Fitting Procedure (IPFP) that exponentially reduces computer storage and calculations requirements. A probabilistic nearest neighbor procedure is provided to yield fine-grain pinpoint scenarios. A method to evaluate forecasters is presented; this method addresses game-theory issues. All of this leads to the final component: a new method of sharing and trading risk, which both directly integrates with the above and yields contingent risk-contracts that better serve all parties.

### CROSS REFERENCE TO RELATED APPLICATIONS

The present application claims the benefit of Provisional Patent Application, Optimal Scenario Forecasting, Serial No. 60/415,306 filed on Sep. 30, 2002.

The present application claims the benefit of Provisional Patent Application, Optimal Scenario Forecasting, Serial No. 60/429,175 filed on Nov. 25, 2002.

The present application claims the benefit of Provisional Patent Application, Optimal Scenario Forecasting, Risk Sharing, and Risk Trading, Ser. No. ______ filed on Oct. 27, 2003.

By reference, issued U.S. Pat. No. 6,032,123, Method and Apparatus for Allocating, Costing, and Pricing Organizational Resources, is hereby incorporated. This reference is termed here as Patent '123.

By reference, issued U.S. Pat. Nos. 6,219,649 and 6,625,577, Method and Apparatus for Allocating Resources in the Presence of Uncertainty, are hereby incorporated. These references are termed here as Patents '649 and '577.

By reference, the following documents, filed with the US Patent and Trademark Office under the Document Disclosure Program, are hereby incorporated:

| | | | Receiving |
|---|---|---|---|
| Title | Number | Date | Location |
| Various Conceptions I | SV01446 | Nov. 1, 2001 | Sc[i]3 |
| Various Conceptions II | SV01148 | Nov. 2, 2001 | Sc[i]3 |
| Various Conceptions III | 504320 | Jan. 19, 2002 | USPTO |
| Various Conceptions IV | 505056 | Jan. 31, 2002 | USPTO |
| Various Conceptions V | 505269 | Feb. 11, 2002 | USPTO |

### BACKGROUND TECHNICAL FIELD

This invention relates to statistical analysis and risk sharing, in particular methods and computer systems for both discovering correlations and forecasting, and for both sharing and trading risks.

### BACKGROUND DESCRIPTION OF PRIOR ART

Arguably, the essence of scientific and technological development is to quantitatively identify correlative (associative) relationships in nature, in man, and between man and nature, and then to capitalize on such discovered relationships. To this end, mathematics, statistics, computer science, and other disciplines have developed numerous quantitative techniques for discovering correlations and making forecasts.

The following outline will be used for reviewing the prior-art:

I. Discovering Correlations and Making Forecasts

I.A. Mathematical Curve Fitting

I.B. Classical Statistics

I.B.1. Regression Analysis

I.B.2. Logit Analysis

I.B.3. Analysis-of-Variance

I.B.4. Contingency Table Analysis

I.B.4.1 Two Primary Issues

I.B.4.2 Iterative Proportional Fitting Procedure (IPFP)

I.B.5. Direct Correlations

I.C. Bayesian Statistics

I.D. Computer Science

I.D.1. Neural Networks

I.D.2. Classification Trees

I.D.3. Nearest-neighbor

I.D.4. Graphic Models

I.D.5. Expert Systems

I.D.6. Computer Simulation/Scenario Optimization

II. Risk Sharing and Risk Trading

III. Concluding Remarks

I. Discovering Correlations and Making Forecasts

I.A. Mathematical Curve Fitting

Mathematical curve fitting is arguably the basis underlying most techniques for discovering correlations and making forecasts. It seeks to fit a curve to empirical data. A function fmc is specified:

ymc=fmc(xmc₁, xmc2, xmc₃, . . . ) (1.0)

Empirical data is then used to determine fmc coefficients (implicit in Equation 1.0) so that deviations between the actual empirical ymc values and the values yielded by fmc are minimized. Variates xmc₁, xmc₂, xmc₃, . . . (xmcs) are synonymously termed “explanatory”, “independent”, “stimulus”, or “domain” variates while variate ymc is synonymously termed “response”, “dependent” or “range.” Ordinary Least Squares is the most commonly employed mathematical curve fitting technique for fitting Equation 1.0. (The formulation of Equation 1.0 is the most typical. However, other formulations are possible and what is said here applies to these other formulations as well. These other formulations include:

1. fmc having no parameters

2. ymc and xmc₁ being the same variate

3. fmc relating and comparing multiple xmcs and yielding a ymc that reflects the relating and comparing

Sometimes, causal relations between variates are indicated by calling some “explanatory” and others “response”; sometimes causal relationships are expressly not presumed.)

Curve fitting, however, has several basic Mathematical Curve Fitting Problems (MCFPs):

1. Equation 1.0 needs to be correctly specified. If the Equation is not correctly specified, then errors and distortions occur can occur. An incorrect specification contributes to curve fitting problem 2, discussed next.

2. There is an assumption that for each combination of specific xmc₁, xmc₂, xmc₃, . . . values, there is a unique ymc value and that non-unique ymc values occur only because of errors. Consequently, for example, applying quadric curve fitting to the nineteen points that clearly form an ellipse-like pattern in FIG. 1A yields a curve like Curve 103, which straddles both high and low ymc values. The fitting ignores that for all xmc₁ values, multiple ymc values occur.

3. There is a loss of information. This is the converse of MCFP #2 and is shown in FIG. 1B. Though Curve (Line) 105 approximates the data reasonably well, some of the character of the data is lost by focusing on the Curve rather than the raw data points.

4. There is the well-known Curse of Dimensionality. As the number of explanatory variates increases, the number of possible functional forms for Equation 1.0 increases exponentially, ever-larger empirical data sets are needed, and accurately determining coefficients can become impossible. As a result, one is frequently forced to use only first-order linearfmc functional forms, but at a cost of ignoring possibly important non-linear relationships.

5. There is the assumption that fitting Equation 1.0 and minimizing deviations represents what is important. Stated in reverse, Equation 1.0 and minimizing deviations can be overly abstracted from a practical problem. Though prima facie minimizing deviations makes sense, the deviations in themselves are not necessarily correlated nor linked with the costs and benefits of using a properly or improperly fitted curve.

I.B. Classical Statistics

Much of classical statistics can be thought of as building upon mathematical curve fitting as described above. So, for example, simple mean calculations can be considered as estimating a coefficient for Equation 1.0, wherein ymc and xmc₁ are the same, and fmc yields the mean. Multivariate statistical techniques can be thought of as working with one or more versions of Equation 1.0 simultaneously to estimate coefficients. As a consequence, most statistical techniques, to some degree, are plagued by the above five MCFPs.

Statistical significance is the essential concept of statistics. It assumes that empirical data derives from processes entailing randomly drawing values from statistical distributions. Given these assumptions, data, and fitted curves, probabilities of obtained results are calculated. If the probabilities are sufficiently small, then the result is deemed statistically significant.

In general, there are three Basic Statistical Problems (BSPs):

1. The difference between statistical and practical significance. A result that is statistically significant can be practically insignificant. And conversely, a result that is statistically insignificant can be practically significant.

2. The normal distribution assumption. In spite of the Central Limit Theorem, empirical data is frequently not normally distributed, as is particularly the case with financial transactions data regarding publicly-traded securities. Further, for the normal distribution assumption to be applicable, frequently large—and thus costly—sample sizes are required.

3. The intervening structure between data and people. Arguably, a purpose of statistical analysis is to refine disparate data into forms that can be more easily comprehended and used. But such refinement has a cost: loss of information.

So, for instance, given a data set regarding a single variant, simply viewing a table of numbers provides some insight. Calculating the mean and variance (a very simple statistical calculation) yields a simplification—but at a cost of imposing the normal distribution as an intervening structure.

This problem is very similar to MCFP #3: loss of information discussed above, but also applies to the advances that statistics attempts to enrich mathematical curve fitting.

FIG. 2 depicts relative aspects of the most popular statistical techniques for handling explanatory and response variables:

1. Regression Analysis is used when both the response and explanatory variables are continuous.

2. Logit is used when the response variable is discrete and the explanatory variate(s) is continuous.

3. Analysis-of-variance (and variates such as Analysis-of-Covariance) is used when the response variate is continuous and the explanatory variate(s) is discrete.

4. Contingency Table Analysis is used when both the response and explanatory variables are discrete. Designating variables as response and explanatory is not required and is usually not done in Contingency Table Analysis.

One problem that becomes immediately apparent by a consideration of FIG. 2 is the lack of unification. Each of these four types of statistical techniques will be discussed in turn.

I.B.1. Regression Analysis

Regression Analysis is plagued by all the MCFPs and BSPs discussed above. A particular problem, moreover, with regression analysis is the assumption that explanatory variates are known with certainty.

Another problem with Regression Analysis is deciding between different formulations of Equation 1.0: accuracy in both estimated coefficients and significance tests requires that Equation 1.0 be correct. An integral-calculus version of the G2 Formula (explained below) is sometimes used to select the best fitting formulation of Equation 1.0 (a.k.a. the model selection problem), but does so at a cost of undermining the legitimacy of the significance tests.

To address MCFP #3—loss of information—various types of ARCH (autoregressive conditionally heteroscedastic) techniques have been developed to approximate a changing variance about a fitted curve. However, such techniques fail to represent all the lost information. So, for example, consider Curve 105 in FIG. 1B as a first order approximation of the data. ARCH's second order approximation would suggest that dispersion about Curve 105 increases in the mid-range of xmc₁. However, it would not indicate that data was above the curve and in alignment.

Regression Analysis is arguably the most mathematically-general statistical technique, and is the basis of all Multivariate Statistical Models. Consequently, it can mechanically handle cases in which either or both the response or explanatory variates are discrete. However, the resulting statistical significances are of questionable validity. (Because both Factor Analysis and Discriminate Analysis are so similar to Regression Analysis, they are not discussed here.)

I.B.2. Logit Analysis

Because Logit Analysis is actually a form of Regression Analysis, it inherits the problems of Regression Analysis discussed above. Further, Logit requires a questionable variate transform, which can result in inaccurate estimates when probabilities are particularly extreme.

I.B.3. Analysis-of-Variance

Analysis-of-Variance (and variates such as Analysis-of-Covariance) is plagued by many of the problems mentioned above. Rather than specifying an Equation 1.0, one must judicially split and re-split sample data and, as the process continues, the Curse of Dimensionality begins to manifest. The three BSPs are also present.

I.B.4. Contingency Table Analysis

FIG. 3, Table 301, will be used as an example to discuss Contingency Table Analysis. This table happens to have two dimensions: Gender and Marital-Status. Each cell contains the frequency that each Gender and Marital-Status pair occur. (The rectangles in FIG. 3. are abstract groupings of implicit cells that contain data.) Contingent probabilities can be obtained by scanning across (down) individual rows (columns) and normalizing the sum of cell counts to total to one. Such calculations, however, are a minor aspect of Contingency Table Analysis. Instead, the focus is on two issues.

I.B.4.1 Two Primary Issues

The first issue is significance testing. Given a contingency table and the marginal totals (mTM, gLM), a determination as to whether the cell counts are statistically varied is made. This in turn suggests whether interaction between the variates (Gender/MaritalStatus) exists.

The statistical test most frequently used for this purpose is the Chi Square test. Another test entails computing the G2 statistic, which is defined, for the two dimensional case of FIG. 3, as:

G2=ΣΣc_{i, j}*Log(c_{i, j}/cc_{i, j}) 2.0

where

c_{i,j}=original observed cell probability.

cc_{i,j}=estimated cell probability. Sometimes simply based upon the mathematical product of the corresponding marginal probabilities.

ΣΣc_{i, j}=ΣΣcc_{i, j}=1.0

A logarithmic base of e.

0 log (0)=0

G2 here will refer specifically to Equation 2.0. However, it should be noted that this G2 statistic is based upon Bayesian Statistics (to be discussed) and is part of a class of Information-Theory-based formulas for comparing statistical distributions. Other variants include:

ΣΣc_{i, j}*Log(cc_{i, j}/c_{i, j})

ΣΣcc_{i, j}*Log(c_{i, j}/cc_{i, j})

ΣΣcc_{i, j}*Log(cc_{i, j}/c_{i, j})

and still further variants include using different logarithm bases and algebraic permutations and combinations of components of these four formulas. (An integral-calculus version of the G2 statistic is sometimes used to decide between regression models. See above.)

The main problem with using both Chi Square and G2 for significance testing is that both require sizeable cell counts.

The second issue of focus for Contingency Table Analysis is estimating marginal coefficients to create hierarchical-log-linear models that yield estimated cell frequencies as a function of the mathematical-product of marginal coefficients. The Newton-Ralphson Algorithm (NRA) is a genetic technique that is sometimes used to estimate such marginal coefficients. NRA, however, is suitable for only small problems. For larger problems, the Iterative Proportional Fitting Procedure (IPFP) is used.

I.B.4.2 Iterative Proportional Fitting Procedure (IPFP)

The IPFP was originally developed to proportion survey data to align with census data. Suppose, for example, a survey is completed and it is discovered that three variates (dimensions)—perhaps gender, marital status, and number of children—have proportions that are not in alignment with census data. (See FIG. 4.) The goal is to obtain weights for each Gender/Marital-status/Number-of-children combination, so that when the weights are applied to the survey data, the proportions match the census data. This is done as follows:

1. Populate a contingency table or cube PFHC (Proportional Fitting Hyper Cube) with Gender/Marital-status/Number-of-children combination counts.

2. Place ones in each hpWeight (hyper-plane weight) vector.

3. Place target proportions in appropriate tarProp vectors of dMargin (dimension margin).

4. Perform the IPFP:

while(not converged, i.e. tarProp not equal to curProp

for any of the three dimensions)

{
//Proportion Gender
for( i=0; i<2; i++)

dMargin[0].curProp[i] = 0;

// start Tallying Phase

for( i=0; i< number of gender categories; i++)

for( j=0; j<number of marital status categories; j++)

for( k=0; k<number of children categories; k++)

dMargin[0].curProp[i] =

dMargin[0].curProp[i] +
PFHC[i][j][k] *
dMargin[0].hpWeight[i] *
dMargin[1].hpWeight[j] *
dMargin[2].hpWeight[k] *

// end Tallying Phase

sum = 0;
for( i=0; i< number of gender categories; i++)

sum = sum + dMargin[0].curProp[i];

for( i=0; i< number of gender categories; i++)

| { | |
|---|---|
| dMargin[0].curProp[ i] = | dMargin[0].curProp[ i]/sum; |
| dMargin[0].hpWeight[i] = | dMargin[0].hpWeight[i] * |
| | ((dMargin[0].tarProp[ i])/ |
| | ( dMargin[0].curProp[ i])); |
| } | |

//Proportion marital status

// analogous to proportion Gender

//Proportion number of children

// analogous to proportion Gender

}

5. Weight respondents in cell:

PFHC[i] [j] [k]

By:

dMargin[0].hpWeight[i]*

dMargin[1].hpweight[j]*

dMargin[2].hpweight[k]

The Tallying Phase requires the most CPU (central processing unit) computer time and is the real constraint or bottleneck.

There are many variations on the IPFP shown above. Some entail updating a second PFHC with the result of multiplying the hp Weights and then tallying curProp by scanning the second PFHC. Others entail tallying curProps and updating all hp Weights simultaneously. For hierarchical log-linear model coefficient estimation, the PFHC is loaded with ones, and the tarProps are set equal to frequencies of the original data. (The memory names, PFHC, dMargin, tarProp, curProp, and hpWeight are being coined here.)

In the IPFP, there is a definite logic to serially cycling through each variant or dimension: during each cycle, the oldest dMargin.hp Weight is always being updated.

As an example of IPFP, in the mid 1980s, the IPFP was used in a major project sponsored by the Electrical Power Research Institute of Palo Alto, Calif., U.S.A. A national survey of several hundred residential customers was conducted. Several choice-models were developed. Raw survey data, together with the choice-models, was included in a custom developed software package for use by electric utility companies. An Analyst using the MS-DOS based software package:

1. selected up to four questions (dimensions) from the questionnaire

2. entered target proportions (that were reflective of the utility company's customer base) for each answer to each selected question (dimension)

3. selected a choice-model

4. entered choice-model parameters

The software, in turn, (the first four steps below were done internally in the software):

1. generated a contingency table based upon the selected questions

2. applied the IPFP to obtains weights

3. weighted each respondent

4. executed the selected choice model, which was applied to each respondent individually

5. reported aggregate results

The first major problem with the IPFP is its requirement for both computer memory (storage) and CPU time. Common belief says that such requirements are exponential: required memory is greater than the mathematical product of the number of levels of each dimension. The CPU time requirements are also exponential, since the CPU needs to fetch and work with all cells. As stated by Jirousek and Preucil in their 1995 article On the effective implementation of the iterative proportional fitting procedure:

As the space and time complexity of this procedure [IPFP] is exponential, it is no wonder that existing programs cannot be applied to problems of more than 8 or 9 dimensions.

Prior to Jirousek and Preucil's article, in a 1986 article, Denteneer and Verbeek proposed using look-ups and offsets to reduce the memory and CPU requirements of the IPFP. However, their techniques become increasingly cumbersome and less worthwhile as the number of dimensions increases. Furthermore, their techniques are predicated upon zero or one cell counts in the PFHC.

Also prior to Jirousek and Preucil's article, in a 1989 article, Malvestuto offered strategies for decomposed IPFP problems. These strategies, however, are predicated upon finding redundant, isolated, and independent dimensions. As the number of dimensions increases, this becomes increasingly difficult and unlikely. Dimensional independence can be imposed, but at the cost of distorting the final results. Subsequent to Malvestuto's article, his insights have been refined, yet the fundamental problems have not been addressed.

Besides memory and CPU requirements, another major problem with the IPFP is that specified target marginals (tarProp) and cell counts must be jointly consistent, because otherwise, the IPFP will fail to converge. If the procedure were mechancially followed when convergence is not possible, then the last dimension to be weighted will dominate the overall weighting results. All known uses of the IPFP are subjected to such dominance.

The final problem with the IPFP is that it does not suggest which variates or dimensions to use for weighting.

In conclusion, though some strategies have been developed to improve the IPFP, requirements for computer memory, CPU time, and internal consistency are major limitations.

I.B.5. Direct Correlations

The above four statistical techniques require identification of explanatory and response variates. Correlation Analysis seeks to find correlations and associations in data without distinguishing between response and explanatory variates. For continuous variates, it is very similar to Regression Analysis and it has all the same MCFPs and BSPs. For discrete variates, it focuses on monotonic rank orderings without regard to magnitudes.

As previously mentioned, large sample sizes are required for many statistical techniques that rely upon the normal distribution. To mitigate this problem, a computer simulation technique called the Bootstrap was developed. It works by using intensive re-sampling to generate a distribution for a statistic that is of interest, and then using the generated distribution to test significance. Its sole focus has been to help ameliorate problems with small samples.

I.C. Bayesian Statistics

The statistical discussion thus far has focused on what is usually termed Classical Statistics, which was first developed about a hundred years ago. Prior to Classical Statistics and about three-hundred years ago, Bayesian Statistics was developed. Bayesian techniques have recently experienced a resurgence, partly because they circumvent issues regarding significance testing.

Bayesian Statistics work by initially positing a prior distribution based upon prior knowledge, old data, past experience, and intuition. Observational data is then applied as probabilistic conditionals or constraints to modify and update this prior distribution. The resulting distribution is called the posterior distribution and is the distribution used for decision-making. One posterior distribution can be the prior distribution for yet another updating based upon yet still additional data. There are two major weaknesses with this approach:

1. To posit a prior distribution requires extensive and intimate knowledge of many applicable probabilities and conditional probabilities that accurately characterize the case at hand.

2. Computation of posterior distributions based upon prior distributions and new data can quickly become mathematically and computationally intractable, if not impossible.

I.D. Computer Science

Apart from statistics, computer science, as a separate field of study, has its own approaches for discovering correlations and making forecasts. To help explain computer science techniques, two variates will be used here: The explanatory variate will be xCS and the response variate will beyCS. A third variate qCS will also be used. (These variates may be vectors with multiple values.)

I.D.1. Neural Networks

Neural networks essentially work by using the mathematical and statistical curve fitting described above in a layered fashion. Multiple curves are estimated. A single xCS and several curves determine several values, which with other curves determine other values, etc., until a value for yCS is obtained. There are two problems with this approach. First it is very sensitive to training data. Second, once a network has been trained, its logic is incomprehensible.

I.D.2. Classification Trees

Classification Tree techniques use data to build decision trees and then use the resulting decision trees for classification. Initially, they split a dataset into two or more sub-samples. Each split attempts maximum discrimination between the sub-samples. There are many criteria for splitting, some of which are related to the Information Theory formulas discussed above. Some criteria entail scoring classification accuracy, wherein there is penalty for misclassification. Once a split is made, the process is repeatedly applied to each subsample, until there are a small number of data points in each sub-sample. (Each split can be thought of as drawing a hyper-plane segment through the space spanned by the data points.) Once the tree is built, to make a classification entails traversing the tree and at each node determining the subsequent node depending upon node splitting dictates and xCS particulars. There are several problems with this approach:

1. Unable to handle incomplete xCS data when performing a classification.

2. Requires a varying sequence of data that is dependent upon xCS particulars.

3. Easily overwhelmed by sharpness-of-split, whereby a tiny change in xCS can result is a drastically different yCS.

4. Yields single certain classifications, as opposed to multiple probabilistic classifications.

5. Lack of a statistical test.

6. Lack of an aggregate valuation of explaintory variates.

I.D.3. Nearest-Neighbor

Nearest-neighbor is a computer science technique for reasoning by association. Given an xCS, yCS is determined by finding data points (xCSData) that are near xCS and then concluding that yCS for xCS would be analogous with the xCSDatas' yCSData. There are two problems with this approach:

1. The identified points (xCSData) are each considered equally likely to be the nearest neighbor. (One could weight the points depending on the distance from xCS, but such a weighting is somewhat arbitrary.)

2. The identified points (xCSData) may be from an outdated database. Massive updating of the database is likely very expensive—but so are inaccurate estimates of yCS.

I.D.4. Graphic Models

Graphic Models both help visualize data and forecast yCS given xCS. They help people visualize data by being displayed on computer screens. They are really networks of cause and effect links and model how and if one variate changes other variates are affected. Such links are determined using the techniques described above. They, however, have three problems:

1. Because they may impose structure and relationships between linked variates, the relationship between two distantly linked variates may be distorted by errors that accumulate over the distance. In other words, using two fitted curves in succession: one curve that models the relationship between xCS and qCS, and another that models the relationship between qCS and yCS, is far less accurate than using a fitted-curve that models the relationship between xCS and yCS directly.

2. Because of the physical 3-D limitations of the world, Graphic models have severe limitations on how much they can show: Frequently, each node/variate is allowed only two states, and there are serious limitations on showing all possible nodal connections.

3. Because they employ the above statistical and mathematical curve fitting techniques, they suffer from the deficiencies of those techniques.

I.D.5. Expert Systems

Because expert systems employ the above techniques, they too suffer from the deficiencies of those techniques. More importantly, however, is the high cost and extensive professional effort required to build and update an expert system.

I.D.6. Computer Simulation/Scenario Optimization

Computer simulation and computerized-scenario optimization both need realistic and accurate sample/scenario data. However, much of the time, using such data is not done because of conceptual and practical difficulties. The result, of course, is that the simulation and scenario-optimization are sub-optimal. One could use the above techniques to create sample/scenario data, but the resulting data can be inaccurate, primarily from loss of information, MCFP #3. Such a loss of information undermines the very purpose of both computer simulations and computerized-scenario optimizations: addressing the multitude of possibilities that could occur.

II. Risk Sharing and Risk Trading

Since human beings face uncertainties and risks, they trade risk in the same way that goods and services are traded for mutual benefit:

1. Insurance is perhaps the oldest and most common means for trading risk. An insurance company assumes individual policy-holder risks, covers risks by pooling, and makes money in the process. To do so, insurance companies offer policies only if a market is sufficiently large, only if there is a reasonable basis for estimating probabilities, and only if concrete damages or losses are objectively quantifiable.

2. Owners of publicly-traded financial instruments trade with one another in order to diversify and share risks. However, each financial instrument is a bundle of risks that cannot be traded. So, for example, the shareholder of a conglomerate holds the joint risk of all the conglomerate's subsidiaries. Owners of closely-held corporations and owners (including corporations) of non-publicly-traded assets usually cannot trade risks, other than by insurance as described above. Arguably, the risks associated with most assets in the world cannot be traded.

3. Long-term contracts between entities are made in order to reduce mutual uncertainty and risk. However, long-term contracts require negotiation between, and agreement of, at least two entities. Such negotiations and agreements can be difficult. (Public futures and forward markets, along with some private markets, attempt to facilitate such agreements, but can address only an infinitesimal portion of the need.) An example of long-term contracts negotiation would be artichoke farming. Focusing on a small town with several artichoke farmers, some farmers might think that the market for artichokes will shrink, while others might think that it will grow. Each farmer will make and execute their own decisions but be forced to live the by the complete consequences of these decisions since, given present-day technology, they lack a means of risk sharing.

4. Derivatives can be bought and sold to trade risk regarding an underlying financial asset. Derivatives, however, are generally applicable only if there is an underlying asset. (The Black-Scholes formula for option pricing, which is arguably the basis for all derivative pricing, requires the existence of an underlying asset.) They further have problems with granularity, necessitating complex multiple trades. Their use in a financial engineering context requires specialized expertise.

5. The Iowa Electronic Markets and U.S. Pat. No. 6,321,212, issued to Jeffrey Lange and assigned to Longitude Inc., offer means of risk trading that entail contingent payoffs based upon which bin of a statistical distribution manifests. These means of trading risk entail a “winner-take-all” orientation, with the result that traders are unable to fully maximize their individual utilities.

All-in-all, trading risk is a complex endeavor, in itself has risk, and can be done only on a limited basis. As a result of this, coupled with people's natural risk-aversion, the economy does not function as well as it might.

III. Concluding Remarks

A few additional comments are warranted:

1. Financial portfolio managers and traders of financial instruments seldom use mathematical optimization. Perhaps this is the result of a gap between humans and mathematical optimization: the insights of humans cannot be readily communicated as input to a mathematical optimization process. Clearly, however, it would be desirable to somehow combine both approaches to obtain the best of both.

2. Within investment banks in particular, and many other places in general, employees need to make forecasts. Such forecasts need to be evaluated, and accurate Forecasters rewarded. How to structure an optimal evaluation and reward system is not known. The one problem, of course, is the Agency Theory problem as defined by economic theory: Forecasters are apt to make forecasts that are in their private interest and not necessarily in the interests of those who rely on the forecast.

3. Within medicine, treatment approval by the FDA is a long and arduous process, and even so, sometimes once a treatment is approved and widely used, previously unknown side-effects appear. But on the other hand, people wish to experiment with treatments. Medicine, itself, is becoming ever more complex and a shift towards individually tailored drug programs is beginning. The net result is ever more uncertainty and confusion regarding treatments. Hence, a need for custom guidance regarding treatments.

In conclusion, though innumerable methods have been developed to quantitatively identify correlative relationships and trade risk, they all have deficiencies. The most important deficiencies are:

1. Loss of information, MCFP #1.

2. Assumption that fitting Equation 1.0 and minimizing deviations represents what is important, MCFP #2.

3. Only a few risks can be traded.

The first two deficiencies are particularly poignant in regards to creating data for computer simulations and for computerized-scenario optimization.

### SUMMARY OF THE INVENTION

Accordingly, besides the objects and advantages of the present invention described elsewhere herein, several objects and advantages of the invention are to address the issues presented in the previous section, including specifically:

Creating a unified framework for identifying correlations and making forecasts.

Handling any type of empirical distribution and any sample size.

Performing tests analogous to statistical-significance tests that are based upon practical relevance.

Generating scenario sets that both reflect expectations and retain maximum information.

Reducing both the storage and CPU requirements of the IPFP.

Facilitating both risk sharing and risk trading.

Additional objects and advantages will become apparent from a consideration of the ensuing description and drawings.

The basis for achieving these objects and advantages, which will be rigorously defined hereinafter, is accomplished by programming one or more computer systems as disclosed. The present invention can operate on most, if not all, types computer systems. FIG. 5 shows a possible computer system, which itself is collage of possible computer systems, on which the present invention can operate. Note that the invention can operate on a stand-alone hand-held mobile computer, a stand-alone PC system, or an elaborate system consisting of mainframes, mini-computers, servers, sensors, controllers—all connected via LANs, WANs, and/or the Internet. The invention best operates on a computer system that provides each individual user with a GUI (Graphical User's Interface) and with a mouse/pointing device, though neither of these two components is mandatory.

What is shown in FIG. 5 is termed here as an installation. A Private-Installation is one legally owned by a legal entity, such as a private individual, a company, a non-profit, or a governmental agency. The Risk-Exchange (Installation) is an electronic exchange available to the general public, or a consortium of private/government concerns, for trading risk. The relationship between these two types of installations is shown in FIG. 6: Risk-Exchange 650 is connected to Private-Installations 661, 662, and 663 via a LAN, WAN, and/or the Internet. The Risk-Exchange serves as a Hub in a Hub-and-Spoke network, where the Private-Installations constitute the Spokes.

Box 701 in FIG. 7 shows the major Bin Analysis components of the present invention. Outside Data 703 is loaded into the Foundational Table. Empirical distributions of Foundational Table data are displayed and edited on GUI 705. The CIPFC (Compressed Iterative Propositional Fitting Component) reconciles user specified target weights or proportions and determines weights for the Foundational Table data. The Distribution-Comparer compares two distributions to determine the learning-value of a second distribution for more accurately portraying future probabilities. The Data-Extropolator extropolates Foundational Table data. The Data-Shifter handles direct data edits by shifting data with respect to an origin.

The Explanatory-Tracker component identifies the variates that best explain other variates. The Scenario-Generator generates scenarios by either randomly sampling the Foundational Table or by outputting both the Foundational Table along with the weights determined by the CIPFC. The Probabilistic-Nearest-Neighbor-Classifier selects candidate nearest neighbors from the Foundational Table and then estimates probabilities that each candidate is in fact the nearest neighbor. The Forecaster-Performance-Evaluator is similar to the Distribution-Comparer: in light of what transpires, it evaluates a forecasted distribution against a benchmark. The results of these four components are either presented to a human being or passed to another computer application/system for additional handling.

The sequence of operation of the components in Box 701 can be dictated by a human being who mainly focuses on the GUI of Box 705 or Listing Results 712. Alternatively, the present invention could serve as the essence of an artificial intelligence/expert system.

Such a system needs to be set-up by human beings, but once it is started, it could operate independently.

The Risk-Exchange has interested traders specify distributions, which are aggregated and used to determine a PayOffMatrix. Depending on what actually manifests, the PayOffMatrix is used to determine payments between participating parties. The Risk-Exchange also handles trades of PayOffMatrix positions prior to manifestation when payoffs become definitively known.

### BRIEF DESCRIPTION OF THE DRAWINGS

The invention will be more readily understood with reference to the accompanying drawings, wherein:

FIGS. 1A and 1B show the loss of information resulting from using Mathematical Curve Fitting;

FIG. 2 depicts relative aspects of the most popular statistical techniques for handling explanatory and response variables;

FIG. 3 shows a simple contingency table;

FIG. 4 shows the data structures of the Iterative Proportional Fitting Procedure;

FIG. 5 shows a possible computer system on which the present invention can operate;

FIG. 6 shows the relationship between the Risk-Exchange installation and Private-Installations;

FIG. 7 shows the major Bin Analysis components of the present invention;

FIG. 8 shows a floating pen used to as a thought experiment to demonstrate a key concept of the present invention;

FIG. 9 shows a pen containing three floating balls used as part of a thought experiment;

FIG. 10 shows the raw VV-Dataset used as part of a tutorial;

FIGS. 11A and 11B show the VV-Dataset in bin format;

FIG. 12 shows xy-graphs of variate v₀ versus other variates of the VV-Dataset;

FIG. 13 shows xy-graphs of variate v₀ versus bins of variate v₁, along with histograms;

FIG. 14 shows xy-graphs of variate v₀ versus bins of variate v₂, along with histograms;

FIG. 15 shows xy-graphs of variate v₀ versus bins of variate v₃, along with histograms;

FIG. 16 shows xy-graphs of variate vo versus bins of variate v₂, holding variate v₁'s bin constant;

FIG. 17 shows xy-graphs of variate vo versus bins of variate v₃, holding variate v₁'s bin constant;

FIG. 18 shows original v₁, v₃, and v₅ histograms along with corresponding forecast histograms (Weighting EFDs);

FIG. 19 shows histograms of the VV-Dataset weighted by wtCur;

FIG. 20 shows a benchmark-Distribution versus a refined-Distribution;

FIG. 21 shows a prototype of the Distribution-BinComparer (DBC) function;

FIG. 22 lists six Distribution-BinComparers and their primary uses;

FIG. 23 shows the operations of DBC-SP;

FIG. 24 shows the data structures for DBC-BB;

FIG. 25 shows the operation of the DBC-BB;

FIG. 26 demonstrates Game Theory costs resulting from relying on forecasts provided by Forecasters;

FIG. 27 shows the data structures used to determine the value of knowing one variate to prediction a response variate;

FIG. 28 shows before and after histograms resulting from CIPFC's Smart Dimension Selecting and Partial Re-weighting;

FIG. 29 shows dMargin vector with an external LPHFC;

FIG. 30 shows the DMB class and its relation to the dMargin vector and LPHFC;

FIG. 31 shows an xy-graph of data used to demonstrate Probabilistic-Nearest-Neighbor-Classifier;

FIG. 32 shows the steps for determining Probabilistic-Nearest-Neighbors;

FIG. 33 shows distributions estimated by five farmers;

FIG. 34 shows the data of FIG. 33 in tabular format;

FIG. 35 shows the arithMean-Distribution of the five farmer's distributions;

FIG. 36 shows farmer FF's ac-Distribution with zero-bin value replacement;

FIG. 37 shows a C-DistributionMatrix composed of farmer's converted ac-Distributions;

FIG. 38 shows a geoMean-Distribution;

FIG. 39 shows a PayOffMatrix;

FIG. 40 shows farmer FF's align-Distribution;

FIG. 41 shows farmer FF's farming-business contingent operating returns;

FIG. 42 shows Farmer FF's angle-Distribution;

FIG. 43 shows Farmer FF's PayOffRow;

FIG. 44 shows Farmer FF's overall returns that are perfectly hedged;

FIG. 45 shows Speculator SG's align-Distribution;

FIG. 46 shows Speculator SG's angle-Distribution;

FIG. 47 shows Speculator SG's PayOffRow, assuming a specific cQuant;

FIG. 48 shows a C-DistributionMatrix after including Farmer FF and Speculator SG;

FIG. 49 shows an updated geoMean-Distribution;

FIG. 50 shows a resulting PayOffMatrix;

FIG. 51 shows a Leg Table;

FIG. 52 shows a Stance Table;

FIG. 53 shows a value disparity calculation;

FIG. 54 shows a value disparity matrix;

FIG. 55 shows a Leg Table after a transaction;

FIG. 56 shows a Stance Table after a transaction;

FIG. 57 shows top-level data structures for Bin Analysis;

FIG. 58 shows the BinTab class header;

FIG. 59 shows the relationship between the BTFeeder, BTManager and BinTab classes;

FIG. 60 shows the BTManager class header;

FIG. 61 shows the BTFeeder class header;

FIG. 62 shows the class instances owned by a Forecaster;

FIG. 63 shows the DMB class header;

FIG. 64 shows the steps of Bin Analysis;

FIGS. 65 and 66 show datasets suitable for loading into the Foundational Table;

FIG. 67 shows a graph that demonstrates Rail-Projection;

FIG. 68 shows the steps for Rail-Projection;

FIG. 69 shows the underlying data of the sample Rail-Projection;

FIG. 70 shows an xy-graph after a self Rail-Projection with trends removed;

FIG. 71 shows the binning of a single variate;

FIG. 72 shows two-dimensional Cartesian binning of two variates;

FIG. 73 shows binning based upon clusters;

FIG. 74 shows the high-level steps of Explanatory-Tracker;

FIG. 75 shows Bin Tab's CalInfo Val functioning, used by Basic-Explanatory-Tracker;

FIG. 76 shows a graph depicting correlations between variates;

FIG. 77 shows an expansion of Box 7430 of FIG. 74, used by Hyper-Explanatory-Tracker;

FIG. 78 shows the steps for determining Foundational Table weights;

FIG. 79 shows the specification of a single-dimension Weighting EFD, which is defined by setting Target-Bin proportions;

FIG. 80 shows the specification of a two-dimension Weighting EFD, which is defined by setting Target-Bubble proportions;

FIG. 81 shows the use of a line to set target proportions;

FIG. 82 shows the operation of the CIPFP;

FIG. 83 shows the operation of Data-Shifter;

FIG. 84 demonstrates a specification for Data-Shifter;

FIG. 85 shows a result of Data-Shifter;

FIG. 86 show a specification for Data-Shifter;

FIG. 87 demonstrates a specification for Data-Shifter regarding a BinTab of two variates;

FIG. 88 shows a grid of the possible scenario types generated by the present invention;

FIG. 89 shows the Scenario-Generator's data structures for generating scenarios;

FIG. 90 shows a dataset, suitable for loading into the Foundational Table, that has future variate values;

FIG. 91 shows the steps for evaluating a weight forecast and a shift forecast;

FIG. 92 shows the beginning steps for evaluating forecasts provided by multiple Forecasters;

FIG. 93 shows details regarding the Risk-Exchange, a single Private-Installation, and their interaction;

FIG. 94 shows the MPPit class header;

FIG. 95 shows the MPTrader class header;

FIG. 96 shows the operation of the MPPit class;

FIG. 97 shows the steps of a Trader interacting with the Risk-Exchange;

FIGS. 98, 99, and 100 shows windows that facilitate the interaction between a Trader and the Risk-Exchange.

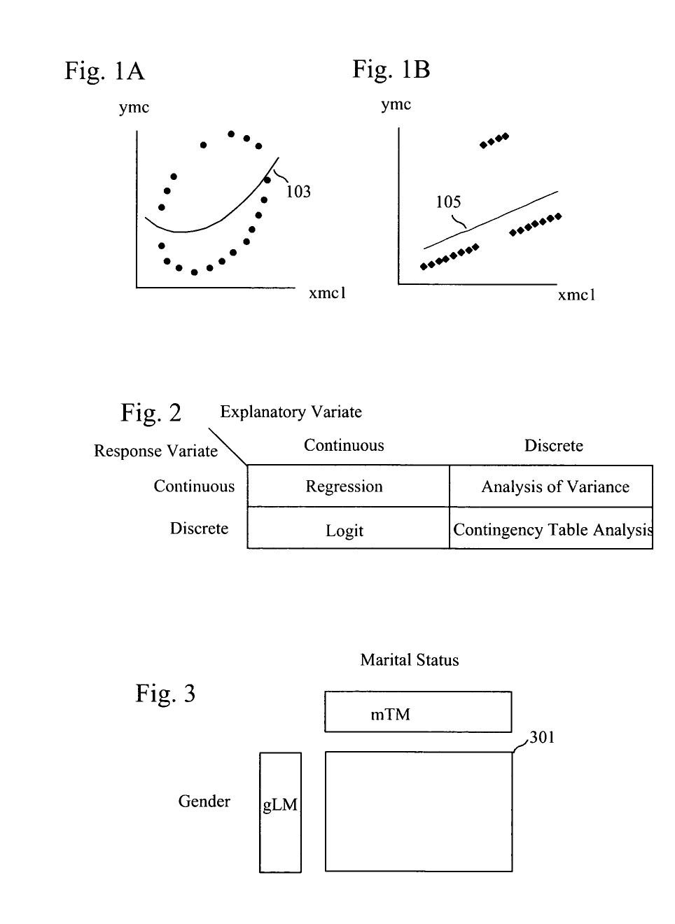

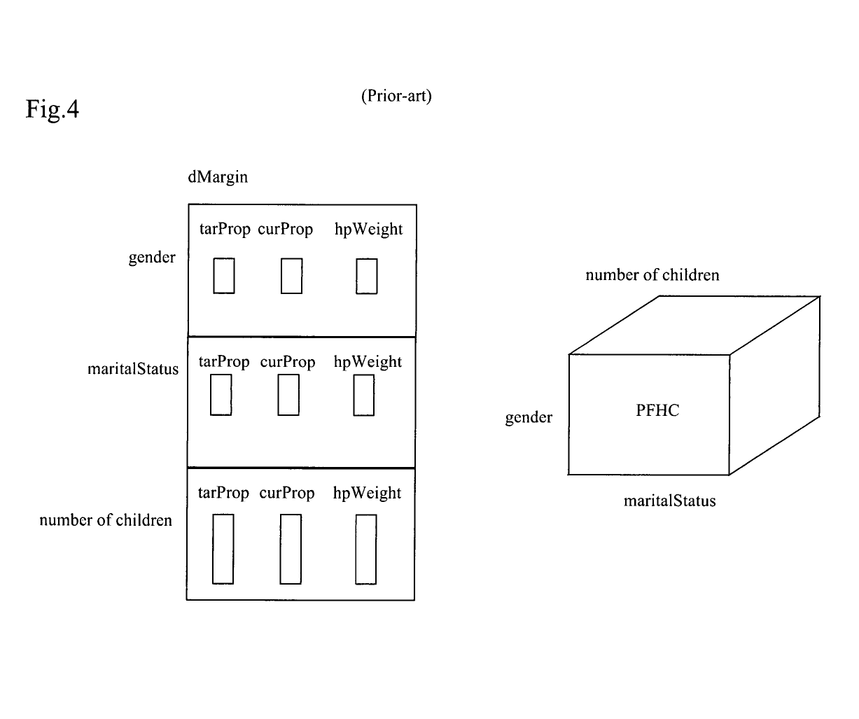

### DETAILED DESCRIPTION OF THE INVENTION

This Detailed Description of the Invention will use the following outline:

I. Expository Conventions

II. Underlying Theory of The Invention—Philosophical Framework

III. Theory of The Invention—Mathematical Framework

III.A. Bin Data Analysis

III.A.1. Explanatory-Tracker

III.A.2. Scenario-Generator

III.A.3. Distribution-Comparer

III.A.3.a. Distribution-BinComparer—Stochastic Programming

III.A.3.b. Distribution-BinComparer—Betting Based

III.A.3.c. Distribution-BinComparer—Grim Reaper Bet

III.A.3.d. Distribution-BinComparer—Forecast Performance

III.A.3.e. Distribution-BinComparer—G2

III.A.3.f. Distribution-BinComparer—D2

III.A.4. Value of Knowing

III.A.5. CIPFC

III.A.6. Probabilistic-Nearest-Neighbor Classification

III.B. Risk Sharing and Trading

IV. Embodiment

IV.A. Bin Analysis Data Structures

IV.B. Bin Analysis Steps

IV.B.1. Load Raw Data into Foundational Table

IV.B.2. Trend/Detrend Data

IV.B.3. Load BinTabs

IV.B.4. Use Explanatory-Tracker to Identify Explanatory Variates

IV.B.4.a Basic-Explanatory-Tracker

IV.B.4.b Simple Correlations

IV.B.4.c Hyper-Explanatory-Tracker

IV.B.5. Do Weighting

IV.B.6. Shift/Change Data

IV.B.7. Generate Scenarios

IV.B.8. Calculate Nearest-Neighbor Probabilities

IV.B.9. Perform Forecaster-Performance Evaluation

IV.B.10. Multiple Simultaneous Forecasters

IV.C. Risk Sharing and Trading

IV.C.1. Data Structures

IV.C.2. Market Place Pit (MPPit) Operation

IV.C.3. Trader Interaction with Risk-Exchange and MPTrader

IV.D. Conclusion, Ramifications, and Scope

I. Expository Conventions

An Object Oriented Programming orientation is used here. Pseudo-code syntax is based on the C++ and the SQL (Structured Query Language) computer programming languages, includes expository text, and covers only the particulars of this invention. Well-known standard supporting functionality is not discussed nor shown. All mathematical and software matrices, vectors, and arrays start with element 0; brackets enclose subscripts. Hence “aTS[0]” references the first element in a vector/array aTS. In the drawings, vectors and matrices are shown as rectangles, with labels either within or on top. In any given figure the heights of two or more rectangles are roughly proportional to their likely relative sizes.

Generally, scalars and vectors have names that begin with a lowercase letter, while generally, matrices and tables have names that begin with an uppercase letter. A Table consists of vectors, columns, and matrices. Both matrices and tables have columns and rows. In this specification, a column is a vector displayed vertically, while a row is a vector that is displayed horizontally.

Vectors are frequently stored in a class that has at least the following four member functions:

1. ::operator=for copying one vector to another.

2. ::Norm1( ), which tallies the sum of all elements, then divides each element by the sum so that the result would sum to one. To normalize a vector is to apply Norm1( ).

3. ::MultIn(arg), which multiplies each element by arg.

4. ::GetSum which returns the sum of all elements.

All classes explicitly or implicitly have an ::Init( . . . ) function for initialization.

From now on, a “distribution” refers to a data-defined distribution with defined bins. The data ideally comes from actual obversations (and thus is an empircal distribution), but could also be generated by computer simulation or other means. Data defining one distribution can be a subset of the data that defines another distribution, with both distributions regarding the same variate(s). The distributions of the present invention are completely separate from the theorical distributions of Classical Statistics, such as the Gaussian, Poison, and Gamma Distributions, which are defined by mathematical formulae.

A simple distribution might regard gender and have two bins: male and female. A distribution can regard continuous variates such age and have bins with arbitrary boundaries, such as:

less than 10 years old

between 11 and 20 years old

between 21 and 30 years old

between 31 and 40 years old

more than 40 years old

A distribution can be based upon multiple distributions or variates; so for example, both the gender and age could be combined into a single distribution with 10 bins (2×5=10). If a variate is categorical, then bin boundaries are self-evident. If a variate is continuous, then the bin boundaries are either automatically determined or manually specified.

Bins can also be defined by using the results of the K-Mean Clustering Algorithm. Suppose that the K-Mean Clustering Algorithm is used to jointly cluster one or more variates. The resulting centroids can be thought of as defining bins: Given a datum point, the distance between it and each centroid can be determined; the given datum point can then be classified into the bin corresponding to the closest centroid. For expository convenience, bins defined by the K-Mean Centroids will be assumed to have (implicit) bin boundaries. Thus, stating that two Distributions have the same bin boundaries, might actually mean that they have bins defined by the same centroids.

An Object Oriented Programming Class PCDistribution (Pseudo-code distribution) is a Distribution container that has a vector bin Value with nBin elements. Different instances of PCDistribution may have different values for nBin. The value in each bin Value element may be a probability, or it may be a non-probability value. Values for bin Value can be accessed used the using the “[ ]” operator. In order to maintain consistency, names of PCDistribution instances frequently contain hyphens, which should not be interpreted as negative signs or subtraction operators.

Assuming that PCDistribution contains probabilities, the function:

Mean Of (PCDistribution)

returns the mean of the underlying original distribution. So, for example, if PCDistribution regards the distribution of people's ages, nBin could be 5 and the five elements of bin Value would sum to 1.0. The value returned by Mean Of however, might be 43.

Mean Of (PCDistribution[i])

Either returns the mid-point between the low and high boundaries of bin i, or returns the actual mean of the original values that were classified into the i^{th} bin.

Equations 3.0 and 6.0, together with other equations, yield a value for a variable named rating. The value of rating can be interpreted as either a rating on a performance scale or as a monetary amount that needs to be paid, received, or transferred. Equations may use asterisk (*) to indicate multiplication.

Each instance of class BinTab is based upon one or more variates. The class is a container that holds variate values after they have been classified into bins. Conceptually, from the innovative perspective of the present invention, a BinTab is the same as a variate, and a strict distinction is not always made.

Class StatTab (statistics tabular) accepts values and performs standard statistical calculations. Its member function Note takes two parameters, value and weight, which are saved in an n×2 matrix. Other functions will access these saved values and weights to perform standard statistical calculations. So, for example, Note might be called with parameters (1, 2) and then with parameters (13,17); GetMean( ) function will then yield 11.74 ((1*2+13*17)/19). Member function Init( ) clears the n×2 matrix. Member function Append( . . . ) appends the n×2 matrix from one class instance to another. A row in the n×2 matrix is termed a “value-weight pair.” Names of instances of this class contain “StatTab.”

Pseudo-code overrules both expository text and what is shown in the diagrams.

The “owner” of a data field is one who has read/write privileges and who is responsible for its contents. The Stance and Leg Tables, which will be introduce later, have traderID columns. For any given row, the entity that corresponds to the row's traderID “owns” the rows, except for traderID field itself. Exogenous data is data originating outside of the present invention.

To help distinguish the functions of the present inventions, three different-user types are named:

Analysts—provide general operational and analytic support. They load data, define bins, and perform general support functions.

Forecasters—provide forecasts in the form of distributions, which are termed Exogenously Forecasted Distributions (EFD). Such EFDs are used for weighting the Foundational Table and are used for data shifting. EFDs may be the result of:

intuitive guesses (subjective probabilities) on the part of the Forecaster

the result of sampling experiments (objective probabilities)

or a combination of these and other approaches.

Traders—share and trade risk, usually on behalf of their principal. To share risk is to participate in a risk pool. To trade risk is to buy or sell a contract of participation in a risk pool.

In an actual implementation, a single user might be Analyst, Forecaster, and Trader; in another implementation, many people might be Analysts, Forecasters, and Traders—with overlapping and multiple duties. The perspective throughout this specification is largely that of a single entity. However, separate legal entities might assume the Analyst, Forecaster, and Trader roles on behalf of a single client entity or multiple client entities.

As suggested, there are two types of EFDs. The first type, Weight EFD, is directly specified by a Forecaster. Specifications are defined in terms of target proportions or target weights for distribution bins. The second type, Shift EFD, is indirectly specified by the Forecaster. The Forecaster shifts or edits the data and the resulting distribution of the data is called a Shift EFD.

At several points, to help explain the present invention, illustrative examples are used. Principles, approaches, procedures, and theory should be drawn from them, but they should not be construed to suggest size, data type, or field-of-application limitations.

The reader is presumed familiar with management science/operations research terminology regarding Stochastic Programming.

The VV-Dataset will be used as a sample to illustrate several aspects of the present invention. Though it may be implied that the VV-Dataset and associated examples are separate from the present invention, this is not the case: VV-Dataset could be loaded into a Foundational Table (to be introduced) and used by the present invention as described.

The present invention is directed towards handling mainly continuous variates, but it can easily handle discrete variates as well.

II. Underlying Theory of the Invention—Philosophical Framework

The perspective of the present invention is that the universe is deterministic. That it is because of our human limitations, both physical and intellectual, that we do not understand many phenomena and that, as a consequence, we need to resort to probability theory.

Though this contradicts Neils Boor's Copenhagen interpretation of quantum mechanics, it parallels both Albert Einstein's famous statement, “God does not play dice” and the thought of Pierre S. Laplace, who in 1814 wrote:

We must consider the present state of the universe as the effect of its former state and as the cause of the state which will follow it. An intelligence which for a given moment knew all the forces controlling nature, and in addition, the relative situations of all the entities of which nature is composed—if it were great enough to carry out the mathematical analysis of these data—would hold, in the same formula, the motions of the largest bodies of the universe and those of the lightest atom: nothing would be uncertain for this intelligence, and the future as well as the past would be present to its eyes.

Ideally, one uses both data and intuition for decision-making, and gives prominence to one or the other depending upon the situation. With no or scarce data, one has only their intuition; with plenty of data, reliance on intuition is rational only under some circumstances. While encouraging an override by subjective considerations, the present invention takes empirical data at face value and allows empirical data to speak for itself. A single data point is considered potentially useful. Such a point suggests things, which the user can subjectively use, discard, etc., as the user sees fit. Unless and until there is a subjective override, each observation is deemed equally likely to re-occur.

This is in contradistinction to the objective formulation of probability, which requires the assumption, and in turn imposition, of “a real probability” and “real Equation 1.0.”

Frank Lad in his book Operational Subjective Statistical Methods (1996, p 7-10) nicely explains the difference between subjective and objective probability:

The objectivist formulation specifies probability as a real property of a special type of physical situation, which are called random events. Random events are presumed to be repeatable, at least conceivably, and to exhibit a state frequency of occurrence in large numbers of independent repetitions. The objective probability of a random event is the supposed “propensity” in nature for a specific event of this type to occur. The propensity is representable by a number in the same way that your height or your weight is representable by a number. Just as I may or may not know your height, yet it still has a numerical value, so also the value of the objective probability of a random event may be known (to you, to me, to someone else) or unknown. But whether known or unknown, the numerical value of the probability is presumed to be some specific number. In the proper syntax of the objectivist formulation, you and I may both well ask, “What is the probability of a specified random event?” For example, “What is the probability that the rate of inflation in the Consumer Price Index next quarter will exceed the rate in the current quarter?” It is proposed that there is one and only one correct answer to such questions. We are sanctioned to look outside of ourselves toward the objective conditions of the random event to discover this answer. As with our knowledge of any physical quantity such as your height, our knowledge of the value of a probability can only be approximate to a greater or lesser extent. Admittedly by the objectivist, the probability of an event is expressly not observable itself. We observe only “rain” or “no rain”, we never observe the probability of rain. The project of objectivist statistical theory is to characterize good methods for estimating the probability of an event's occurrence on the basis of an observed history of occurrences and nonoccurrence of the same (repeated) event.

The subjectivist formulation specifies probability as a number (or perhaps less precisely, as an interval) that represents your assessment of your own personal uncertain knowledge about any event that interests you. There is no condition that events be repeatable; in fact, it is expressly recognized that no events are repeatable! Events are always distinct from one another in important aspects. An event is merely the observable determination of whether something happens or not (has happened, will happen or not). . . . Although subjectivists generally eschew use of the word “random,” in subjective terms an event is sometimes said to be random for someone who does not know for certain its determination. Thus randomness is not considered to be a property of events, but of your (my, someone else's) knowledge of events. An event may be random for you, but known for certain by me. Moreover, there are gradations of degree of uncertainty. For you may have knowledge that makes you quite sure (though still uncertain) about an event, or that leaves you quite unsure about it. Finally, given our different states of knowledge, you may be quite sure that some event has occurred, even while I am quite sure that it has not occurred. We may blatantly disagree, even though we are each uncertain to some extent. About other events we may well agree in our uncertain knowledge. In the proper syntax of the subjectivist formulation, you might well ask me and I might well ask you, “What is your probability for a specified event?” It is proposed that there is a distinct (and generally different) correct answer to this question for each person who responds to it. We are each sanctioned to look within ourselves to find our own answer. Your answer can be evaluated as correct or incorrect only in terms of whether or not you answer honestly. Science has nothing to do with supposed unobservable quantities, whether “true heights” or “true probabilities.” Probabilities can be observed directly, but only as individual people assess them and publicly (or privately, or even confidentially) assert them. The project of statistical theory is to characterize how a person's asserted uncertain knowledge about specific unknown observable situation suggests that coherent inference should be made about some of them from observation of others. Probability theory is the inferential logic of uncertain knowledge.

The following thought experience demonstrates the forecasting operation of the present invention.

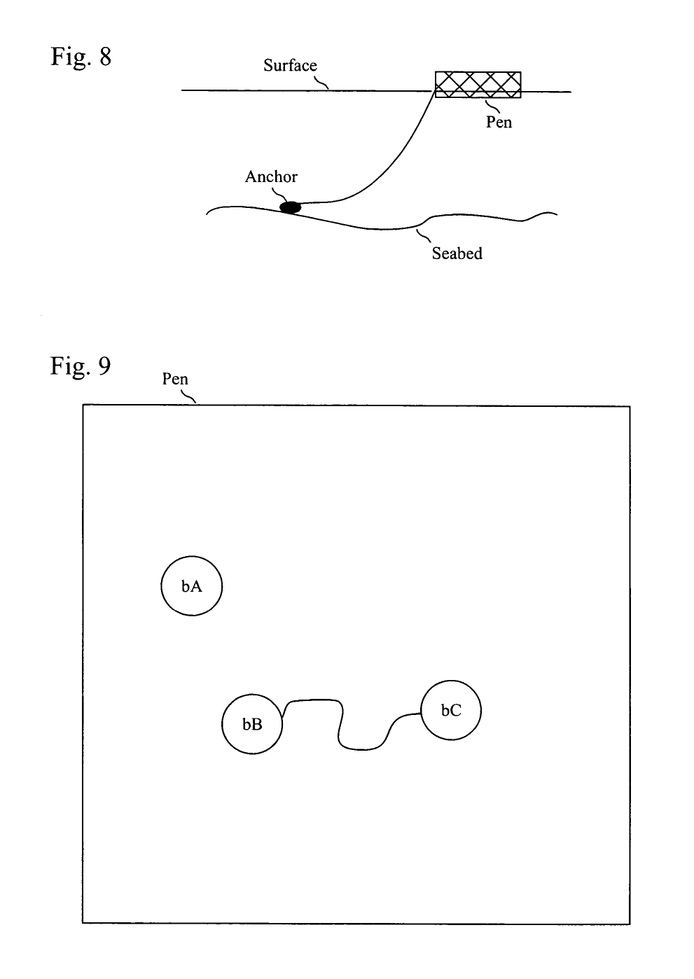

In the middle of the ocean a floating open pen (cage, enclosure) made of chicken wire (hardware cloth) is placed and is anchored to the seabed as shown in FIG. 8. Because of the wind, waves, etc., the pen moves about on the surface, but is constrained by the anchor. Three floating balls—bA, bB, and bC—are placed in the pen; balls bB and bC are tied together by a thin rope; and the pen confines the balls to its interior. (See FIG. 9) Like the pen itself, these three balls are buffeted by the wind, waves, etc. Now if multiple observations of the location of the three balls relative to the pen are made and recorded, an empirical distribution of ball locations can be tallied. Now suppose that an uncertain observation is made that ball bB is in the lower left-hand corner and that subjective probability estimates of ball bB's location can be made, e.g., 50% subjective probability that ball bB is within three ball lengths of the lower left-hand corner; 50% subjective probability that the observation was spurious. Now the recorded data can be weighted to align with the subjective probability estimates. From this weighted data, the Distributions of the locations of balls bA and bC can be tallied. Given that ball bC is tied to ball bB, the tallied distribution of the location of ball bC will be skewed towards having ball bC also located in the lower left-hand corner. The distribution of the location of ball bA will change little, since balls bA and bB largely roam independently.

If the roaming independently assumption is suspended, then two possibilities occur. On the one hand, because there is a higher probability that ball bB is the lower left-hand corner, there is a lower probability that ball bA is in the same corner simply because it might not fit there. On the other hand, there is a higher probability that ball bA is in the same corner because the winds and currents may tend to push the three balls into the same corners. Whichever the case, the answer lays in the weighted data.

Note that to forecast the position of balls bC and bA, given subjective probability estimates of the location of ball bB, does not require any hypothecation regarding the relationship between the three balls. The relationships are in the data.

In making the step towards improving the tie with practical considerations, as a goal-orientating device, the present invention assumes that the user or his agent is attempting to maximize mathematically-expected utility. Because of the nature of the problem at hand, a betting metaphor is deemed appropriate and useful. Frequently, the maximization of monetary gain is used here as a surrogate of utility maximization; the maximization of information gain is used here as a surrogate of monetary maximization. Arguably, this replaces the “a real probability” and “real Equation 1.0” orientation of the objective probability formulation.

This philosophical section is presented here to facilitate a deeper and broader understanding of how the present invention can be used. However, neither understanding this section nor agreeing with it is required for implementing or using this invention.

Hence, this philosophical section should not be construed to bound or in any way limit the present invention.

III. Theory of the Invention—Mathematical Framework

III.A. Bin Data Analysis

III.A.1. Explanatory-Tracker

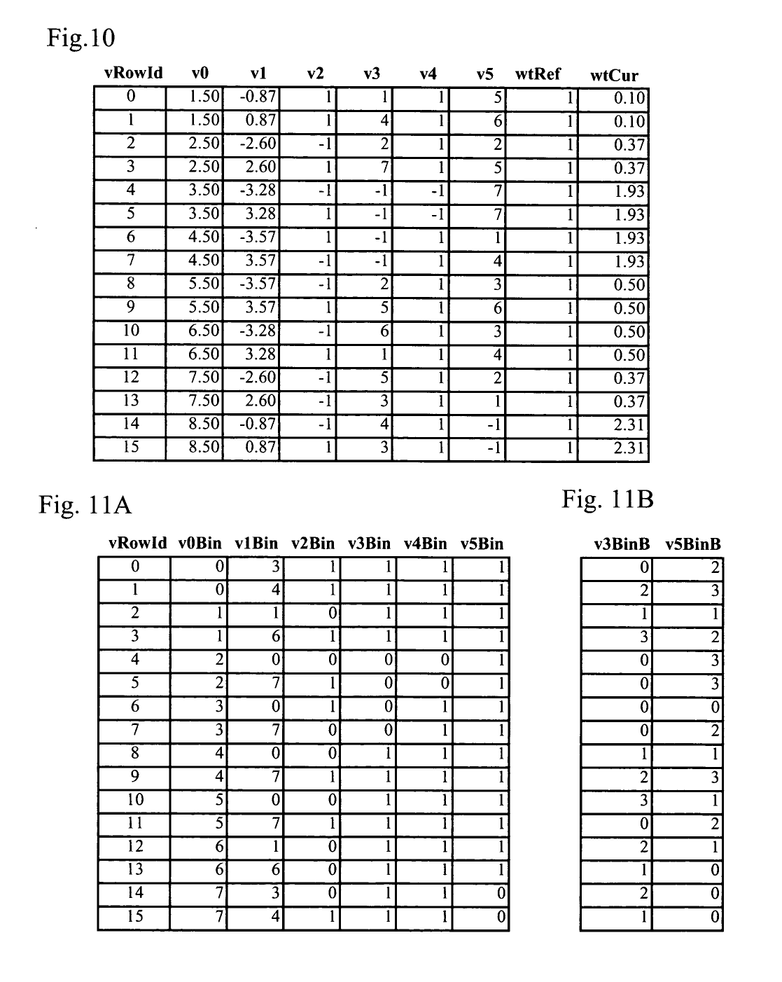

Both Explanatory-Tracker and Scenario-Generator follow from the Pen example above, and will be presented next. The presentation will use the VV-Dataset as shown in FIG. 10. The VV-Dataset consists of sixteen observations of six variates, v₀, v₁, v₂, v₃, v₄, and v₅. Variates v₁, v₂, v₃, v₄, and v₅ are considered possible explanatory variates of response variate v₀. Whether these variates are continuous or discrete does not matter: They are all digitized, or placed into bins, as shown in FIG. 11A. In other words, for example, the values of variate v₅ are placed into one of two bins or categories, with categories as shown in FIG. 11A. (Values less than 0 are placed in one bin; values greater than 0 are placed in another bin.)

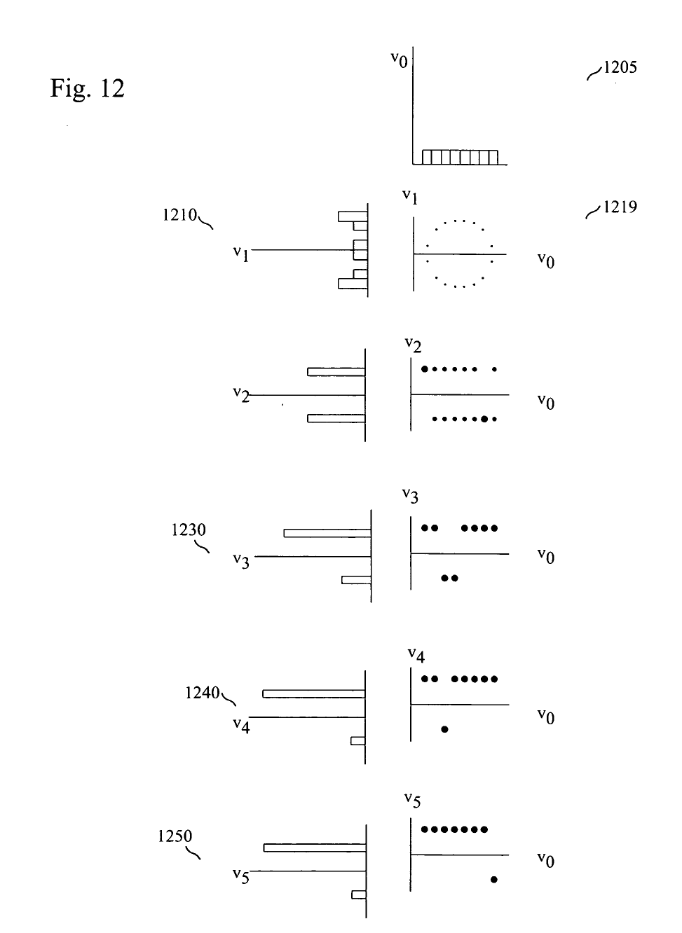

FIG. 12 shows xy-graphs of each of the five possible explanatory variates versus response variate v₀, along with histograms of the six variates. For example, xy-graph 1219 shows the relationship between v₀ and v₁, histogram 1205 regards v₀, and histogram 1210 regards v₁. The basis for these graphs are the bins of FIG. 11A, rather than the raw data of FIG. 10.

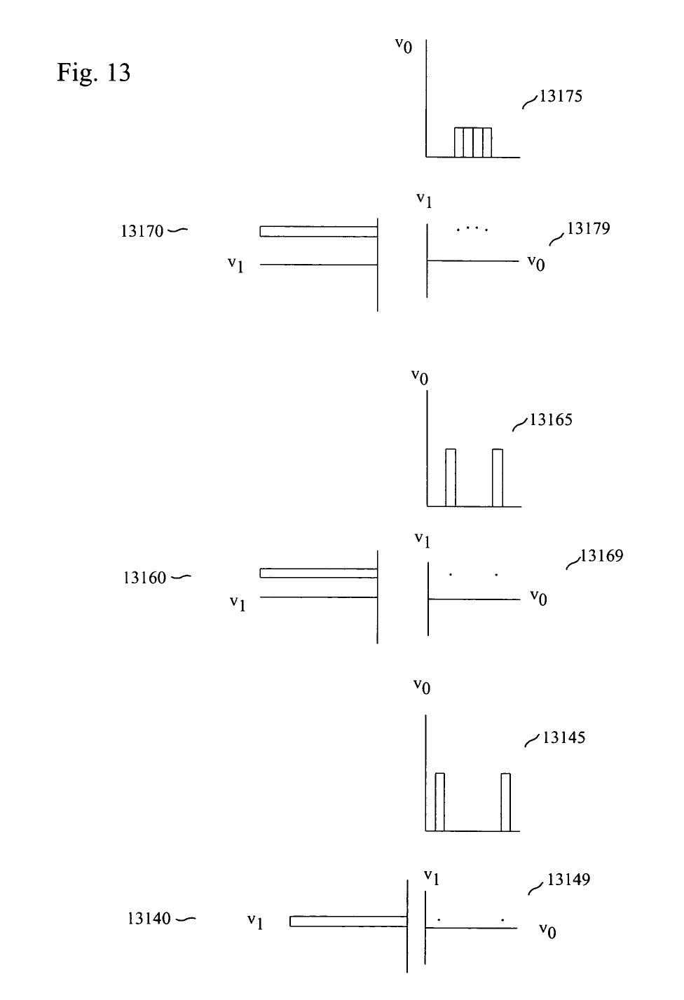

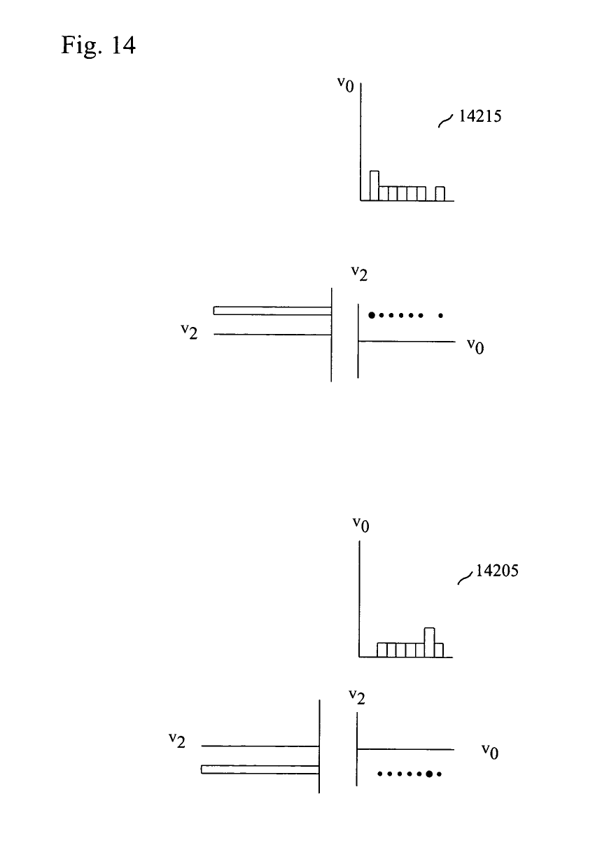

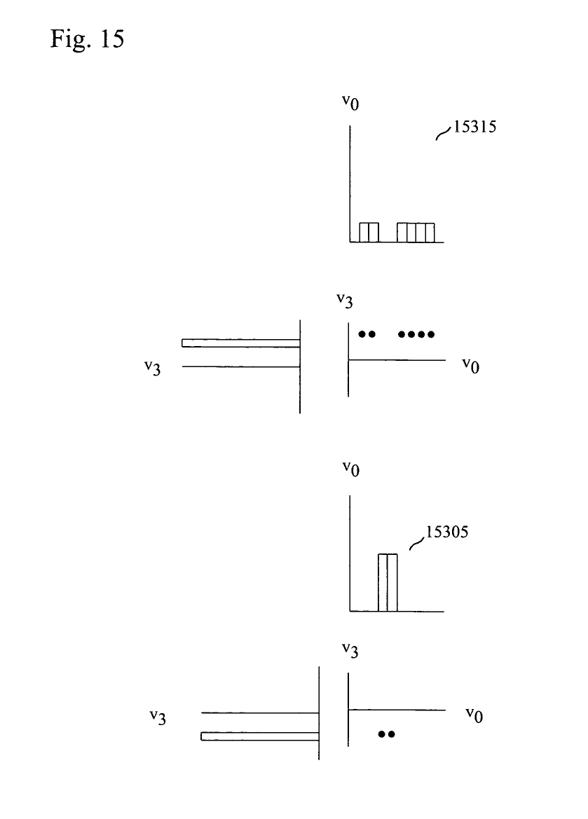

Suppose that the data of FIG. 11A were weighted so that the weight equals 1.0 when v1 Bin equals 7, and the weight equals 0.0 otherwise. Graphs 1210, 1205, and 1219 become graphs 13170, 13175, and 13179 respectively (of FIG. 13). Repeating the process, weighting so that the weight equals 1.0 when v1Bin equals 6, and the weight equals 0.0 otherwise yields graphs 13160, 13165, and 13169. Weighting 1.0 when v1Bin equal 4 yields graphs 13140, 13145, and 13149. And the process is repeated for each of the bins of v1Bin. Furthermore, the process is applied to the other variates, v₂, v₃, v₄, and v₅. Some results for v₂ and v₃ are shown in FIGS. 14 and 15 respectively.

In comparing histogram 1205 with histogram sets 13175-13165-13145, 14215-14205, and 15315-15305, it appears that set 13175-13165-13145 is most different from 1205. This difference suggests that v₁ is more explanatory of v₀ than are v₂ and v₃ (and not shown, v₄ and v₅).

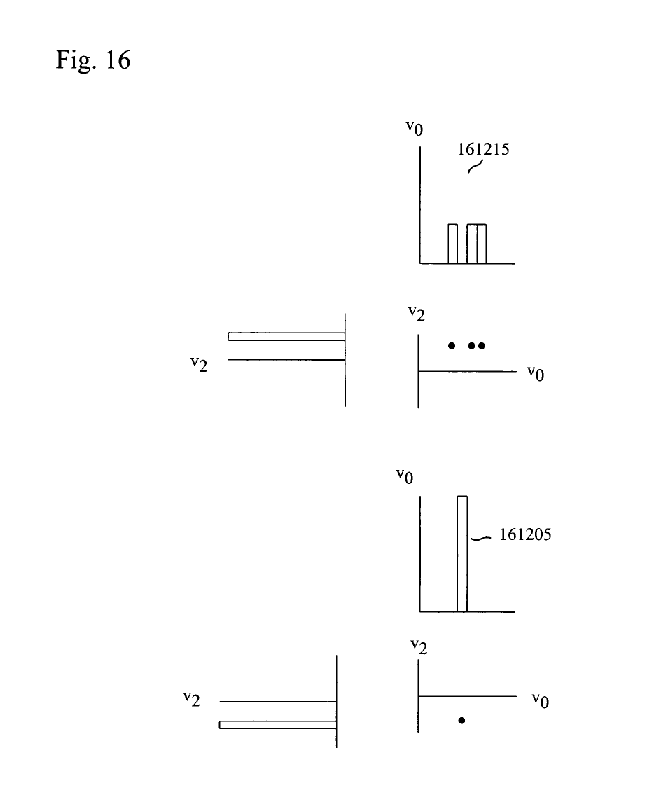

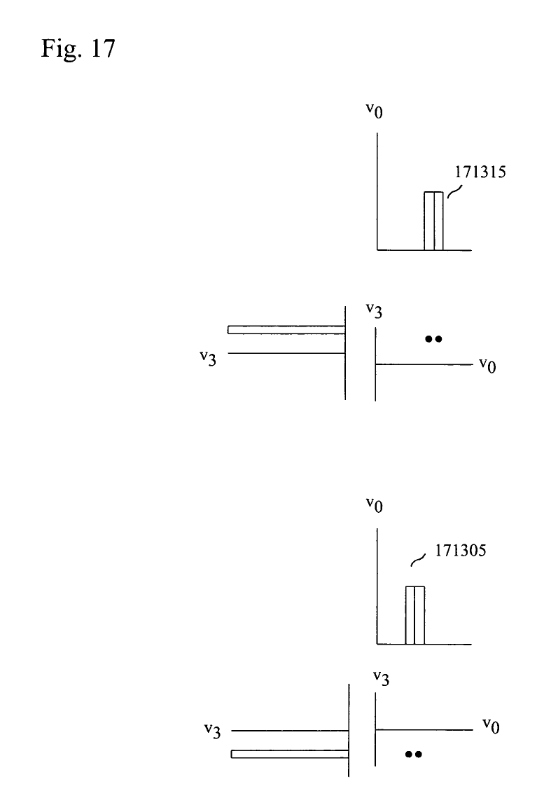

Given that v₁ is the most explanatory, the process is repeated for each bin of v1Bin. Focusing on bin 7 of v1Bin, applying the above process yields the graphs of FIG. 16 for v₂ and FIG. 17 for v₃. In comparing histogram 13175 with histogram sets 161215-161205 and 171315-171305, it appears that set 171315-171305 is most different from 13175. This suggests that given the occurrence of bin 7 of v1Bin, v₃ is more explanatory of v₀, than is v₂. If the process were, as is required, expanded to generate 28 additional histograms (7*2*2) for v₂ and v₃ it, would appear that those of v₃ are most different from histogram 13175. This in turn suggests that given v₁, v₃ is more explanatory of v₀ than is v₂ (and not shown, v₄ and v₅).

Given that v₁, and v₃ are most explanatory, the process is repeated from each bin combination of v₁ and v₃. (There are 8*2 such combinations.) The result of such a repetition leads to the conclusion that v₅ is the third most explanatory. And this process can be repeated until all variates are identified, in decreasing order of explanatory power.

III.A.2. Scenario-Generator

Scenario-Generator complements the Explanatory-Tracker described above: Explanatory-Tracker searches for variates to explain response variates; Scenario-Generator uses variates to explain response variates. To forecast v₀ requires choosing explanatory variates. The Forecaster could use the variates determined by Explanatory-Tracker as described above and/or could use intuition.

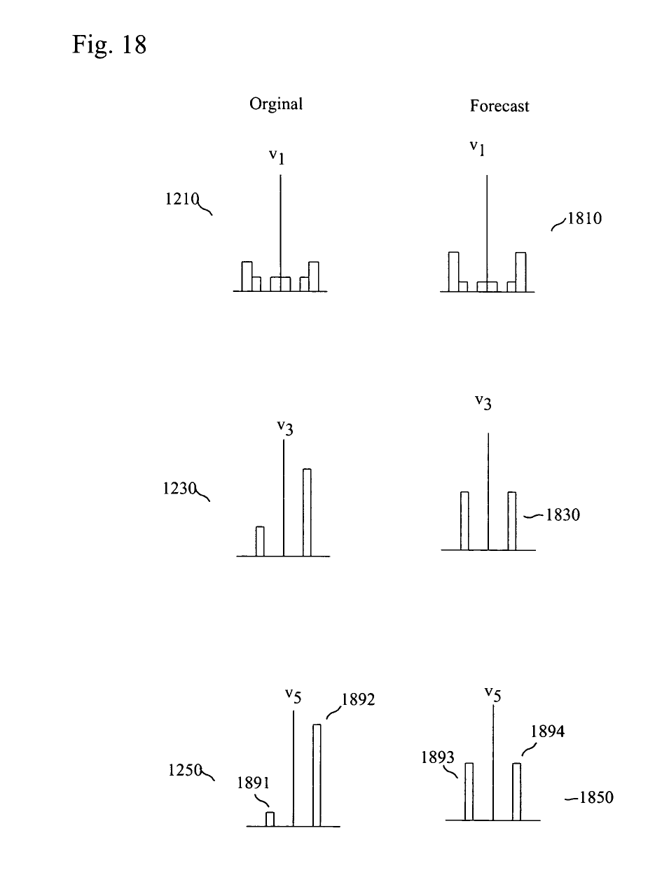

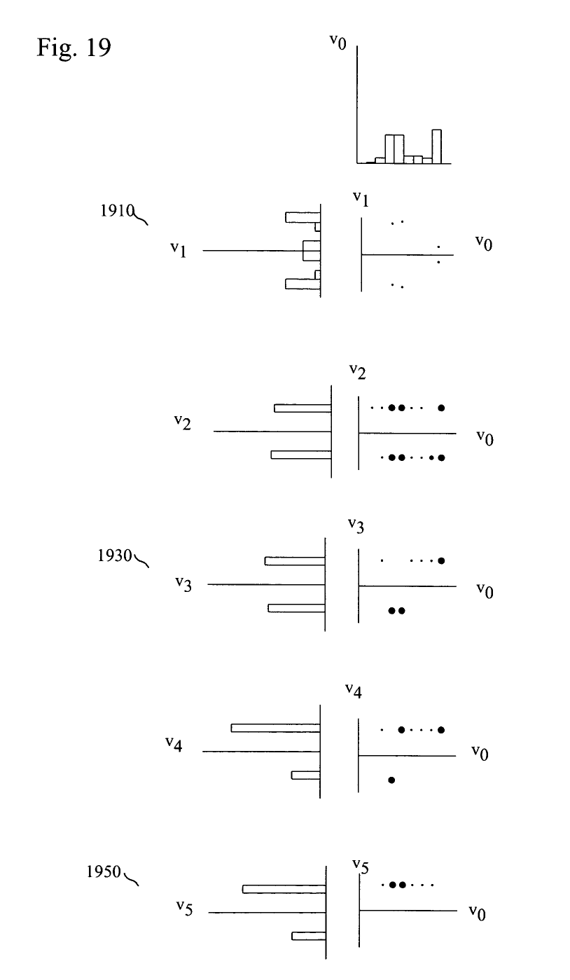

For now, assuming usage of the three identified variates, v₁, v₃, v₅, the Forecaster provides three Weighting EFDs as, for example, shown to right of FIG. 18. (The left histograms are the original distributions of FIG. 12.) Using these forecasted EFDs, the CIPFC determines weights that proportion the data to fit the EFDs. The resulting weights for each vv observation are shown in column wtCur of FIG. 10. FIG. 19 shows variate v₀ by v₁, v₂, v₃, v₄, and v₅ using the weights of column wtCur. Notice how, in light of available data, the CIPFC reconciled the forecasts of v₁, v₃, and v₅ (compare histograms 1810, 1830, 1850 with 1910, 1930, 1950 respectively). If there were more diverse data, the fit would become perfect. Notice also how forecasts for v₂ and v₄ are also yielded. And finally, notice how, when picturing each row of FIG. 10 as a scenario, the relationships between all variates (v₀ by v₁, v₂, v₃, v₄, and v₅) are maintained. In other words, since curve fitting is not used, all the information in retained. This relationship maintenance is a key benefit of the present invention.

The Forecaster does not need to use explanatory variates as identified by Explanatory-Tracker. So, for example, the Forecaster could use only v₁ and v₃. In this case, not using v₅ means accepting the distribution of v₅ as it is in, or as it results in, histograms 1250 and 1950. Alternatively, the Forecaster could use any combination of v₁, v₂, v₃, v₄, and v₅. Returning to FIG. 14, because distributions 14215 and 14205 are so similar to distribution 1205, if the Forecaster used v₂ as an explanatory variate of v₀, the resulting distribution of v₀ would scarcely change. If the Forecaster had an insight that the first, relatively less frequent, bin of v₄ was going to occur (See FIG. 12, Histogram 1240), then v₄ should be used as an explanatory variate with the first bin weighted heavily: A sizable change in the distribution of vo would occur.

A major advantage here is that whatever the combination of designated explanatory variates the Forecaster may use, those variates that correlate linearly or nonlinearly with the response variate alter the distribution of the response variable, and those variates that do not correlate with the response variate have little or no effect.

Actual scenario generation is accomplished either by directly using the data and weights (wtCur) of FIG. 10, or by using wtCur to sample data from FIG. 10.

III.A.3. Distribution-Comparer

The Distribution-Comparer compares distributions for the Explanatory-Tracker, the CIPFC, and for the Forecaster-Performance-Evaluator. It compares a refined-Distribution against a benchmark-Distribution to determine the value of being informed of the refined-Distribution in light of- or over, or in addition to—the benchmark-Distribution. Both distributions are equally valid, though the refined-Distribution, in general, reflects more refinement and insight.

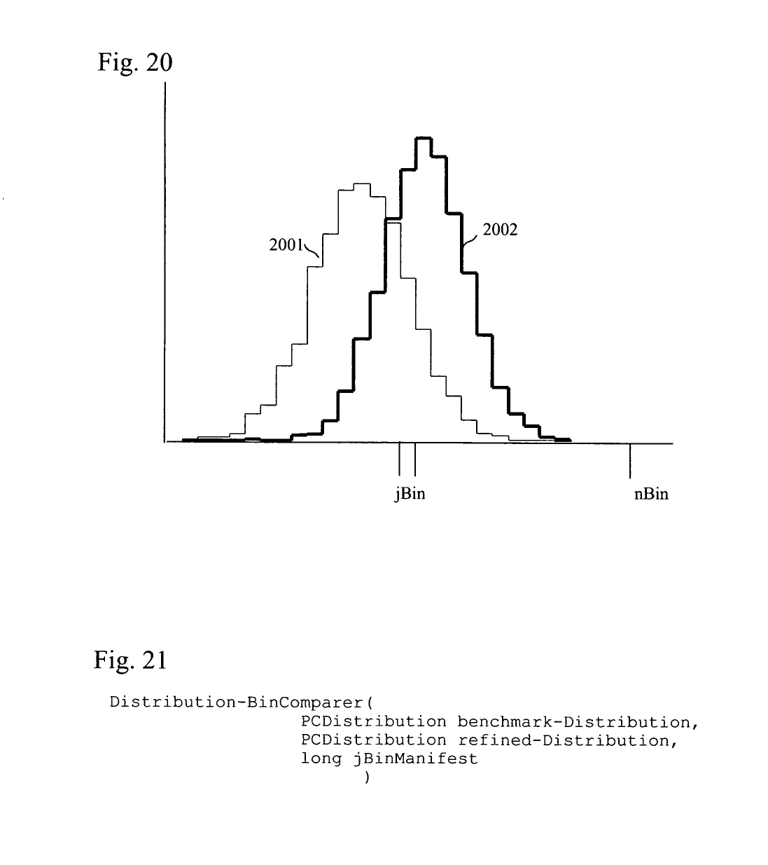

So, for example, suppose benchmark-Distribution 2001 and refined-Distribution 2002 as shown in FIG. 20. Given benchmark-Distribution 2001, certain decisions are presumably made. Now, being informed of the refined-Distribution 2002 possibly makes those decisions sub-optimal and necessitates a revision. What would have been the value of being informed of the refined-Distribution before making any decision? This is the issue addressed by the Distribution-Comparer. The answer: the stochastic difference between what could have been obtained (objective function value) versus what would be obtained. The “could have been” is extremely important: The issue is not whether what is obtained happens to be different under either distribution, but whether different decisions could and should have been made depending upon which distribution is used or referenced.

To do this requires serially considering each bin and doing the following: compare the refined-Distribution against a benchmark-Distribution to determine the retrospective value of being informed of the refined-Distribution in light of both the benchmark-Distribution and the manifestation of a jBinManifest bin. Again, the answer is the stochastic difference between what could have been obtained versus what would be obtained. Note that a given jBinManifest may argue for the superiority of a refined-Distribution over a benchmark-Distribution, while a consideration of all bins and their associated probabilities argues for the superiority of benchmark-Distribution.

(Both the benchmark-Distribution and refined-Distribution have nBin bins—with congruent boundaries. Each bin represents a proportion or probability. So, for instance, in benchmark-Distribution 2001, binjBin has a 7% proportion or 7% probability, while in refined-Distribution 2002, binjBin has a 12% proportion or 12% probability. These differences are the result of using different data, weightings, or subjective estimates for creating benchmark-Distribution and refined-Distributions. [When the Distribution-Comparer is called by the Explanatory-Tracker, at a simple level, the refined-Distribution contains a subset of the observations that are used to create the benchmark-Distribution.] A bin is said to manifest when a previously unknown observation becomes available and such an observation is properly classified into the bin. The observation may literally become available as the result of a passage of time, as a result of new information becoming available, or as part of a computer simulation or similar operation. So, for example, the benchmark-Distribution 2001 could be based upon historical-daily rainfall data, while the refined-Distribution 2002 could be Forecaster Sue's estimated distribution (Exogenously Forecasted Distribution—EFD) based upon her consideration of the benchmark-Distribution and her intuition. Once tomorrow has come to pass, the amount of (daily) rainfall is definitively known. If this amount is properly classified into a bin jxBin, then jxBin has manifested. Otherwise, jxBin has not manifested. Hence, jxBin may or may not equal jBinManifest.)

FIG. 21 shows a prototype of the Distribution-BinComparer (DBC) function, which:

1. Takes a benchmark-Distribution, a refined-Distribution, and a jBinManifest;

2. Compares the refined-Distribution against the benchmark-Distribution;

3. Determines the retrospective (assuming a perspective from the future) value of being informed of the refined-Distribution in light of both the benchmark-Distribution and the manifestation of ajBinManifest bin.

The Distribution-Comparer function calls Distribution-BinComparers and tallies the results:

| | |
|---|---|
| Distribution-Comparer | (benchmark-Distribution, |
| | refined-Distribution) |

{
infoVal = 0;
for(jBin=0; jBin< nBin; jBin++)
infoVal = infoVal +

| | |
|---|---|
| Distribution-BinComparer | (benchmark-Distribution, |
| | refined-Distribution, jBin) * |
| | (probability of jBin according |
| | to refined-Distribution); |

return infoVal;
}

In an actual implementation of the present invention, multiple and different versions of Distribution-BinComparer could be used and Distribution-Comparer would call the appropriate one depending upon the contexts under which Distribution-Comparer itself is called. So, for example, Distribution-Comparer might call one Distribution-BinComparer for Explanatory-Tracker, another for the CIPFC, and still another for Performance Evaluation.

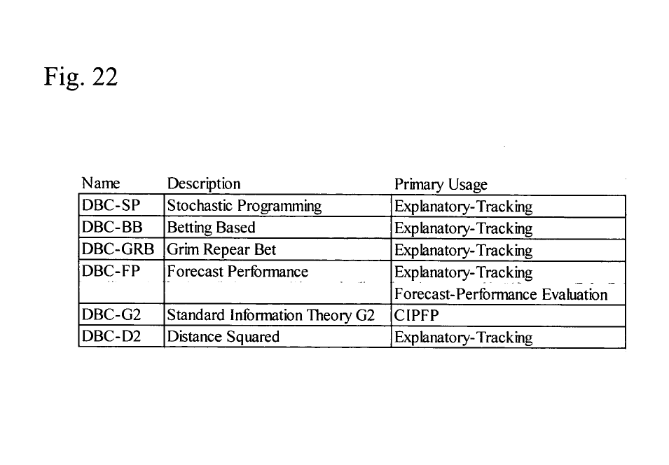

Six Distribution-BinComparer versions, with descriptions and primary use identified, are shown in FIG. 22. These versions will be explained shortly. Note that the first version, DBC-SP (Distribution-BinComparer—Stochastic Programrnming) is the general case version. As a consequence, the DBC-SP description below provides a more exact description of Distribution-BinComparer, as compared to the description thus far presented. The other five versions are arguably special cases of DBC-SP, and they can, as needed, be customized.

After the six versions have been explained, generic references to the Distribution-Comparer function will be made. Any of the versions, or customized versions, could be used in place of the generic reference, though the primary/recommended usages are as shown in FIG. 22.

III.A.3.a. Distribution-BinComparer—Stochastic Programming

Distribution-BinComparer—Stochastic Programming (DBC-SP) is the most mathematically general and complex of the six DBCs and requires custom computer programming—by a programmer familiar with Stochastic Programming—for use with the present invention.

The other five DBCs are arguably only simplifications or special cases of DBC-SP and could be built into a packaged version of the present invention. All Distribution-Comparers, except DBC-FP and DBC-G2 in usual circumstances, require parameter data exogenous to the present invention. All calculate and return an infoVal value.

Here, a stochastic programming problem is defined as any problem that can be defined as:

1. Making one or more decisions or resource allocations in light of probabilistic possibilities (First-Stage);

2. Noting which First-Stage possibilities manifest;

3. Possibly making additional decisions or resource allocations (Second-Stage);

4. Evaluating the result.

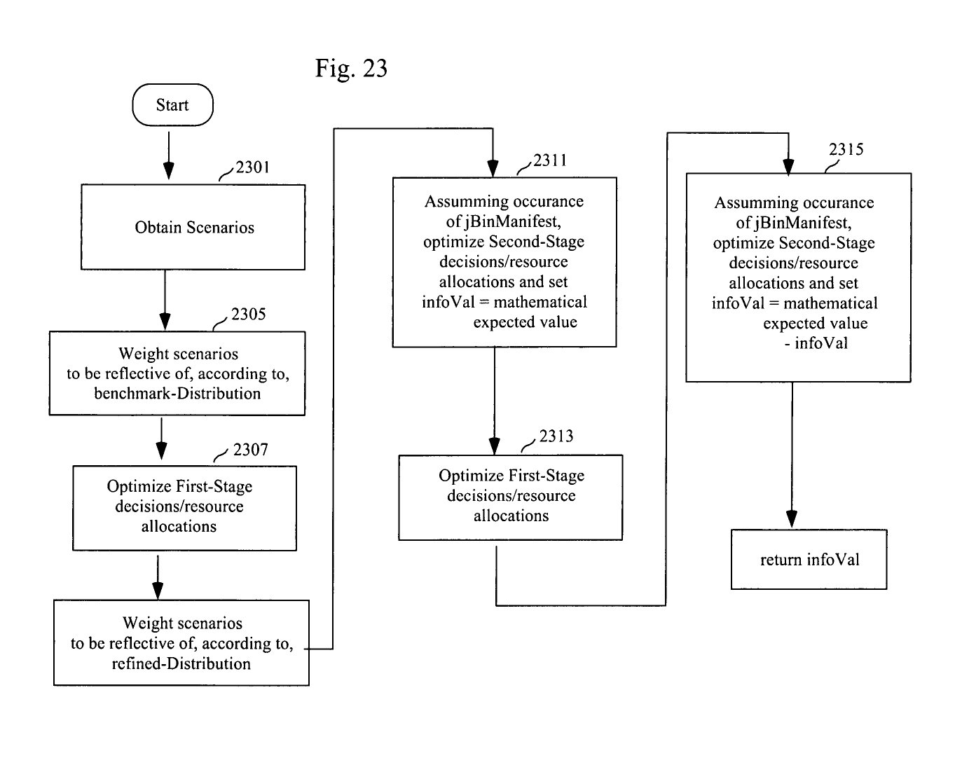

This definition encompasses large Management-Science/Operations Research stochastic programming problems entailing one or more stages, with or without recourse; but also includes simple problems, such as whether to make a bet and noting the results. Scenario optimization is a special type of stochastic programming and will be used to explain the functioning of DBC-SP. Its use for determining infoVal is shown in FIG. 23 and comments follow:

In Box 2301, the obtained scenarios may come from either the Foundational Table or from other data sources.

In Box 2305, scenarios are weighted according to the benchmark-Distribution, which could span two or more stages. For example, the benchmark-Distribution could be the joint distribution of a patient's temperature at stage-one, together with the patient's temperature at stage-two.

In Box 2311, infoVal is set equal to the expected value of the optimized Second-Stage decisions or resource allocations.

In Box 2313, First-Stage decisions/resource allocations are optimized again, though this time with the scenarios weighted by refined-Distribution.

In Box 2315, the expected value of the optimized Second-Stage decisions or resource allocations is subtracted from infoVal (of Box 2311) to yield the final infoVal.

Examples of Scenario optimization include Patents '649 and '577, U.S. Pat. No. 5,148,365 issued to Ron Dembo, and the Progressive Hedging Algorithm of R. J. Wets. Use of other types of Stochastic Programming readily follow from what is shown here. Note that the present invention could be applied to the data that is needed by the examples of scenario optimization shown in Patents '649 and '577.

Regarding the DBC variations, as will be shown, the optimizing first-stage decisions/resource allocation (of Box 2307 and 2313) can be the triviality of simply accepting the benchmark- and refined-Distributions (respectively). Similarly, the optimization of Boxes 2311 and 2315 can entail only computing the value of an objective function.

III.A.3.b. Distribution-BinComparer—Betting Based

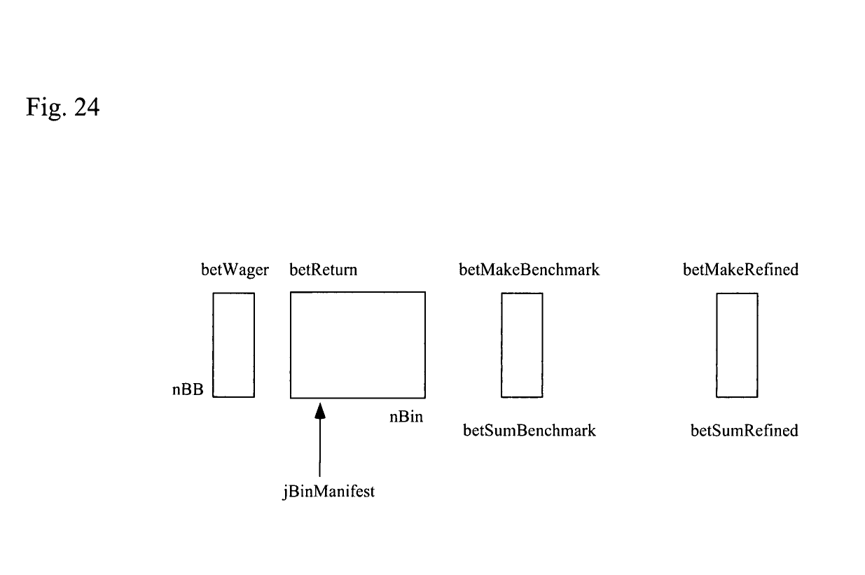

Distribution-BinComparer—Betting Based (DBC-BB) data structures are shown in FIG. 24. Vectors bet Wager, betMakeBenchmark, and betMakeRefined each have nBB elements, where 0<nBB; nBB is the number of simultaneous bets. Matrix betReturn has nBB rows and nBin columns. Each of the nBin columns of betReturn corresponds to an element of benchmark-Distribution and refined-Distribution. There are two scalars: betSumBenchmark and betSumRefined. The manifest bin is indicated by jBinManifest. The monetary amount of each bet is stored in betWager. Matrix betReturn is a bet-pay-off matrix. Element betReturn [3][4], for instance, is the payoff of bet 3 in the event that bin 4 manifests. The net monetary gain, in this instance, is thus betReturn [3][4]-betWager[3].

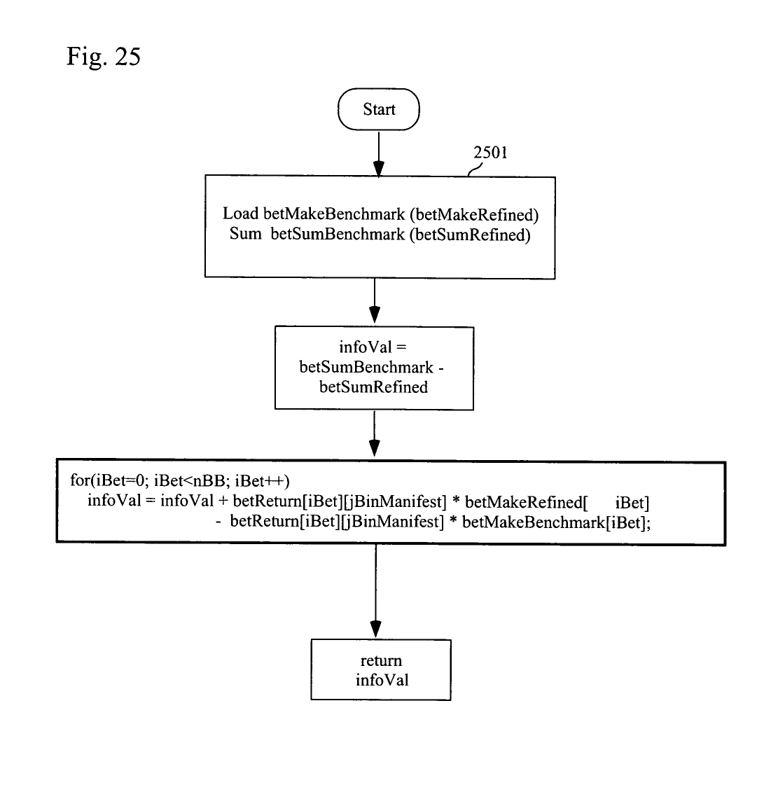

The process of calculating infoVal is shown in FIG. 25. In Box 2501, given the benchmark-Distribution (refined-Distribution) and assuming that it is correct, it is a straight-forward procedure to place 0 and 1 values in betMakeBenchmark (betMakeRefined), indicating whether each bet yields a positive mathematically-expected return (1 is placed in betMakeBenchmark [betMakeRefined], otherwise 0 is placed). This operation corresponds to Box 2307 [2313] of FIG. 23. Afterwards, betSumBenchmark (betSumRefined) is set equal to the mathematical dot-product of betWager with betMakeBenchmark (betMakeRefined). Afterwards, info Val is determined as shown in FIG. 25.

Notice that the issue is not what can be obtained under either the benchmark-Distribution or the refined-Distribution, but rather determining the incremental value of refined-Distribution over benchmark-Distribution. Also notice that scenarios are neither obtained nor weighted as shown in FIG. 23 and furthermore that there is a correspondence here with Box 2311 (Box 2315), but without a second-stage optimization.

Note also that this DBC-BB does not necessarily need to be denominated in monetary units. Other units, and even slightly miss-matched units, can be used. However, the DBC-GRB, described next, can be superior to the DBC-BB in regards to miss-matched units.

III.A.3.c. Distribution-BinComparer—Grim Reaper Bet

Distribution-BinComparer—Grim Reaper Bet (DBC-GRB) addresses potential dimension-analysis (term comes from physics and does not concern the IPFP) problems with DBC-BB, which may, metaphorically, compare apples with oranges. This problem is best illustrated by considering a terminally ill patient. If betReturn is in terms of weeks to live, what should betWager be? Medical costs?

The problem is resolved by imagining that a Mr. WA makes a bet with The Grim Reaper. (In Western Culture, The Grim Reaper is a personification of death as a shrouded skeleton bearing a scythe, who tells people that their time on earth has expired.) The Grim Reaper is imagined to offer Mr. WA a standing bet: the mean expected number of weeks of a terminally-ill person, in exchange for the number of weeks the terminally-ill person actually lives. The Grim Reaper, however, uses the benchmark-Distribution, while Mr. WA is able to use the refined-Distribution.

The value for Mr. WA of learning the refined-Distribution is simply:

Mean Of (refined-Distribution)−Mean Of (benchmark-Distribution)

If this is positive, then infoVal is set equal to the positive value (Mr. WA takes the bet). Otherwise, info Val is set equal to zero (Mr. WA declines the bet).

Calculating info Val in this way motivates Explanatory-Tracker to find the variates (BinTabs) that possibly have relevance for extending the terminally-ill person's life. Note that whether or not it is possible to extend the terminally-ill person's life, it is in the interest of Mr. WA to learn of the Explanatory-Tracker results in order to make more judicious bets. Note also that in respect to the general case method of DBC-SP, all but the last two boxes drop away here. And Box 2315 becomes a triviality of setting infoVal to the positive return when it occurs.

III.A.3.d. Distribution-BinComparer—Forecast Performance

Distribution-BinComparer—Forecast Performance (DBC-FP) is mainly used for evaluating Forecasters, but as shown in FIG. 22, can also be used for Explanatory-Tracker.

Since the Scenario-Generator as explained above requires EFDs, a technique for evaluating those who supply such distributions is needed. Returning to FIG. 18, in comparing distributions 1250 and 1850, it is apparent that the Forecaster thought that, in relation to the data, what will transpire and manifest is more likely to fall into the left, rather than the right, bin. This is apparent because, as indicated, bin 1893 has a higher probability than bin 1891. If the upcoming manifestation is such that once it has occurred it would be classified into Bin 1893, then it is appropriate to say that the Forecaster accurately predicted: the estimated probability of what manifested was higher than that suggested by the data. If the upcoming manifestation is such that once it has occurred it would be classified into Bin 1894, then it is appropriate to say that the Forecaster predicted inaccurately: the estimated probability of what manifested was lower than that suggested by the data.

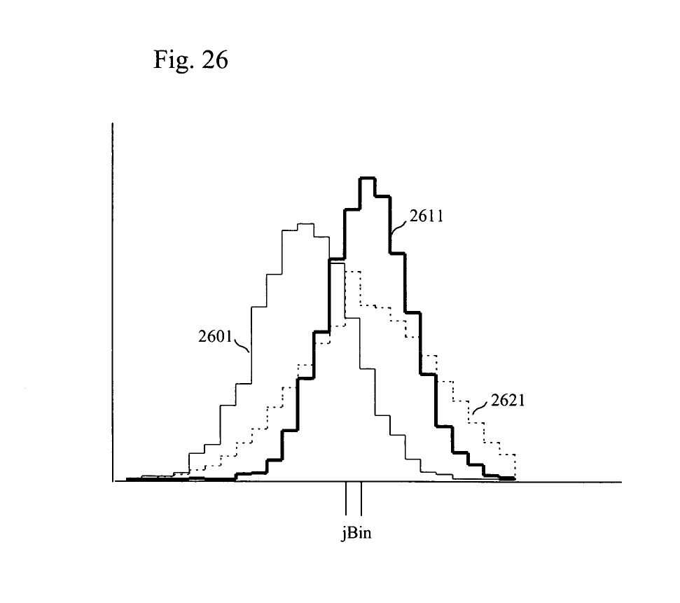

Any technique for evaluating a Forecaster is subject to Game Theoretic considerations: the Forecaster might make forecasts that are in the Forecaster's private interest, and not in the interests of the users of the forecast. This is shown in FIG. 26. Suppose the Distribution 2601 is the benchmark-Distribution and that the Forecaster thinks the correct distribution is Distribution 2621. In order to take advantage of his or her position as an agent and exploit flaws in the evaluation technique, the Forecaster might provide Distribution 2611 as a forecast. Given that Distribution 2611 has a higher mean and lower variance, compared with Distribution 2621, the user of the distribution might be happier, and thus hold the Forecaster is higher esteem.

The solution is to rate the Forecaster according to the following formula:

rating=fpBase+fpFactorΣlog(R_{jBinManifest}/B_{jBinManifest})+ΣMot_{jBinManifest} 3.0

where jBinManifest=bin that actually manifests

R_{jBinManifest}=probability of bin jBinManifest in the refined-Distribution

B_{jBinManifest}=probability of bin jBinManifest in the benchmark-Distribution

fpBase=a constant, used for scaling, usually zero (0.0).

fpFactor=a constant, used for scaling, always greater than zero (0.0), usually one (1.0).

Mot_{jBinManifest}=a constant, usually zero (0.0).

(Unusual values for fpBase, fpFactor, and Mot have special purposes that will be discussed latter. They are irrelevant to much of the analysis of Equation 3.0, but are introduced here to maintain overall unification.)

To see this, consider the perspective of the Forecaster, which is to maximize:

$$fpBase + fpFactor {\sum }_{i = 0}^{i < nBin} {t}_{i} * log ( {R}_{i} / {B}_{i} ) \qquad 4.0$$

where tᵢ is what the Forecaster actually thinks is the correct bin probability.

Differentiating with respect to Rₖ, yields:

tᵢ/Rᵢ=tⱼ/Rⱼ 4.1

Since Σtᵢ=ΣRᵢ=1, tᵢ=Rᵢ. Hence, in conclusion, the Forecaster is compelled to reveal what the Forecaster thinks.

If the Forecaster has no basis for forecasting and makes random forecasts, the mathematically expected result of Equation 3.0 is negative. To see this, assuming that constant fpBase is zero and reverting to the probabilities of Bᵢ, consider the problem from the perspective of the Forecaster, which is to maximize:

$$fpFactor {\sum }_{i = 0}^{i < nBin} {B}_{i} * log ( {R}_{i} / {B}_{i} ) \qquad 4.2$$

Differentiating with respect to the random Rₖ, yields:

Bᵢ/Rᵢ=Bⱼ/Rⱼ

Since ΣBᵢ=ΣRᵢ=1, Bᵢ=Rᵢ. Hence, at best, on average, the Forecaster receives a rating of zero when randomly making forecasts.

The results of differentiating Equation 4.0 imply that Bᵢ is irrelevant to the optimization decision. Hence, Bᵢ can be dropped from Equation 3.0, or it can be set to any arbitrary value greater than zero. Hence, the benchmark-Distribution does not need to be an empirical distribution, but can be subjectively estimated by one or more Forecasters or Analysts.

There are three special things to note about Equation 3.0 and the results shown above. First, if each plus sign in Equation 3.0 were a negative sign, and if the objective were to minimize the rating, the results would be the same. Second, the above presumes that the Forecaster is willing to provide a refined-Distribution. Third, all bins, Rᵢ and Bᵢ, are required to have positive values. There are three possibilities for either Bᵢ and/or Rᵢ not being zero:

1. If Bᵢ is positive and Rᵢ is zero, the Forecaster is providing a Refined-bin probability estimate of zero, even though the corresponding benchmark bin has a positive probability. This is reasonable, but can result in the Forecaster employing Game Theoretic considerations for private gain—at the expense of the user(s) of the forecast. Such Game Theoretic considerations can be neutralized by presuming that the Forecaster is randomly guessing, calculating the mathematically-expected extra return beyond zero that would be earned, and then penalizing the Forecaster with this extra return when and if an estimated-zero-probability Refined-bin manifests. The details of this neutralization are shown in the DBC-FP function shown below.

2. If Bᵢ is zero and Rᵢ is positive, the Forecaster is providing a positive Refined-bin probability estimate, even though the corresponding benchmark bin has a zero probability. This is reasonable, particularly if there is a lack of data, but again Game Theoretic considerations come into play, this time in the reverse manner: it is not in the private interest of the Forecaster to provide estimates for zero-probability benchmark-Distributions, since Equation 3.0 lacks a means of handling such situations. This can be addressed by presuming that the Forecaster is randomly guessing, calculating the mathematically-expected cost that the Forecaster is bearing (for reducing the estimated probabilities of bins that have positive-benchmark probabilities), and then rewarding the Forecaster with this born mathematically-expected cost as a positive-desirable bonus when the Forecaster proves correct. Details are shown in the DBC-FP function shown below.

3. If both Bᵢ and Rᵢ are zero, then neither the benchmark-Distribution nor the refined-Distribution anticipated what manifested. In this case, the rating is zero.

Accordingly, the DBC-FP version of the Distribution-BinComparer is defined as follows:

| | |
|---|---|
| double DBC-FP | (PCDistribution& benchmark-Distribution, |
| | PCDistribution& refined-Distribution, |
| | jBinManifest, |
| | fpBase /*=0*/, |
| | fpFactor /*=1*/ ) |

| { | |
|---|---|
| // defaults: | |
| // fpBase=0; | |
| // fpFactor=1; | |
| i, j, k; | |
| skipProbability=0; | |
| skipValue=0; | |
| skipCost=0; | |
| nBin = benchmark-Distribution.nRow; | |
| baseValue; | |
| if( | 0 < benchmark-Distribution[jBinManifest] && |
| | 0 < refined-Distribution[jBinManifest] ) |
| | { |

| | |
|---|---|
| baseValue = log | (refined-Distribution[jBinManifest] / |
| | benchmark-Distribution[jBinManifest]); |
| } | |

| | |
|---|---|
| if( | 0 < benchmark-Distribution[jBinManifest] && |

0 == refined-Distribution[jBinManifest] )
{
PCDistribution w;
w = benchmark-Distribution;
for( j=0; j < nBin; j++ )

if( refined-Distribution[j] == 0 )

{
w[j] = 0;
skipProbability = skipProbability +

benchmark-Distribution[j];

}

w.Norm1();
for( j=0; j < nBin; j++ )

| if( 0 < benchmark-Distribution[j] && 0 < w[j] ) | |
|---|---|
| skipValue = | skipValue + |

benchmark-Distribution [j] *
log(w[j]/benchmark-Distribution[j]);

| | baseValue = − skipValue/ skipProbability; |
|---|---|
| | } |
| if( | 0 == benchmark-Distribution[jBinManifest] && |

0 < refined-Distribution[jBinManifest] )
{
PCDistribution w;
w = benchmark-Distribution;
for( j=0; j < nBin; j++ )

| | |
|---|---|
| if( | benchmark-Distribution[j] > 0 && |

refined-Distribution[j] > 0 )
skipProbability = skipProbability +

refined-Distribution[j];

for( j=0; j < nBin; j++ )

w[j] = w[j] * skipProbability;

for( j=0; j < nBin; j++ )

if( 0 < benchmark-Distribution[j] )

{
skipCost = skipCost +

benchmark-Distribution[j] *
log(w[j]/benchmark-Distribution[j]);

}

| | |
|---|---|
| baseValue = | (− skipCost * skipProbability |

/ (1-skipProbability) );

| | } |
|---|---|
| if( | 0 == benchmark-Distribution[jBinManifest] && |

0 == refined-Distribution[jBinManifest] )
baseValue = 0;

infoVal = fpBase + fpFactor * baseValue;
return infoVal
}

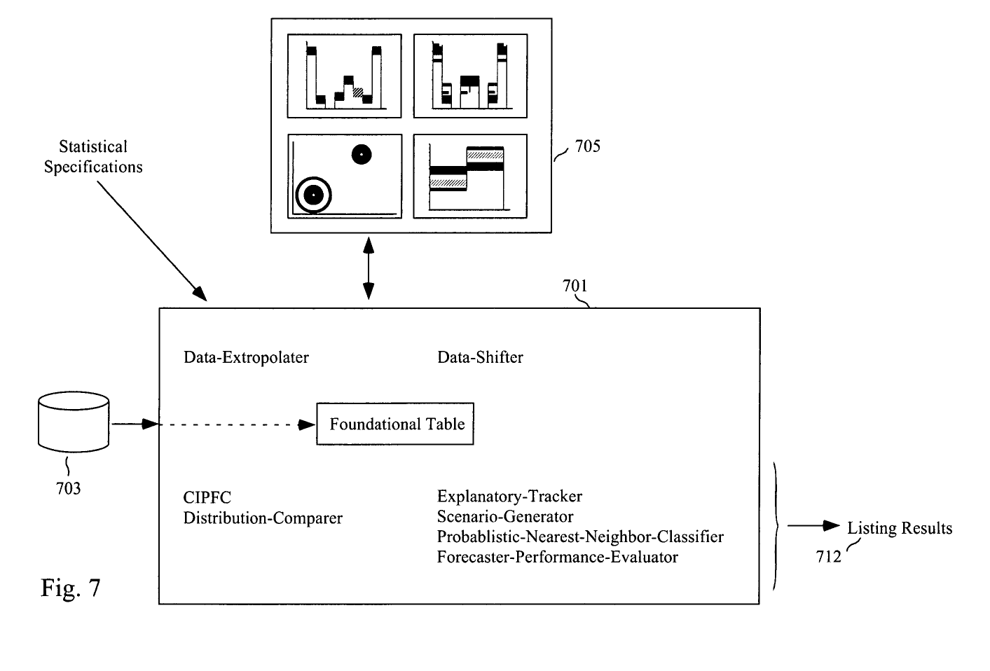

The Forecaster-Performance-Evaluator (See FIG. 7) generally determines non-default values for fpBase and fpFactor and has Distribution-Comparer uses DBC-FP.

To see DBC-FP as a special case of DBC-SP, simply consider that the objective is to beat Equation 3.0. In this case, all but the last two boxes of FIG. 23 drop away.

III.A.3.e. Distribution-BinComparer—G2

The first four Distribution-BinComparers described above determine the extra value that can be obtained as a result of using the refined-Distribution rather than the benchmark-Distribution.

Distribution-BinComparer, DBC-G2, addresses the cases where the extra value is difficult or impossible to quantify. It derives from Information Theory and represents a quantification of the extra information provided by the refined-Distribution over the benchmark-Distribution. It is based on the prior-art formula and is simply:

| | |
|---|---|
| DBC-G2 | (benchmark-Distribution, |

refined-Distribution,
jBinManifest)

| { | |
|---|---|
| if( | 0 < benchmark-Distribution[jBinManifest] && |

| 0 < refined-Distribution [jBinManifest] ) | |
|---|---|
| infoVal = | log(refined-Distribution [jBinManifest]/ |

benchmark-Distribution[jBinManifest]

else

infoVal = 0

return infoVal
}

Since it is extremely difficult to cost non-alignment of row/column proportion in the IPFP, the CIPFC has Distribution-Comparer use DBC-G2.

To see DBC-G2 as a special case of DBC-SP, simply consider that the objective is to maximize obtained information.

III.A.3.f. Distribution-BinComparer—D2

Distribution-BinComparer, DBC-D2, causes Explanatory-Tracker to search in a manner analogous with Classical Statistics' Analysis-of-Variance. It is simply:

| | |
|---|---|
| DBC-D2( | benchmark-Distribution, |

| | refined-Distribution, |
|---|---|
| | jBinManifest ) |
| { | |
| bm = | MeanOf(benchmark-Distribution) − |
| | MeanOf(benchmark-Distribution[jBinManifest]) |
| bm = | bm * bm |
| rf = | MeanOf(refined-Distribution) − |
| | MeanOf(refined-Distribution[jBinManifest]) |
| rf = | rf * rf |

infoVal = bm − rf
return infoVal
}

This DBC should be used when a forecasted distribution (e.g., Histogram 1900 of FIG. 19) is converted into a point forecast and the mathematical-curve-fitting standard of minimizing the sum of errors squared is apropos.

To see DBC-D2 as a special case of DBC-SP, simply consider that the objective is minimizing the sum of errors squared (defined as deviations from the mean) and that such a summation represents what is germane to the bigger problem at hand. (This can be the case in some engineering problems.)

III.A.4. Value of Knowing

Given the various Distribution-BinComparers, they are used to estimate the value of knowing one variate or composite variate (represented in a BinTab) for predicting another variate or composite variate (represented in another BinTab). In other words, for example, the Distribution-BinComparers are used to determine the value of knowing v₁ for predicting v₀, of knowing v₂ for predicting v₀, of knowing both v₀ and v₂ for predicting v₀, etc.

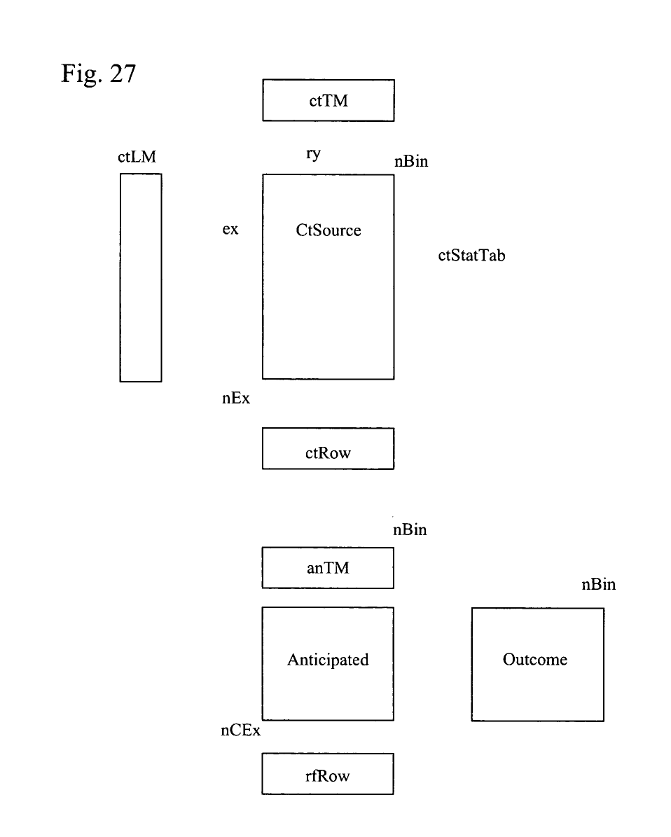

This is accomplished by creating and loading a contingency table, CtSource, as shown in FIG. 27. This contingency table has the explanatory variate (ex) on the vertical, the response variate (ry) on the horizontal, nEx rows, and nBin columns. Vectors ctTM (ct top margin) and ctLM (ct left margin) contain vertical and horizontal total propositions respectively. As will be explained, DirectCTValuation (direct contingency table valuation) directly works with CtSource to determine a value of knowing ex for predicting ry entails. Vector ctRow is initialized by loading a row from CTSource. Note that cell counts in CtSource are not necessarily integers; this is because data used to load CtSource might be fractionally weighted (by wtRef or wtCur).

SimCTValuation (simulated contingency table valuation) corrects for upward bias valuations of DirectCTValuation, by splitting CtSource into two sub-samples which are stored in contingency tables Anticipated and Outcome. Both of these tables have nCEx rows and nBin columns. Vector, anTM (Anticipated top margin) contains vertical total proportions of Anticipated. Tables Anticipated and Outcome are used by SimCTValuation to determine a value of knowing ex for forecasting ry.

Both DirectCTValuation and SimCTValuation use a C++ variable named info Val to tally the value of knowing ex for predicting ry. Before terminating, both functions initialize and load ctStatTab with their determined info Val(s) and appropriate weight(s).

DirectCTValuation considers each row of CtSource as a refined-Distribution and evaluates it against ctTM, which serves as the benchmark-Distribution. The resulting info Val values of each row are weighted by row probabilities and summed to obtain an aggregate infoVal of knowing ex for predicting ry. Specifically:

PCDistribution ctTM, ctLM, ctRow;
load contingency table CtSource

| for( | i=0; i < nEx; i++ ) | |
|---|---|---|
| | for( | j=0; j < nBin; j++ ) |

{
ctLM[i] = ctLM[i] + CtSource[i][j];
ctTM[j] = ctTM[j] + CtSource[i][j];
}

ctLM.Norm1();
ctTM.Norm1();
infoVal = 0;

| for( | i=0; i < nEx; i++ ) | |
|---|---|---|
| | { | |
| | copy row i of CtSource into ctRow; | |
| | ctRow.Norm1(); | |
| | infoVal = | infoVal + ctLM[i] * |

Distribution-Comparer(ctTM, ctRow);

}

ctStatTab.Init();
ctStatTab.Note(infoVal, 1);

Once the DirectCTValuation is completed as shown above, ctStatTab is accessed to obtain the value of using ex to predict ry. A simplest test is determining whether info Val proved positive.

DirectCTValuation relatively quickly produces a value of knowing ex for predicting ry. However, because the same structured data is simultaneously used in both the benchmark-Distribution and the refined-Distribution, the resulting value is biased upwards. SimCTValuation reduces, if not eliminates, this bias by simulating the use of ex to make forecasts of ry. The data structure is broken and data is not simultaneously used in both the benchmark-Distribution and the refined-Distribution.

In SimCTValuation, the following is repeated many times: Rows of CtSource are serially selected, random numbers of adjacent rows are combined, and the result is placed in the next available row of Anticipated. As a consequence, the number of rows in Anticipated (nCEx) is less than or equal to nEx. Using cell counts for weighting, a small depletive sample is drawn from Anticipated and placed in Outcome. Column proportions of Anticipated are then determined and placed in anTM. Now that anTM, Anticipated, and Outcome have been loaded, an evaluative test of using ex to forecast ry is made: the object is to determine whether using the rows of Anticipated as refined-Distributions beats anTM as the benchmark-Distribution—using Outcome as the generator of manifestations. Each non-zero cell of Outcome is considered; one of the six DBCs is called; and the resulting info Val is noted by ctStatTab. Details of SimCTValuation follow:

// load CtSource, nEx, and nBin

| nCycle = | number of full cycles to perform. |
|---|---|
| | (More cycles, more accuracy.) |

nSubSize = target cell sum for Outcome. Needs to be an integer.
rowCombineMax = maximum number of CtSource rows for combination.
ctStatTab.Init();

| for( | iSet=0; iSet < nCycle; iSet++ ) | |
|---|---|---|
| | { | |
| | nextFreeSetId = 0; | |
| | long srcRowSetId[nEx]; | |
| | for( | i=0; i < nEx; i++ ) |

srcRowSetId[i] = −1;

do

| | |
|---|---|
| { | |
| i = | random value such that: |
| | 0 <= i < nEx |
| | srcRowSetId[i] = −1 |
| n = | random value such that: |
| | 0 < n < rowCombineMax |
| do | |
| | { |
| | srcRowSetId[i] = nextFreeSetId; |
| | i = i + i |
| | n = n − 1 |
| | } |

| | while( 0 < n, i < nEx, srcRowSetId[i] != −1) |
|---|---|
| | nextFreeSetId = nextFreeSetId + 1 |
| | } |
| while(exist a srcRowSetId[k] = −1, where 0<= k < nEx) | |
| nCEx = −1 | |
| currentSetId = −1; | |
| for( | i=0; i < nextFreeSetId; i++ ) |

| | |
|---|---|
| for( | j=0; j < nBin; j++ ) |

Anticipated[i][j] = 0;

| | |
|---|---|
| for( | i=0; i < nEx; i++ ) |

| | |
|---|---|
| { | |
| if( | currentSetId != srcRowSetId[i] ) |
| | { |
| | currentSetId = srcRowSetId[i]; |
| | nCEx = nCEx + 1; |
| | } |
| for( | j=0; j < nBin; j++ ) |

Anticipated[nCEx][j] =
Anticipated[nCEx][j] + CtSource[i][j]

| | } |
|---|---|
| cellCtSum = 0; | |
| for( | i=0; i < nextFreeSetId; i++ ) |

| | |
|---|---|
| for( | j=0; j < nBin; j++ ) |

{
cellCtSum = cellCtSum + Anticipated[i][j];
Outcome[i][j] = 0;
}

nSub = nSubSize
while(0 < nSub)

| { | |
|---|---|
| cutOff = Random floating-point | |
| value between 0 and cellCtSum | |
| for( | i=0; i < nCEx; i++ ) |

| | |
|---|---|
| for( | j=0; j < nBin; j++ ) |

| { | |
|---|---|
| cutOff = cutOff − Anticipated; | |
| if( | cutOff <= 0 ) |

| { | |
|---|---|
| if( | Anticipated[i][j] >= 1 ) |

ct = 1

else

ct = Anticipated[i][j]

Anticipated[i][j] =
Anticipated[i][j] − ct;
Outcome[ i][j] = Outcome[ i][j] + ct;
nSub = nSub − ct;
goto whileCont
}

}

| | whileCont: |
|---|---|
| | } |
| PCDistribution anTM, rfRow; | |
| for( | i=0; i < nCEx; i++ ) |

| | |
|---|---|
| for( | j=0; j < nBin; j++ ) |

anTM[j] = anTM[j] + Anticipated[i][j]

| anTM.Norm1(); | |
|---|---|
| for( | i=0; i < nCEx; i++ ) |

| { | |
|---|---|
| Copy row i of Anticipated to rfRow | |
| rfRow.Norm1(); | |
| for( | j=0; j < nBin; j++ ) |

| | |
|---|---|
| if( | 0 < Outcome[i][j] ) |

```
  {
  infoVal =
```

```
  Distribution-BinComparer( anTM,
  rfRow, j)
```

ctStatTab.Note(infoVal,

Outcome[i][j] / cellCtSum);

}

}

}

Once the SimCTValuation is completed as shown above, ctStatTab is accessed to obtain the value of using ex to predict ry. The simplest test is determining whether the weighted mean of infoVal proved positive.

III.A.5 CIPFC (Compressed Iterative Proportional Fitting Component)

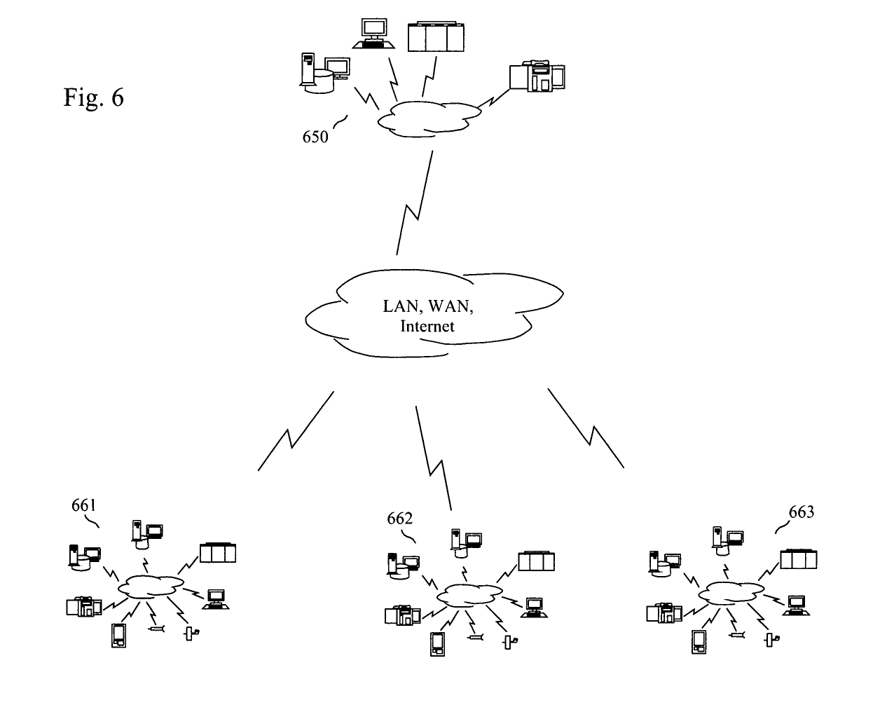

Referring back to the VV-Dataset, an outstanding issue regards using the CIPFC, shown in FIG. 6, to generate the wtCur weights based upon the Forecaster's EFDs, in this instance, v₁, v₃, and v₅.

The CIPFC has two aspects: Computational Tactics and Strategic Storage.

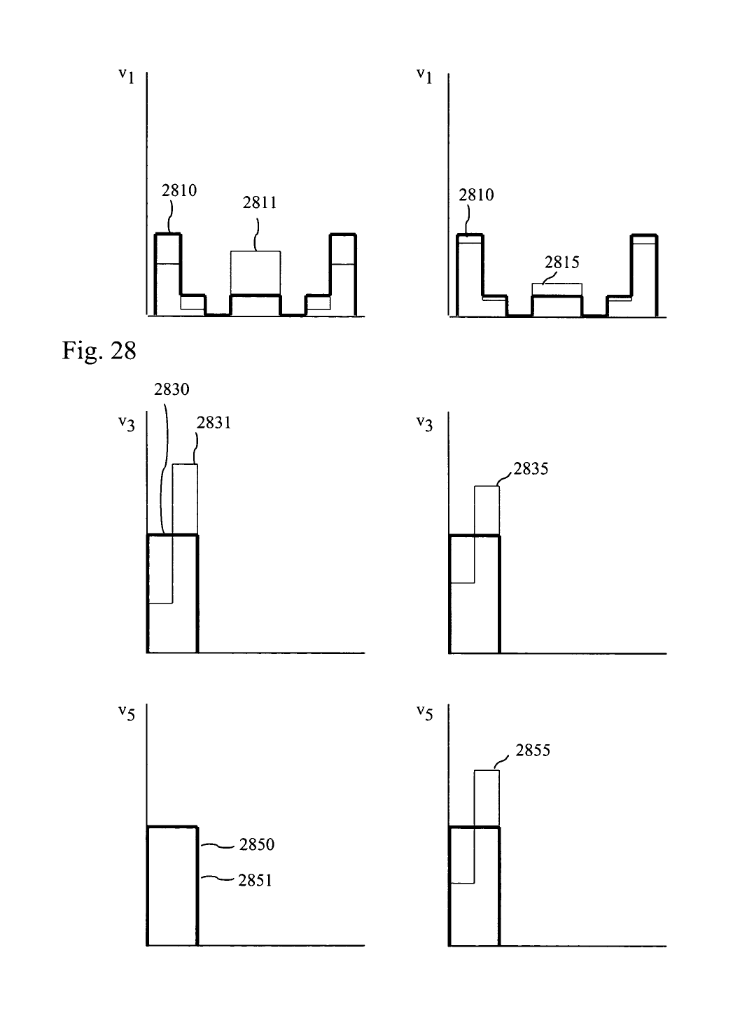

CIPFC's Computational Tactics has two sub-aspects: Smart Dimension Selecting and Partial Re-weighting. Both are demonstrated in FIG. 28. On the left of the figure are histograms for v1, v3, and v5 where histograms 2810, 2830, and 2850 are the EFDs, or target proportion histograms (tarProp), provided by the Forecaster, and where histograms 2811, 2831, and 2851 are the proportions (curProp) thus far achieved—presuming, for the moment, that thus far a standard IPFP has been used to determine weights. Dimension v5 has just been brought into alignment with the target proportions, and so consequently, histograms 2850 and 2851 overlap perfectly.

Now, rather than serially considering each dimension, the CIPFC's Smart Dimension Selecting uses a Distribution-BinComparer (usually DBC-G2) to find the curProp distribution that is most different from the tarProp distribution. So, in this example, at this stage, v1 might be selected. Now, rather than re-weighting v1's weights so that v1's distribution 2811 exactly matches distribution 2810—which would substantially aggregate the lack of fit for v3 and v5 (jointly) and which would ultimately lead to non-convergence—Partial Re-weighting blends existing weights of v1 with newly calculated weights (Full-Force Weights) to find the weights that result in an overall best fit across all dimensions. Histograms 2815, 2835, and 2855 show the results of Partial Re-weighting immediately after the weights of v1 have been adjusted. Note the partial convergence of v1's curProp (Histogram 2815) to v1's tarProp (Histogram 2810). Partial Re-weighting operates in a smart trial-and-error fashion. It initially starts with weighting existing weights at zero and weighting Full-Force Weights at 100%. As it continues, the Full-Force Weights are given less and less importance. When selecting dimensions, Smart Dimension Selecting considers the results of Partial Re-weighting.

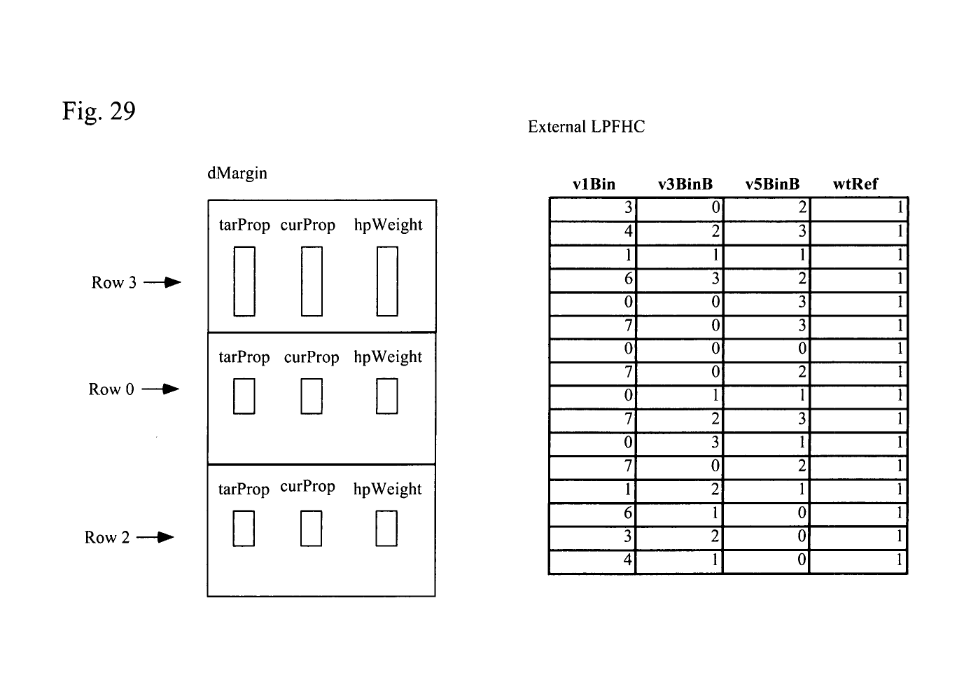

CIPFC's Strategic Storage also has two sub-aspects: The LPFHC (Linear Proportional Fitting Hyper Cube) and the DMB (Dimensional Margin Buffer). The latter is an improvement over the former. The advantage of the LPFHC over the PFHC comes into play as the sparseness of PFHC increases. To better demonstrate this, consider that variates v₃ and v₅ of FIG. 9 are re-categorized into four bins as shown in FIG. 11. Columns v1Bin, v3BinB, v5BinB, wtRef of FIGS. 9, 10, and 11, can be extracted and re-written as shown in the right of FIG. 29—this is an External LPFHC. For tallying, LPFHC is scanned vertically, indexes are read horizontally across each LPFHC row, and curProp is tallied. As shown, the LPFHC's first-row references into dMargin are marked in FIG. 29. Note that this LPFHC requires 64 memory locations (16*4), while if the columns v1Bin, v3BinB, v5BinB, wtRef of FIGS. 9, 10, and 11 were loaded into a PFHC, 128 (8*4*4) memory locations would be required.

The advantage of the LPFHC exponentially increases as the number of dimensions increases. So, for example, if a fourth dimension of say six levels were added, the LPFHC would require 80 (64+16) memory locations, while the PFHC would require 768 (128*6).

Using the LPFHC to tally curProp is somewhat the reverse of using a PFHC: the table is scanned, indexes are retrieved, and tallies made. The specifics for tallying curProp using the LPFHC follow:

| for( | i=0; i < 8; i++ ) |
|---|---|
| | dMargin[0].curProp[i] = 0; |
| for( | i=0; i < 4; i++ ) |
| | dMargin[1].curProp[i] = 0; |
| for( | i=0; i < 4; i++ ) |
| | dMargin[2].curProp[i] = 0; |
| for( | iRow=0; iRow < 16; iRow++ ) |

| { | |
|---|---|
| i = v1Bin[ iRow]; | |
| j = v3BinB[iRow]; | |
| k = v5BinB]iRow]; | |
| wtRow = | wtRef[iRow] * |

dMargin[0].hpWeight[i] *
dMargin[1].hpWeight[j] *
dMargin[2].hpWeight[k];

dMargin[0].curProp[i] = dMargin[0].curProp[i] + wtRow;
dMargin[1].curProp[j] = dMargin[1].curProp[j] + wtRow;
dMargin[2].curProp[k] = dMargin[2].curProp[k] + wtRow;
}

The LPFHC of FIG. 29 is termed here an External LPFHC. Rather than working with the External LPFHC of FIG. 29, the v1Bin and wtRef columns in FIG. 10 and the v3BinB and v5BinB columns of FIG. 11 could be accessed directly. When data is accessed in this way, i.e., the data is not copied and laid-out as in FIG. 29, but rather is accessed from an original source, the LPFHC is said to be an Internal LPFHC.

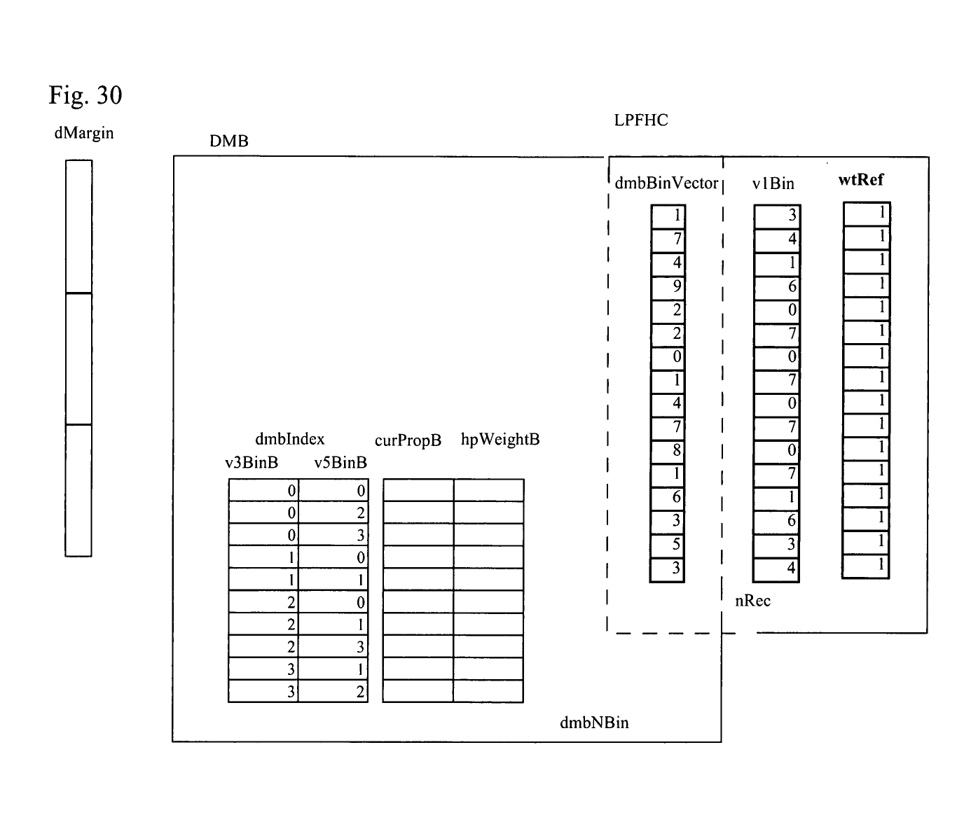

The DMB object stands between the dMargin vector and the LPFHC. It both reduces storage requirements and accelerates the process of tallying curProp. An example DMB is shown in FIG. 30, with the four main components: curPropB, hpWeightB, dmbIndex, and dmbBinVector. Both curPropB and hpWeightB correspond to curProp and hpWeight of dMargin, but have slightly different names to help facilitate a comparison with the prior-art. Component dmbIndex contains a list of indexes into the dMargin vector and the dMargin sub-vectors. In this example, dmbIndex contains indexes for both v3BinB and cSBinB. Each index in dmbIndex, curPropB, and hpWeightB all have the same number of elements. Vector dmbBin Vector contains indexes to curPropB and hpWeightB. Columns v3BinB and v5BinB of the External LPFHC in FIG. 29 have redundancies. For instance, the pair “v3BinB=1, v5BinB=0” occurs twice. Each pair variation can be included in dmbIndex as shown in FIG. 30. The indexes to each pair are stored in dmbBin Vector as shown. So, for example, the 1^{st} element of dmbBin Vector contains a 7 (dmdBin Vector has a 0^{th} element, which is 1). The 7^{th} element of the dmbindex pair contain 2, 3, which corresponds to the 1^{st} entry in the External LPFHC of FIG. 29 (LPFHC also has a 0^{th} element).

The dmdBin Vector is a type of LPFHC hyper column that reduces the storage requirements for the LPFHC. As can be seen in the FIG. 30, the size of LPFHC has been reduced by a fourth from what it was in FIG. 29. Offsetting this reduction, of course, are the memory requirements for the DMB. The major elements of the DMB—dmbIndex, curPropB, and hpWeightB—soon reach an upper limit as problem size increases. So, for example, suppose that the LPFHC in FIG. 29 had 10,000 rows. At most the dmbIndex, curPropB, and hp WeightB would require 64 memory locations (4*16), while the savings resulting from using dmdBin Vector is almost 10,000 memory locations. Besides saving space, the DMB speeds tallying by eliminating arithmetic operations.

When tallying curProp, the vector hp WeightB is initialized using the dmbIndex indexes and weights contained in hpWeights. The LPFHC is scanned, but rather than fetching three index values, i.e.:

i=v1Bin[iRow];

j=v3BinB [iRow]

k=v5BinB [iRow];

only two are fetched:

i=v1bin[iRow];

jk=dmiBinVector[iRow];

Rather than performing four multiplications, i.e.:

wtRow=wtRef[iRow]*

dMargin[0].hpWeight[i]*

dMargin[1].hpWeight[j]*

dMargin[2].hpWeight[k];

only three are performed:

wtRow=wtRef[iRow]*

dMargin[0].hpWeight[i]*

hpWeightB[jk]

Rather than doing three curProp additions, i.e.:

dmargin[0].curProp[i]=dmargin[0].curProp[i]+wtRow;

dMargin[1].curProp[j]=dMargin[1].curProp[j]+wtRow;

dMargin[2].curProp[k]=dmargin[2].curProp[k]+wtRow;

only two are performed:

dmargin[0].curProp(i)=dMargin[0].curProp[i]+wtRow;

curPropB[jk]=curPropB[jk]+wtRow;

Once the scan is complete, the values in curPropB are posted to the curProp vectors in dMargin.

Ignoring the initiation of hpWeightB (which requires at most 16 multiplications) and the transfer from curPropB to the curProps of dMargin (which requires at most 32 additions), using the DMB to perform IPF Tallying reduces the number of multiplications by one-fourth and the number of additions by one-third.

Note that multiple DMBs can be used along side each other to obtain an exponential reduction in the number of needed multiplications and additions for tallying. Also note the dmbindex can be implied. So, for example, because there are only 4 categories in v3BinB and in v5BinB, the dmbindex (and curPropB and hpWeightB) of FIG. 30 would have a maximum of 16 rows. Memory could be saved by having dmbIndex empty, having six additional non-used elements in curPropB and hpWeightB, and inferring v3BinB and v5BinB index values based upon row location.

Returning back to FIG. 10, once the wtCur weights have been determined, or if wtRef is directly accepted, then several things can be done:

1. Data values can be shifted/edited by the Forecaster.

2. Scenarios can be generated.

3. The data can be used for Probabilistic-Nearest-Neighbor Classification (PNNC).

As will be explained in detail later, the Forecaster can edit data by shifting or moving data points on a GUI screen. As will also be explained in detail later, scenarios are generated by sampling the Foundational Table and by directly using the Foundational Table and wtCur.

III.A.6. Probabilistic-Nearest-Neighbor Classification

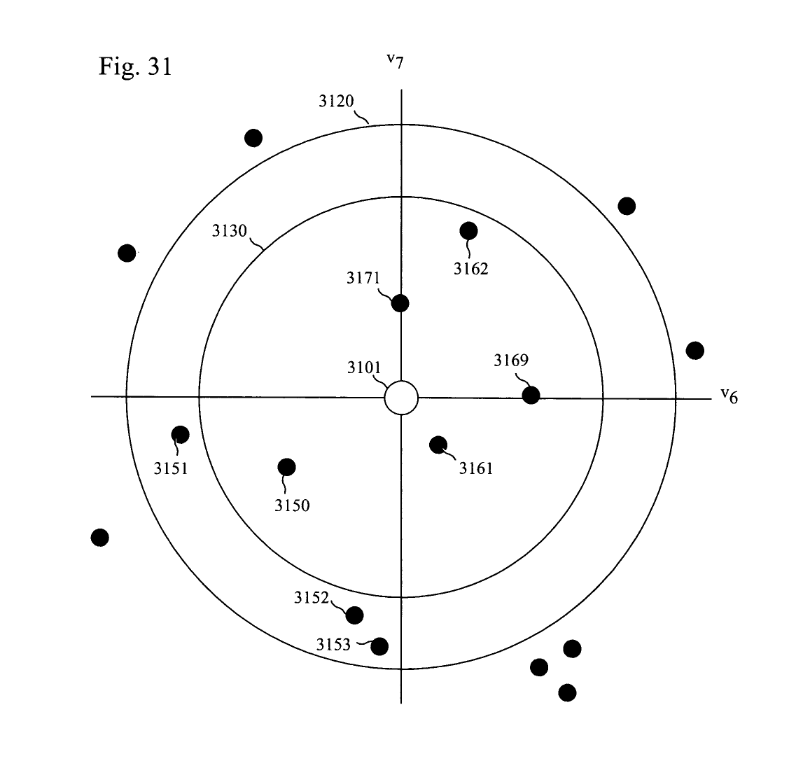

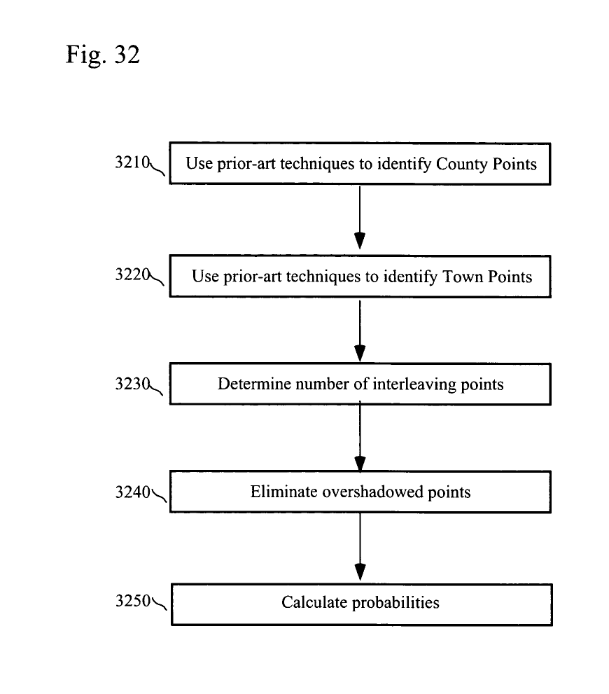

FIG. 31 will be used to demonstrate Probabilistic-Nearest-Neighbor-Classifier. An xy-graph of variates v₆ and v₇ is shown. Variates v₆ and v₇ are being introduced here for the first time and, for exemplary purposes, are assumed to be part of the Foundational Table. Open Point 3101 is the point for which probabilistic nearest neighbors are sought. The steps for determining Probabilistic-Nearest-Neighbors are shown in FIG. 32.

In Box 3210, prior-art techniques are used to select k-nearest neighbors from the Foundational Table. Note that the selection is done without regards to wtRef and wtCur. The k points are termed here as County Points. In this particular instance, they are enclosed by a Circle 3120 in FIG. 31. Points outside of the County are ignored.

In Box 3220, a subset of County Points that are nearest open point 3101 are identified. These points are termed here as Town Points. In this particular example, they are enclosed by Circle 3130 in FIG. 31.

In Box 3230, for each Town Point, the number of interleaving County points is determined. An interleaving point is one that would be closer to the open point, given any projection onto any subset of axes. So, for example, Point 3151 is an interleaving point for Point 3150, since if the v₆ dimension is ignored, Point 3151 is between Point 3150 and the Open Point on the v₇ axis. Similarly, Points 3152 and 3153 are interleaving points for Point 3150; similarly, Points 3161 and 3162 are interleaving points for Point 3169.

In Box 3240, overshadowed points are eliminated from the Town set of points. An overshadowed point is one that is, irrespective of axis scaling, further away from the Open Point than another Town point. So, for example, Point 3162 is overshadowed by Point 3171.

In Box 3250, for each remaining Town point, the number of interleaving points is incremented by 1.0. Afterwards, for each Town Point, the inverse of the number of interleaving points is calculated. These inverse values are normalized to sum to 1.0. These values are in turn multiplied by the corresponding wtCur. Again, the sum is normalized to 1.0. The result is a probability vector containing the probabilities that each Town Point is the nearest neighbor to the Open Point.

Computer simulations have demonstrated that basing probability on the number of interleaving points as shown above yields significantly higher probability estimates for actual nearest-neighbors than does simply assigning each point an equal probability. Later, a pseudo-code listing applying Probabilistic-Nearest-Neighbor Classification to the problem of FIG. 31 will be provided.

III.B. Risk Sharing and Trading

Even though all of the above—identifying explanatory variates, making forecasts, and comparing distributions—helps to understand the world and manage risk, it omits a key consideration: risk sharing and risk trading. This is addressed by the Risk-Exchange, which employs mathematics analogous to Equation 3.0. Such mathematics are introduced next. Afterwards, the previously mentioned near-impossibility for Artichoke farmers to trade risk is used as an example to provide an overview of the Risk-Exchange's function and use, both internal and external.

Suppose that the orientation of Equation 3.0 is reversed, that Bᵢ is replaced with Gᵢ, that Rᵢ is replaced with Cᵢ, that fpFactor is replaced with cQuant, that fpFactor and Moti are dropped, and the right portion is negated. The result is:

rating=−cQuantΣlog(Cᵢ/Gᵢ) 6.0

where

Cᵢ=probability of bin i

in the c-Distribution

Gᵢ=probability of bin i

in the geoMean-Distribution

Suppose further that Equation 6.0 is applied to Traders, rather than Forecasters. The result is that the Traders get negative ratings and/or need to make a payment when correct! Given such a result, a reasonable first response is for a Trader to minimize 6.0. Now if an incorrect assumption is made, that ΣGᵢ=1, then minimizing 6.0 becomes the same as maximizing 3.0, and hence the results regarding 3.0 apply: the Traders are compelled to reveal what they think. As will be shown, however, ΣGᵢ<1, and thus Traders are not fully compelled to reveal what they think.

Returning to a previous example, suppose again that a small town has several artichoke farmers who have different opinions about whether the artichoke market will shrink or grow over the next year. Farmer FA believes that the market will shrink 10%; Farmer FB believes that market will grow by 5%; and so on for Farmers FC, FD, and FE. Each Farmer has an individual assessment, and will make and execute plans as individually deemed appropriate: for example, Farmer FA leaves her fields fallow; Farmer FB purchases new equipment to improve his yield; and so on.

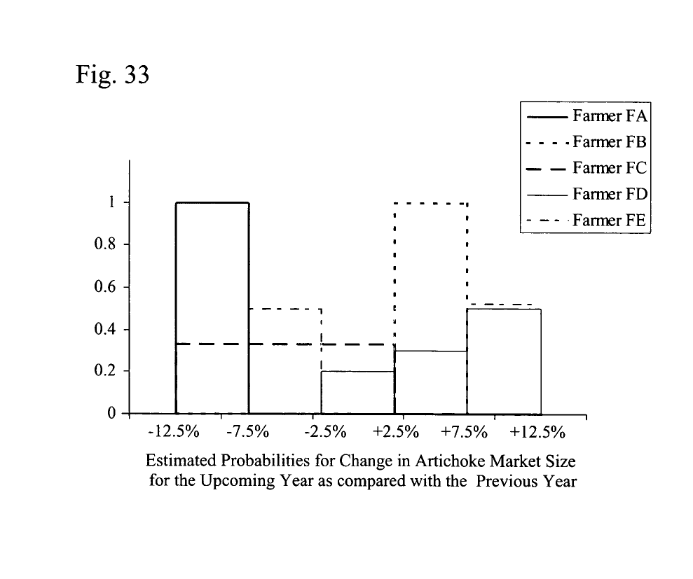

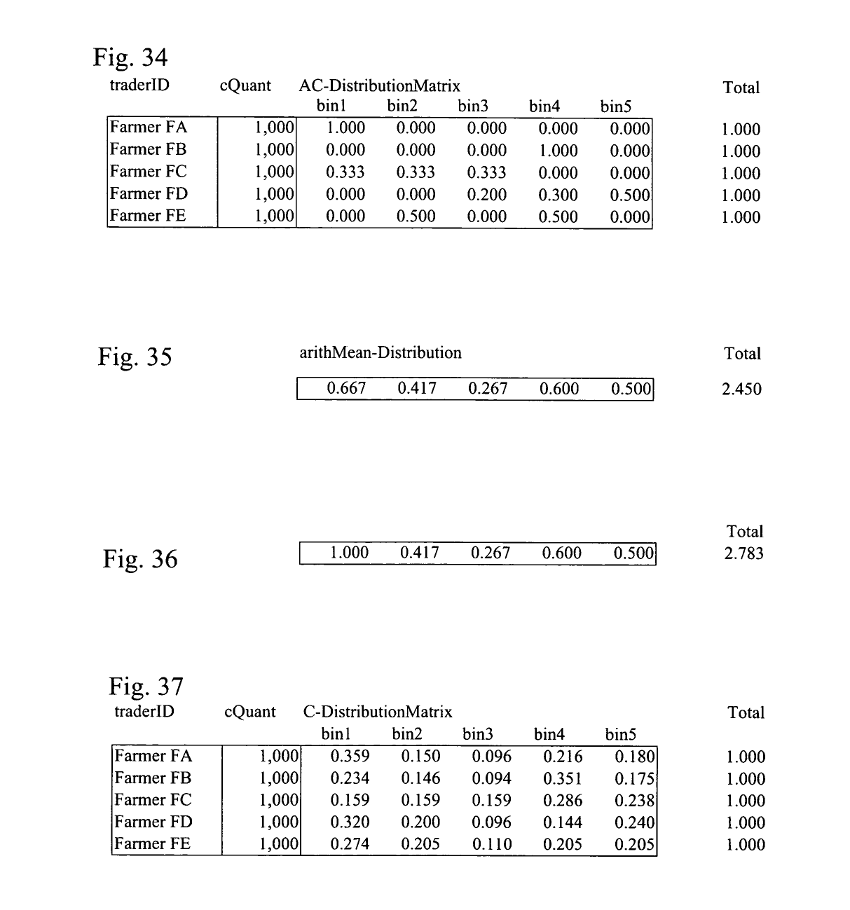

In order to share their risks—for example, ultimately either Farmer FA or Farmer FB will be proved wrong—each farmer sketches a distribution or histogram representing their individual forecasts. Such distributions are shown in FIG. 33 with five bins. These distributions are termed ac-Distributions (ante-contract Distributions). They are shown in tabular format in FIG. 34, where matrix AC-DistributionMatrix contains each Farmer's ac-Distribution.

In FIG. 34 through FIG. 56, essential data used/created by the present invention is enclosed by rectangles that represent actual data structures of the present invention. Labels and pedagogical aggregate data are shown outside of the rectangles. For illustrative purposes, data has been rounded: the results shown may not reproduce exactly.

Because Equation 6.0 requires that Cᵢ and Gᵢ both be positive, each Farmer could be required to directly provide only positive bin probabilities. Nothing in the present invention precludes imposing such a requirement: the farmers could be required to directly provide c-Distributions, which will be introduced shortly. However, it is perhaps fairer and more considerate to allow Farmers to specify zero-probability bins and in the place of such zero probabilities insert mean values. This is tantamount to allowing Farmers to claim no special knowledge or regard concerning some bins and accepting consensus opinion. This calculation procedure is shown in FIG. 35 through FIG. 37.

Arithmetic means, excluding zero values, for each bin/column of AC-DistributionMatrix are calculated, as shown in FIG. 35. Next, for each Farmer, zero-bin values are replaced by these mean values. FIG. 36 shows such a replacement for Farmer FA. For each Farmer, the results are normalized to sum to one, which yields what is termed the Contract Distribution (c-Distribution). The c-Distributions are stored in matrix C-DistributionMatrix as shown in FIG. 37. The result of normalizing Farmer's FA vector of FIG. 36 is the first row of C-DistributionMatrix of FIG. 37.

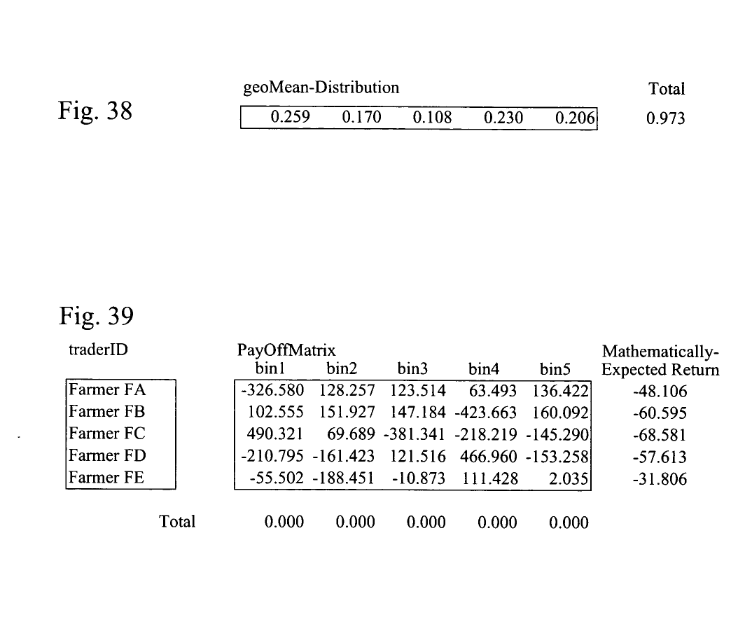

Next, a weighted (by cQuant) geometric-mean is calculated for each bin (column) of C-DistributionMatrix. The result of is, what is termed here, the geoMean-Distribution as shown in FIG. 38.

Now if both C-DistributionMatrix and geoMean-Distribution are used as per Equation 6.0, then the result is matrix PayOffMatrix as shown in FIG. 39. Each row of PayOffMatrix is called PayOffRow. The PayOffMatrix should be considered a collection of PayOffRows.

Assuming the Farmers have finalized their ac-Distributions and cQuant (contract quantity), then PayOffMatrix defines, say a one-year, contract between the five farmers. For one year, the PayOffMatrix is frozen; the Farmers pursue their individual private interests as they best see fit: Farmer FA leaves her fields fallow; Farmer FB obtains new equipment, etc.

At the end of the year, depending upon which bin manifests, PayOffMatrix is used to determine monetary amounts that the farmers need to contribute or can withdraw. So, for example, if the first bin manifests, Farmer FA would contribute 326.580 monetary units (MUs) since, as per Equation 6.0:

−326.580=−1000*log(0.359/0.259)

Farmer FB, on the other hand, would withdrawal 102.555 MUs, since, as per Equation 6.0:

102.555=−1000*log(0.234/0.259)

Notice the inherent fairness: Farmer FA gained by leaving her field fallow and having the manifested bin prove as she expected; Farmer FB lost by obtaining the unneeded new equipment and by having the manifested bin prove not as he expected. The presumably fortunate, pays the presumably unfortunate.

Now suppose that the situation is reversed and that Bin 4 manifests: Farmer FA withdraws 63.493 MUs, while Farmer FB contributes 423.663. Farmer FA lost by leaving her fields fallow, missing a good market, and having the manifested bin prove not as she expected. Farmer FB gained by being able to capitalize on the new equipment and having the manifested bin prove as he expected. The presumably fortunate, pays the presumably unfortunate.

This presumably fortunate paying the presumably unfortunate is a key benefit of the present invention: The farmers are able to beneficially share different risks, yet avoid blockages and costs associated with insurance and other prior-art techniques for risk trading and sharing.

An inspection of FIG. 39 reveals several things. In the same way that Farmers FA and FB mutually benefit, all the Farmers benefit: those faced with unexpected bin manifestations and who presumably did poorly are compensated by those that faced expected bin manifestations and who presumably did well. The column totals on the bottom all equal zero: contributions equal withdrawals, which is a mathematical result of using geometric means as the denominator in Equation 6.0. As shown in the rightmost column, each Farmer's mathematically-expected return is negative. So in a simple monetary sense, they all lose. However, they all individually gain by hedging their risk and from economic-theory-utility perspective are all individually overall better off.

Prior to PayOffMatrix being finalized, each Farmer can review and edit their ac-Distributions, view geoMean-Distribution, and view their row in PayOffMatrix. This provides Farmers with an overall market assessment of bin probabilities (that they may act upon) and allows them to revise their ac-Distributions and to decide whether to participate. If all of a Farmer's bin probabilities are higher than the corresponding geoMean-Distribution bin probabilities, then the Farmer should withdraw, or be automatically excluded, since whichever bin manifests, the farmer faces a loss. (This oddity is possible since the sum of geoMean-Distributions bins is less than 1.0 and each Farmer is ultimately required to provide bin probabilities that sum to 1.0.)

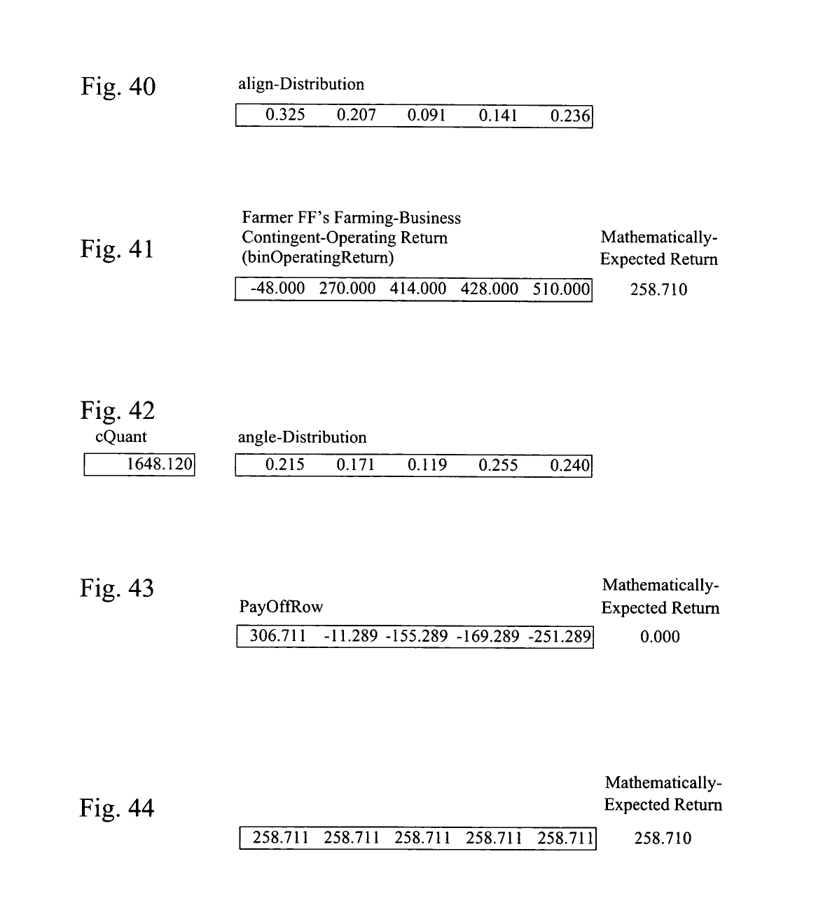

Even though risks are shared by each farmer by providing c-Distributions and participating as described above, if so elected, each Farmer could advantageously consider both their own potential-contingent returns and the geoMean-Distribution. So, for example, suppose that a Farmer FF, from his farming business, has potential contingent returns as indicated in FIG. 41. Suppose further, that Farmer FF has subjective or objective bin probabilities estimates as indicated in FIG. 40. This distribution is called an align-Distribution, since it ideally aligns with the farmer's (Trader's) own private beliefs and expectations. The net result is that the Farmer has a mathematically-expected return of 258.710 from his farming operation. But the Farmer faces considerable variance in return: if the first bin manifests, the return is a −48; if the fifth bin manifests, the return is 510.

Now suppose that the PayOffMatrix is not yet finalized and that geoMean-Distribution is, for the moment, constant. Five equations of the form:

cQuant*log(angleᵢ/geoMean-Distributionᵢ)=(mathematically expected return)−binOperatingReturnᵢ

and one equation of the form:

Σangleᵢ=1

are specified and both angles and cQuant determined. (Angle: A tricky method for achieving a purpose—Simon & Schuster, Webster's New World Dictionary, 1996)

Solving these equations is handled by the DetHedge function, and for the case at hand, the result is shown in FIG. 42. Still holding geoMean-Distribution constant, the return for each bin is shown in FIG. 43. Note:

306.711=−1648.120*log(0.215/0.259);

Given the bin probabilities of the align-Distribution in FIG. 40, the mathematically-expected return for the 1648.120 contracts is 0.0. In other words, the mathematical dot-product of align-Distribution and PayOffRow is 0.0.

Now if FIG. 41 and FIG. 43 are combined, the result is shown in FIG. 44: all the bins have the same value, which is equal to the expected 258.710 previously mentioned. Hence, in order to achieve a perfect hedge, Farmer FF submits angle-Distribution (of FIG. 42) as his ac-Distribution and specifies a cQuant of 1648.120. Farmer FF's submission will ultimately cause a change in geoMean-Distribution, but this will be addressed later.

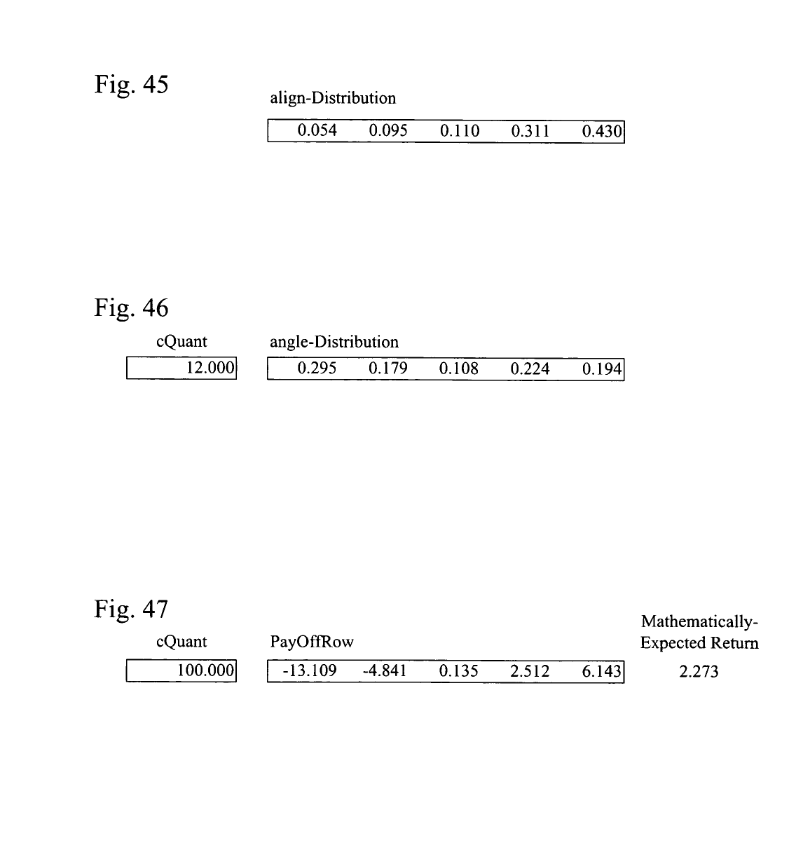

Now suppose a Speculator SG with an align-Distribution as shown in FIG. 45. This speculator is deemed to believe in her align-Distribution to the extent of being willing to bet on it. Continuing to hold geoMean-Distribution constant, Speculator SG could make her mathematically-expected return arbitrarily large by making one or more angle-Distribution bin probabilities arbitrarily small since:

log(angleᵢ/geoMean-Distributionᵢ)→infinity, as angleᵢ→0

If this were allowed to happen, the utility of sharing and trading risks as described here could be undermined. The solution is to require that each ac-Distribution bin probability be either zero (to allow mean insertion as described above) or a minimum small value, such as 0.001, to avoid potentially infinite returns. (Computational-numerical-accuracy requirements dictate a minimum small value, assuming a positive value.)

By using equations similar to those just introduced, a cQuant and angle-Distribution can be determined to place Speculator SG in position, analogous, yet superior to a Forecaster who is compensated according to Equation 3.0. The superiority comes about by capitalizing on the geoMean-Distribution bins' summing to less than 1.0. These calculations are performed by the SpeculatorStrategy function, which will be presented later.

For the case at hand, the resulting cQuant and angle-Distribution are shown in FIG. 46. Using the angle-Distribution as the ac-Distribution yields a positive expected return for Speculator SG. Scalar cQuant need not be 12.000, but rather can be used to scale the PayOffRow. So, for example, Speculator SG could set cQuant equal to 100 to obtain the PayOffRow as shown in FIG. 47-with an overall mathematically-expected return of 2.273. (−13.109=−100*log(0.295/0.259); 13.109×0.054+ . . . =2.273.)

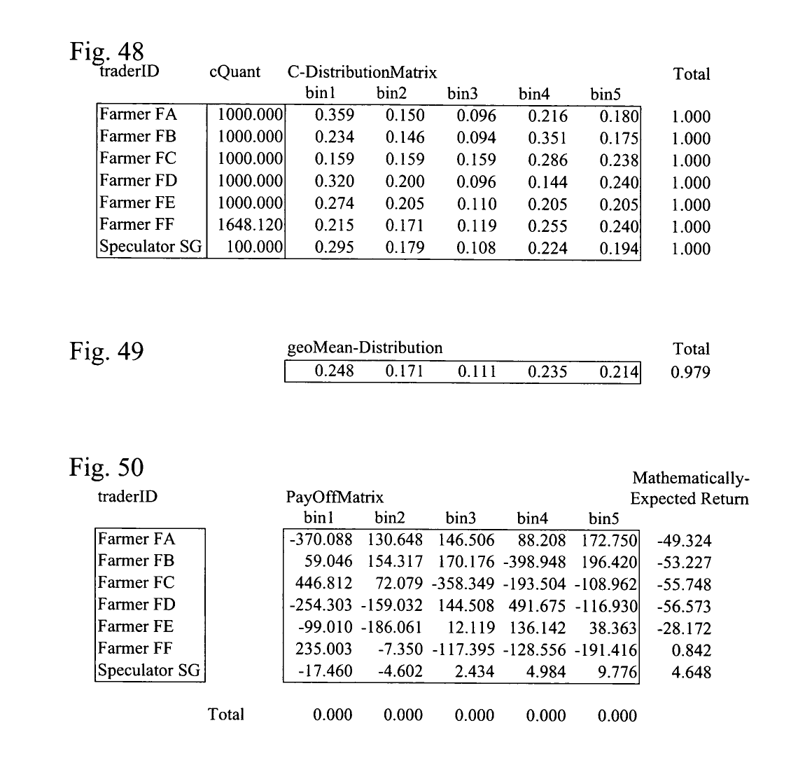

Now assume that both Farmer FF and Speculator SG submit their angle-Distributions as c-Distributions. FIG. 48 shows the inclusion of these c-Distributions in C-DistributionMatrix. FIG. 49 shows the updated resulting weighted geoMean-Distribution. FIG. 50 shows the resulting PayOffMatrix. To the right of FIG. 50 is the Mathematically-expected return for each Farmer and the Speculator. For the first five rows, PayOffMatrix cells were multiplied by cells in C-DistributionMatrix, e.g.,

0.359×−370.088+ . . . +0.180×172.750=−49.324.

For Farmer FF and Speculator SG, their original align-Distributions were used, e.g.

0.325×235.003+ . . . +0.236×−191.419=0.842

Comparing the Mathematically-expected returns in FIG. 50 with those shown in FIG. 39 reveals that some farmers gained, while one Farmer (FA) lost. Since the first five Farmers' aggregate mathematically-expected return changed from −266.701 to −243.044, arguably they gained in aggregate. Both Farmer FF and Speculator SG also gained.

As mentioned before, prior to PayoffMatrix being finalized, each Farmer, together now with the Speculator, can review and edit their ac-Distributions, view geoMean-Distribution, and view their row in PayOffMatrix. As all Farmers and the Speculator update their cQuants, angle-Distributions, and ac-Distributions, their risk sharing becomes increasingly precise and an overall Nash Equilibrium is approached. (The “Theory of the Core” in economics suggests that the more participants, the better.)

Finalizing Pay QfMatrix is actually better termed “Making a Multi-Party Contract Set” (MMPCS). MMPCS entails, as described above, determining a geoMean-Distribution and calculating PayOffMatrix. It also entails appending PayOffMatrix to a PayOffMatrixMaster. Multiple MMPCS can be performed, each yielding a PayOffMatrix that is appended to the same PayOffMatrixMaster.

Once PayOffMatrix is finalized, each Farner or the Speculator may want to sell their PayOffRows, with associated rights and responsibilities. The focus will now shift towards trading such PayOffRows.

Stepping back a bit, assume that MMPCS is done, and that the result is PayOffMatrix of FIG. 39.

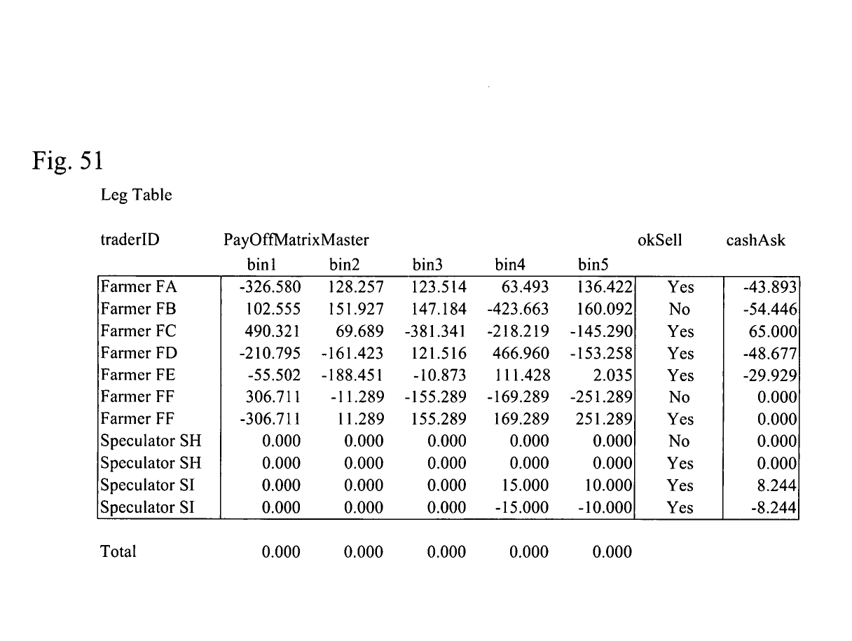

This PayOffMatrix, along with traderID, is appended to the Leg Table as shown in FIG. 51. In other words, traderID and PayOffMatrix of FIG. 39 are copied to the first five elements (rows) of the Leg Table as shown in FIG. 51. The okSell vector contains a Boolean value indicating whether the Trader wants to sell the PayOffRow. The cashAsk vector contains the amount of cash that the Trader wants for the PayOffRow. Its elements can be:

Positive—the value the Trader wants someone to pay for the PayOffRow.

Zero.

Negative—the value the Trader will pay someone to assume PayOffRow ownership, with its associated rights and obligations.

Both okSell and cashAsk are set by the corresponding Trader.

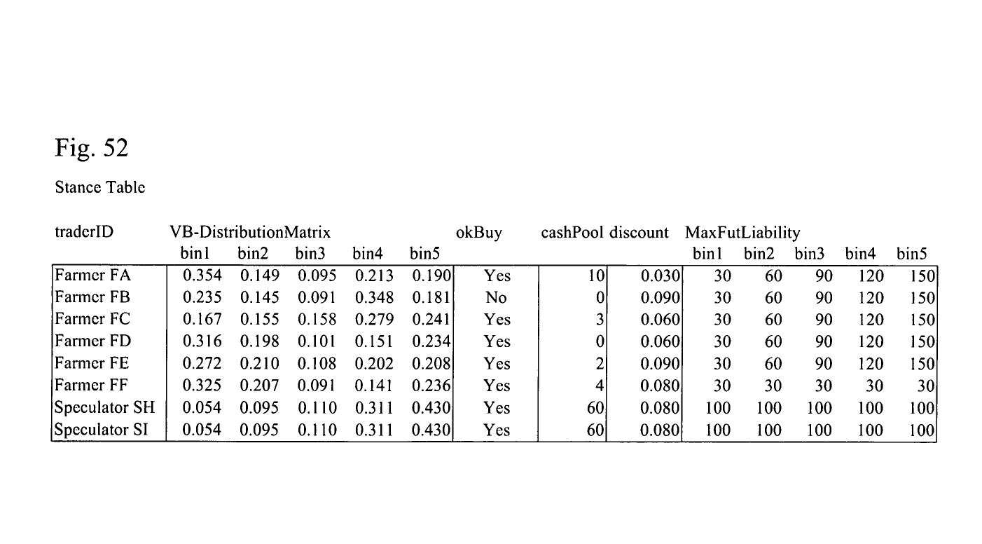

The Stance Table, shown in FIG. 52, contains information about each Trader. Each row of VB-DistributionMatrix contains a Trader's vb-Distribution (value-base distribution), which is the Trader's current estimated distribution and is generally the same as an up-to-date align-Distribution. (A Trader can keep an align-Distribution private, but needs to reveal a vb-Distribution for trading purposes.)

So, for example, suppose that a month has passed since the first five rows of PayOffMatrixMaster were appended. Given the passage of time, Farmer FA has revised her original estimates and now currently believes that the probability of bin] 's manifesting is 0.354. The okBuy vector of the Stance Table contains Boolean values indicating whether the Trader is willing to buy Leg Table rows. The cashPool vector contains the amount of cash the Trader is willing to spend to purchase Leg Table rows. Vector discount contains each Trader's future discount rate used to discount future contributions and withdrawals. Note that as a first order approximation, for a given row Leg Table row, cashAsk is:

cashAsk=(1−discount)×dot product of PayOffRow and vb-Distribution.

A Trader sets cashAsk based upon the above, but also upon perceived market conditions, need for immediate cash, and whether the PayOffRow has a value, for the Trader, that is different from its mathematically-expected discounted value.

Matrix MaxFutLiability contains limits to potential contributions that the Trader wishes to impose.

Leg Table rows are added by MMPCS as previously described. They can also be added by Traders, provided that the column values sum to zero. So, for example, Farmer FF could append two rows: His strategy is to retain the first row—in order to achieve the hedge of FIG. 43 and FIG. 44—and sell the second row for whatever positive value it might fetch. (Farmer FF could set cashAsk to a negative value, meaning that Farmer FF is willing to pay for someone to assume the PayOffRow.) As another example, Speculator SH appends two rows of zero pay-offs; these rows are essentially fillers. His strategy is to buy PayOffRows that have value per his vb-Distribution, future-value discount rate, and the potential seller's cashAsk. As another example, Speculator SI is similar to Speculator SH, except that she is also willing to sell PayOffRows for more than her mathematically-expected return.

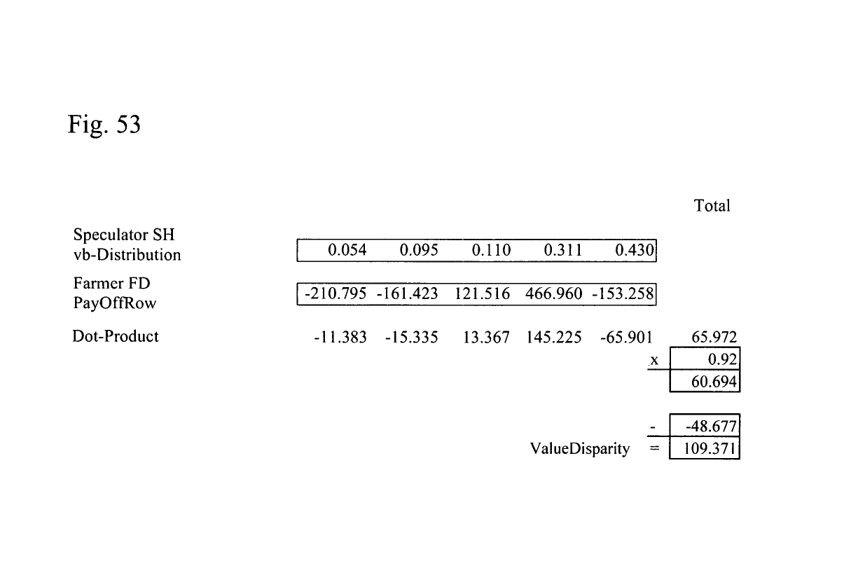

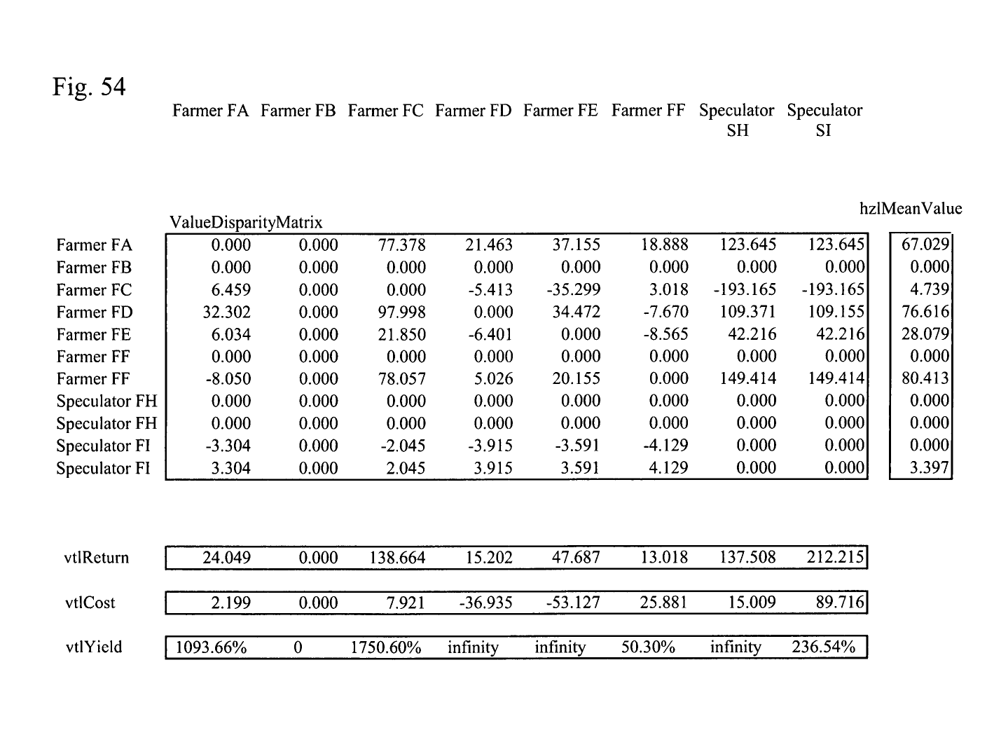

To execute trading, for each potential buyer/potential seller combination, a valueDisparity is calculated. This is the difference in the perceived value of the PayOffRow: the dot product of the potential buyer's vb-Distribution with the seller's PayOffRow, discounted by the buyer's discount, minus the seller's cashAsk. So, for example, the calculation for valuing Farmers FF's second PayOffRow for Speculator SH is shown in FIG. 53, yielding a valueDisparity of 109.371. FIG. 54, containing matrix ValueDisparityMatrix, shows the valueDisparity for each potential buyer/potential seller combination.

After the ValueDisparityMatrix has been determined, the largest positive value is identified and a trade possibly made. The largest value is used, since it represents maximal consumer- and producer-surplus value increase. So, for example, scanning ValueDisparityMatrix of FIG. 54 locates 149.414 as the largest cell value, corresponding to Farmer FF's selling his second PayOffRow to Speculator SH. The two split the difference, so Speculator SH needs to pay Farmer FF 74.707, plus Farmer FF's cashAsk, which is 0.0. Because Speculator SH has a cashPool limit of 60, only 60/74.707, or 80%, of the PayOffRow can be purchased. This constitutes a first constraint. With Farmer FF's full PayOffRow, Speculator SH would be assuming a potential contingent liability of 306.711 should bin1 manifest. This exceeds the 100 limit specified in MaxFutLiability. Hence, the second constraint is that only 100/306,711, or 33%, of the PayOffRow can be purchased. Since the second constraint is binding, Speculator SH pays Farmer FF:

(74.707+0)*100/306,711

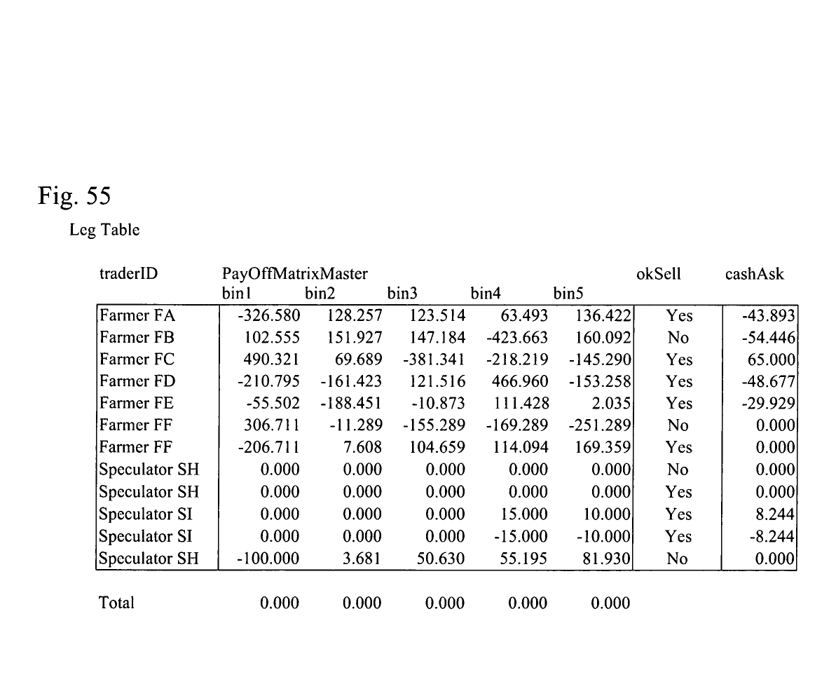

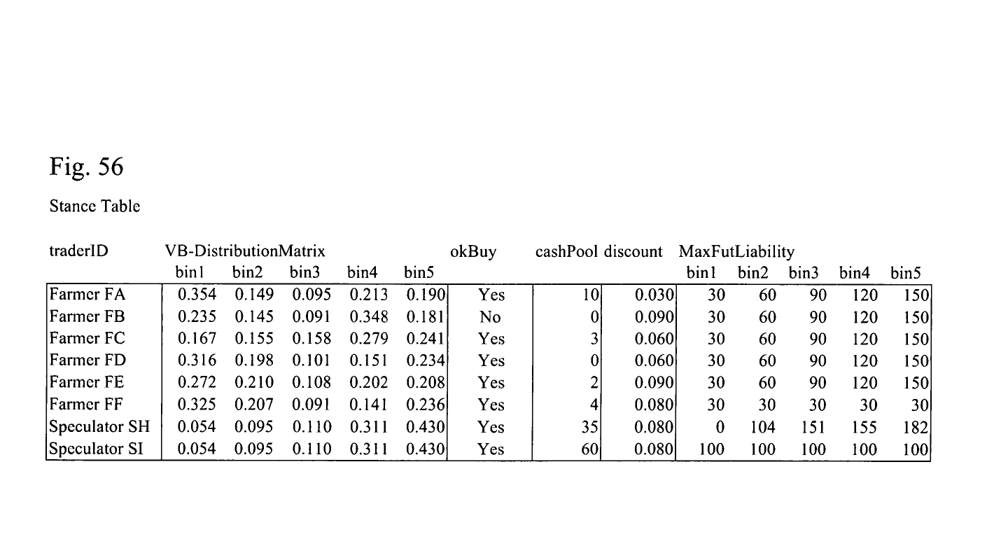

for a 100/306,711 fraction of PayOffRow. FIG. 55 shows an updated Leg Table resulting from Speculator SH's partial purchase of Farmer FF's second PayOffRow. The Stance Table is also appropriately updated, as shown in FIG. 56, so that trading can continue. There are a few of points to note. A trade is made only if it is in the interest of both parties. Even if Speculator SH is the only buyer of Farmer FF's PayOffRow and even if only 33% of the PayOffRow is purchased, Farmer FF is helped: he gets some hedging, plus a payment of cash. Conceivably, others might purchase the remaining 66% of Farmer FF's second PayOffRow. Since there are many positive values in ValueDisparityMatrix, many trades can be made. Notice that buying Speculator SI's second PayOffRow is in the interests of each farmer willing to buy PayOffRows.

Now supposing that Farmer FF has a choice between participating in risk sharing versus risk trading. What is the difference? Risk sharing offers the advantage of almost infinite flexibility in terms of what is specified for cQuant and ac-Distribution. It also offers the advantage of allowing strategically-smart ac-Distributions based upon geoMean-Distributions. It does not allow immediate cash transfers, which can be a disadvantage.

Risk trading entails cash transfer, but since buyers and sellers need to be paired, there is an inherent inflexibility on what can be traded. In general, the advantages and disadvantages for risk trading are the reverse of those for risk sharing. As a consequence, the Risk-Exchange offers both risk sharing and risk trading.

IV. Embodiment

IV.A. Bin Analysis Data Structures

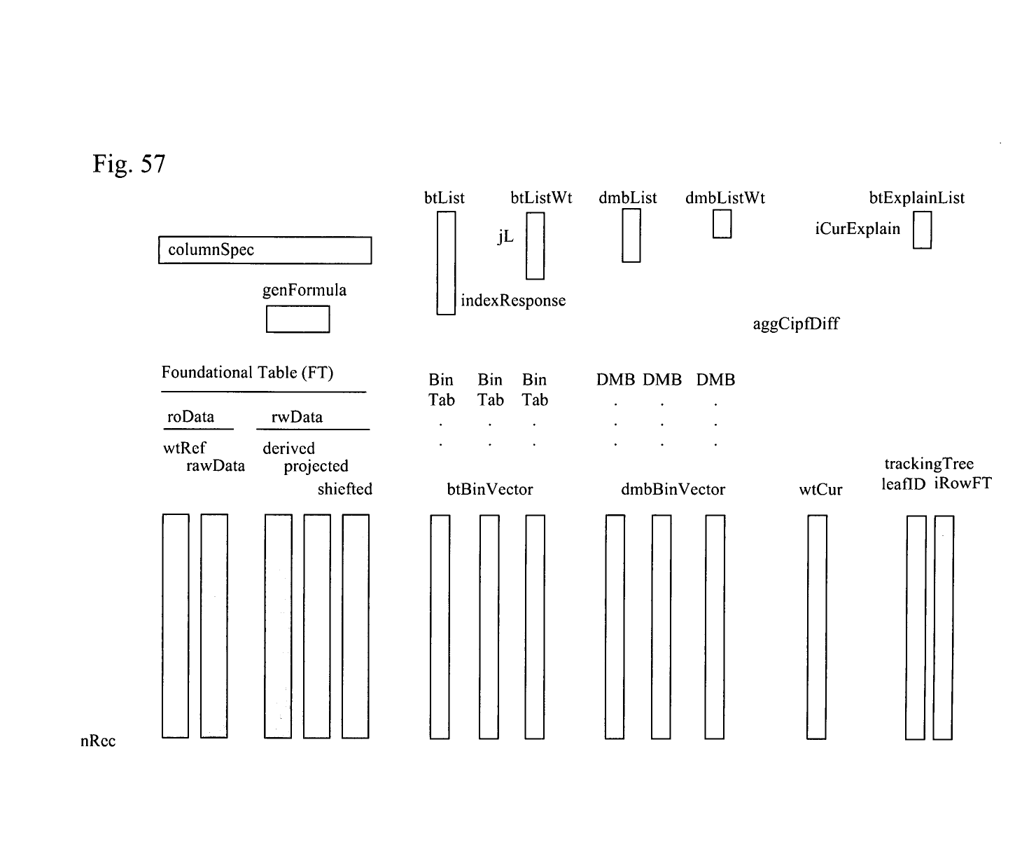

FIG. 57 shows the overall memory layout, exclusive of the Risk-Exchange.

The Foundational Table (FT) consists of nRec rows and a hierarchy of column-groups. At the highest level, there are two column-groups: roData (read only) and rwData (read-write). The roData column-group has column vector wtRef, which contains exogenously determined weights for each row of the Foundational Table. Column-group rawData contains multiple columns of any type of raw-inputted data. (In FIG. 57, open rectangles signify vectors, while solid rectangles signify matrixes.) The rwData column-group contains three column-groups. The derived column-group contains columns derived, as specified by the Analyst, from other columns. For example, a data-column in the derived column-group could contain the ratio between corresponding elements in two rawData columns. The projected column-group contains the results of projecting other column data relative to two Rails. Such a projection will be described later. Formulas and parameters for generating derived and projected column data are stored in genFormula which, as shown in FIG. 57, span over the derived and projected columns. The shifted column-group contains revised versions of the other columns that have been, what is termed here, shifted. Shifting is to edit or change column values for purposes of making data better match subjective judgements. Structure columnSpec contains information regarding each Foundational Table column to help create histograms and assist in general processing. Most importantly, however, is that it contains a mapping between shifted and non-shifted columns: Each shifted column corresponds to one or more non-shifted columns of the Foundational Table. Each non-shifted column may have an associated shifted column. (It is helpful to suppose that derived, projected, and shifted column data are directly based upon rawData and that the Foundational Table consists of a read-only roData column-group and a read-write rwData column-group. In an actual implementation of the present invention, however, such rigidities may be absent: As in a relational database system, read/write privileges would be assigned and some entities or people could create any type of column based upon any other type of column.) (For best performance, the rawData column-group can be stored either by column or by row, but the other Foundational Table data should be stored by column.)

BinTab objects define categorization bins for Foundational Table column data and have a btBinVector that contains nRec bin IDs: one for each row of the Foundational Table. Three BinTabs and associated btBinVectors are shown to the right of the Foundational Table in FIG. 57. Vector btList contains a current list of BinTab objects in use, while vector btListWt contains a current list of BinTab objects that are used for weighting. Each object in btListWt is in btList. Scaler jL is an index into btListWt. Rather than making nested references explicit, occasionally btListWt[i] will mean btList[btListWt[i]].

As discussed before, DMB objects have dmbBin Vectors of nRec elements. Three DMBs and associated dmbBin Vectors are shown to the right of the BinTabs in FIG. 57. Vector dmbList contains a current list of DMB objects, while vector dmbListWt contains a current list of DMB objects that are used for weighting. Each object in dmbListWt is in dmbList. Rather than making nested references explicit, occasionally dmbListWt [i] will mean dmbList[dmbListWt [i]].

Vector wtCur of nRec elements contains weights as calculated by the CIPFC. Each such weight applies to the corresponding Foundational Table row.

It is helpful to view the natural progression and relationships as can be seen in FIG. 57: The btBinVectors are derived from the Foundational Table. The dmbBin Vectors are derived from the btBinVectors. Vector wtCur is derived from the dmbBin Vectors and wtRef. (As a result, the LPFHC, to be described later, consists of vector wtRef along with the dmbBin Vectors.) Vector wtCur is used to weight Foundational Table rows and btBinVector elements.

For use by the Explanatory-Tracker, vector btExplainList contains a list of BinTabs, which are in effect containers of variates, that can be used to explain BinTab btList[indexResponse]. Index iCurExplain into btExplainList references the working-most-explanatory BinTab. Based upon data in btBinVectors, the Explanatory-Tracker develops a tree, the leaves of which are stored in trackingTree.leafID. Leaf references to Foundational Table rows are stored in trackingTree.iRowFT. Structure trackingTree is stored by row.

Scalar aggCipfDiff, used by the CIPFP, stores an aggregation of the differences between tarProp and curProp across all dimensions.

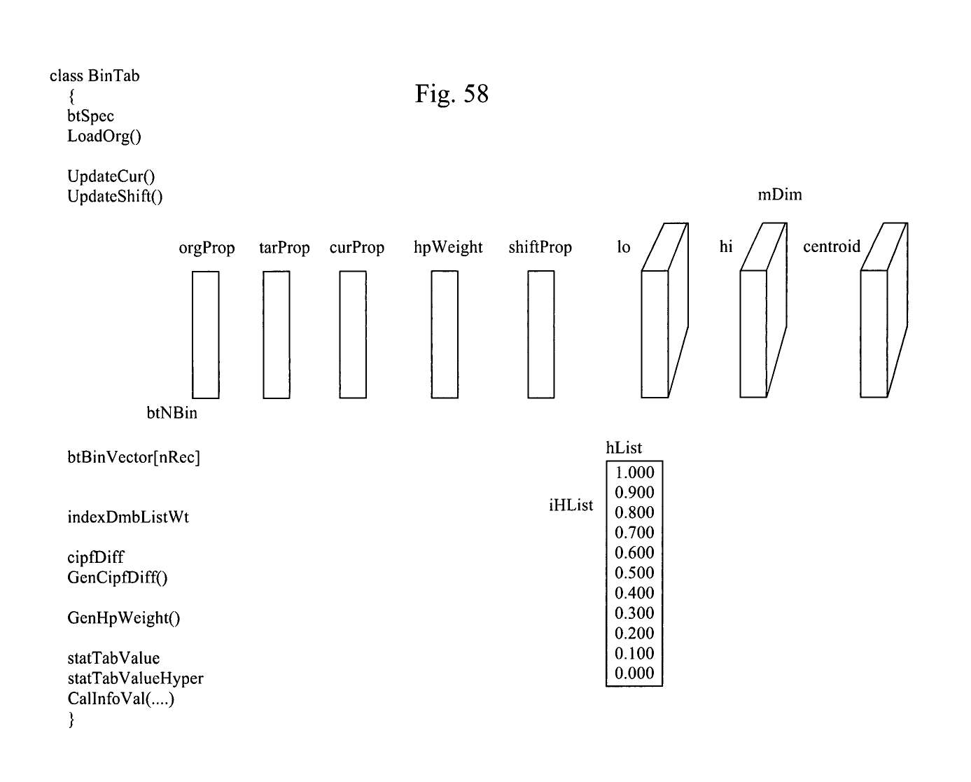

FIG. 58 shows the BinTab class:

Component btSpec contains both a list of Foundational Tables columns (source columns) used to define class-instance contents and specifications regarding how such column data should be classified into btNBin bins. In addition, btSpec may also contain references to a client BTManager and a client DMB. (Both BTManagers and DMBs use BinTab data.)

Function LoadOrg( ) uses wtRef to weigh and classify source column data into the btNBin bins; results are normalized and stored in vector orgProp.

Vectors tarProp, curProp, and hp Weight contain data for, and generated by, the CIPFP as previously discussed.

Function UpdateCur( ) uses wtCur to weigh and classify source column data into the btNBin bins; results are normalized and stored in vector curProp. (curProp is loaded by either the CIPFP or UpdateCur.)

Function UpdateShift( ) uses wtCur to weigh and classify the shifted versions of source column data into the btNBin bins; results are normalized and stored in vector shiftProp.

Matrixes lo, hi, and centroid all have btNBin rows and mDim columns. They define bin bounds and centroids.

Member btBinVector stores nRec bin IDs that correspond to each row of the Foundational Table. (Column vOBin in FIG. 11A contains a list of bin IDs that could be, for example, stored in btBinVector.)

Member indexDmbListWt is an index into dmbListWt. DMB dmbListWt[indexDmbListWt] used the current BinTab (as expressed in C++: *this) for creation.

Function GenCipfDiff, used by the CIPFC, calls a Distribution-BinComparer to compare distributions defined by vectors tarProp and curProp. Results of the comparison are stored in cipfDiff.

Function GenHp Weight, used by the CIPFC, generates hp Weight by blending existing hpWeights with Full-Force IPFP weights. It uses a vector hList, which is static to the class; in other words, common to all class instances. Vector hList contains at least two blending factors that range from 0.000 (exclusive) to 1.000(inclusive): 1.000 needs to be in the vector, which is sorted in decreasing order. Scalar iHList, which is particular to each class-instance, is an index into hList.

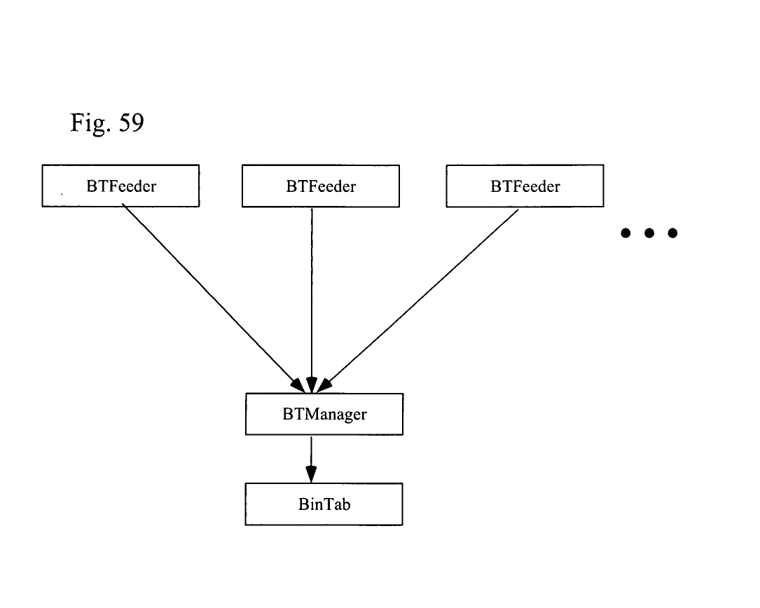

Function CalInfo Val calls DirectCTValuation and SimCTValuation. Results are stored in statTab Value. Member statTab ValueHyper is an aggregation of multiple statTab Values. If there is a single Forecaster, the Forecaster can directly work with BinTab objects as will be explained. However, when there are multiple Forecasters, rather than directly working with BinTabs, Forecasters work with BTFeeders as shown in FIGS. 59, 61, and 62. The BTManager coordinates the operations between BTFeeders and the underlying BinTab (See FIG. 59). For each BinTab, there is at most one BTManager; for each BTManager, there are one or more BTFeeders.

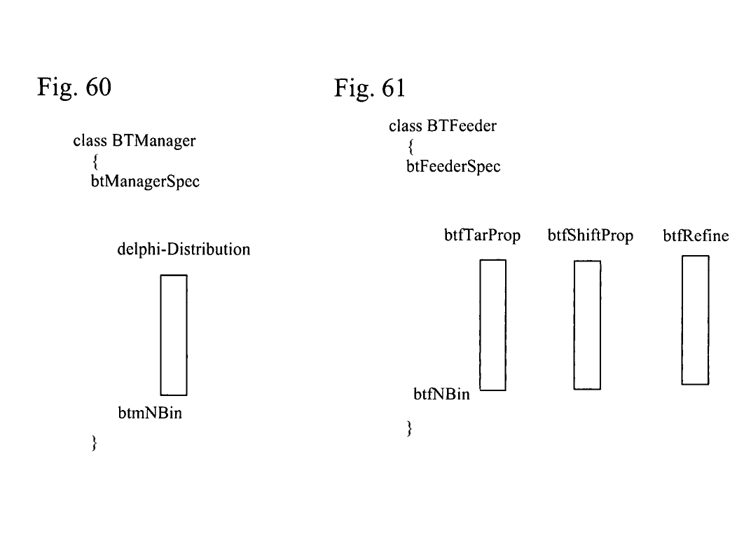

FIG. 60 shows the BTManager class:

Component btManagerSpec stores pointers and references to the associated BTFeeders, and an underlying BinTab.

Vector delphi-Distribution is a special benchmark-Distribution that has btmNBin bins. The number of bins (btmNBin) equals the number of bins (btNBin) in the underlying BinTab.

FIG. 61 shows the BTFeeder class:

Component btFeederSpec stores pointers and references to the associated BTManager and to other Forecaster owned objects, in particular, matrix forecasterShift.

Components btfTarProp and btfShiftprop are private versions of the tarProp and shiftProp vectors of the BinTab class. They have btfNBin elements and btfNBin equals btNBin of the underlying BinTab.

Component btfRefine is a copy of either btfTarProp or btfShiftProp.

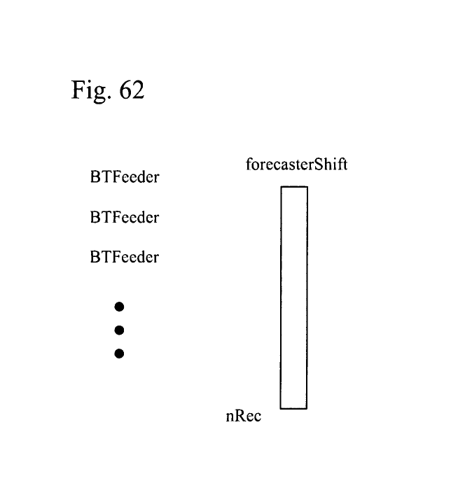

Each individual Forecaster owns/controls the objects shown in FIG. 62: multiple BTFeeders and a matrix forecasterShift. Each BTFeeder is owned by an individual Forecaster. Each Forecaster owns up to one BTFeeder per BTManager. Each Forecaster also owns a forecasterShift matrix, which is a private copy of the shifted column-group of the Foundational Table. Like the Foundational Table, forecasterShift has nRec rows.

When a Forecaster accesses a BTFeeder, a temporary virtual merger occurs: btfTarProp temporarily virtually replaces the tarProp in the underlying BinTab and forecasterShift temporarily virtually replaces the shifted-group columns in the Foundational Table. The Forecaster uses the merged result as if the underlying BinTab were accessed directly. When the Forecaster is finished, the BTManager updates the underlying BinTab and performs additional operations.

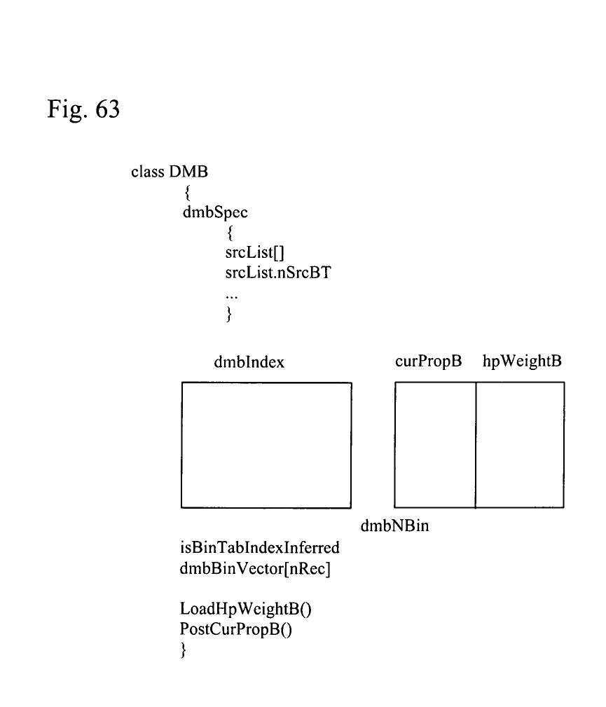

FIG. 63 shows the DMB (Dimensional Marginal Buffer) class. Component dmbSpec contains an object srcList, which is a list of pointers to the BinTabs used as the basis to define the DMB. These BinTabs can be referenced using the [ ] operator. For example, srcList[2] is the third BinTab used as the basis for the DMB. The number of basis BinTabs is srcList.nSrcBT. Matrix dmbindex contains one or more indexes into the source BinTabs' curProp and hpWeight vectors. The first column of dmbindex contains indexes into srcList[0]; the second column of dmbindex contains indexes into srcList[1]; etc. Boolean is BinTabIndexInferred indicates whether, as previously discussed, indexes are contained in dmbindex or are inferred. Vectors curPropB and hpWeightB are buffers between the BinTabs' curProp and hpWeight vectors and the LPFHC, consisting of one or more dmbBin Vectors together with vector wtRef. Vectors curPropB and hp WeightB have dmbNBin elements. Matrix dmbindex has either 0 or dmbNBin rows.

IV.B. Bin Analysis Steps

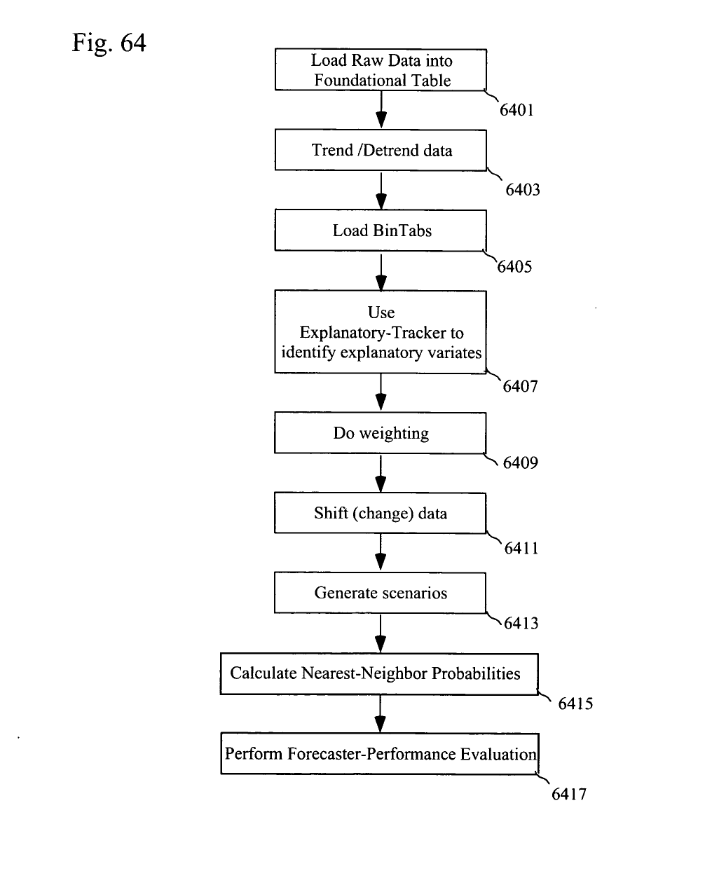

FIG. 64 shows a natural sequencing of the major steps of Bin Analysis. These steps can be performed in any order and any given Analyst/Forecaster might use only a subset of these steps. Any given implementation of the present invention may entail only a subset of the steps shown in FIG. 64. So, for example, one implementation might have Steps 6401, 6409, and 6413; while another implementation might have only Step 6417, with data being directly provided to Step 6417, thus bypassing Step 6401 and other data preparation steps.

Most of the descriptions in this Bin Analysis Steps section will detail internal processing. An Analyst/Forecaster is presumed to direct and oversee such internal processing by, for example, entering specifications and parameters in dialog boxes and viewing operation summary results. While directing the steps of FIG. 64, the Analyst/Forecast is likely to be continuously viewing histograms and other diagrams on GUI 705 in order to monitor progress and understand Foundational Table data.

To facilitate exposition and comprehension, initially a single Analyst/Forecaster will be presumed. This single Analyst/Forecaster will work directly with BinTabs (as opposed to BTFeeders). After all the steps of FIG. 64 have been presented in detail, the case of multiple simultaneous Forecasters will be addressed.

IV.B. 1. Load Raw Data into Foundational Table

Step 6401 entails loading exogenous raw data into wtRef and rawData of the Foundational Table. At the simplest level, this could be accomplished using SQL on a standard relational database system:

SELECT 1.0 AS wtRef,*

INTO rawData

FROM soureTableName;

A more advanced level would entail wtRef being generated by SQL's aggregation sum function and the asterisk shown above being replaced by several of SQL's aggregate functions. Any data type can be loaded into rawData; each field can have any legitimate data type value, including “NULL” or variants such as “Not Available” or “Refused.”

If weighting data is available, it is loaded into wtRef. Otherwise, wtRef is filled with 1.0s. Which ever the case, wtRef is copied to wtCur.

When time series data is loaded into roData, it should be sorted by date/time in ascending order. Alternatively, an index could be created/used to fetch roData records in ascending order.

Component roData can be stored in either row or column format. For best performance on most computer systems, wtRef should be stored separately from rawData. Performance might be enhanced by normalizing rawData into a relational database star schema, with a central table and several adjunct tables. However, such a complication will no longer be considered, since star schemas are well known in the art.

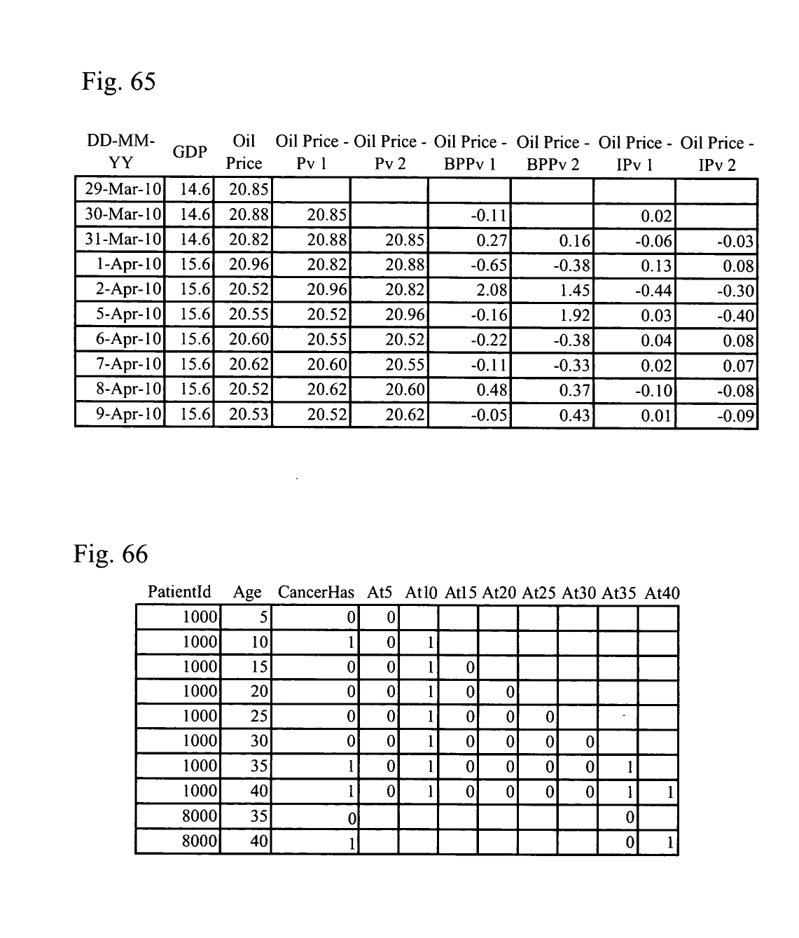

FIG. 65 shows an example of data that could be directly loaded into rawData. It has a date, values for the quarterly GDP (Gross Domestic Product), and oil prices. It also has lagged oil prices, lagged oil prices in terms of basis-point changes, lagged oil prices in terms of incremental change. Both changes from the previous day and from the previous two days are included. What is important to note here is the use of different lags and differently expressed lags. The decision concerning what lags to use and how to express them is analogous to the same decision when building a statistical regression model. As compared with statistical regression model, however, such a decision is not as ominous, since the present invention addresses many of the deficiencies of the statistical regression model.

FIG. 66 shows another example of data that could be directly loaded into rawData. What is important here is the allowance of repetitive tracking data for the same patient. This is allowed, because each row is considered by the present invention as an observation and because weighting can correct any age-distributions distortions. (The Age column contains the patient's age when the row observation was made. CancerHas is a Boolean, indicating whether the patient currently has cancer. At5 . . . At40 contain Booleans indicating whether the patient had cancer at various ages.)

Once roData is loaded, rwData.derived is generated by the Analyst specifying formulas to determine rwData.derived column values as a function of both roData column values and rwData.derived column values. Such formulas can be analogous to spreadsheet formulas for generating additional column data and can be analogous to SQL's update function. These formulas are stored in genFormula. (Whether generated data is created by the genFormula formulas or whether it is created as part of the process to load rawData is optional. The former gives the Analyst more control, while the latter may ultimately allow more flexibility.)

IV.B.2 Trend/Detrend Data

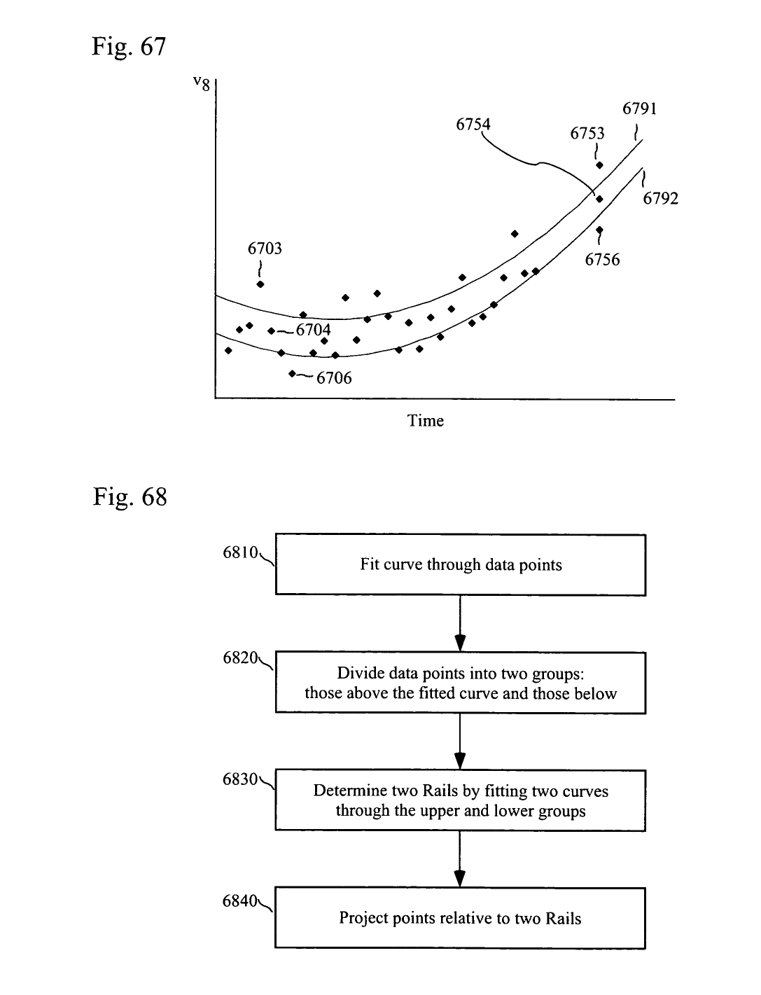

When a column of rawData contains time series data that has a trend, then such a trend needs to be identified and handled in a special manner. FIG. 67 shows a variate v₈, being introduced here for the first time, as a function of time. It spans time=0 through time=29, and has 30 rather the previous typical 16 observations. There is a an upward trend and if this variate was not detrended, then Explanatory-Tracker, CIPFC, and Data-Shifter would all handle v₈ as if it came from the same constant empirical distribution.

In order to preserve the nature of the data as much as possible, yet still detrend it, a two-Rail technique as shown in FIG. 68 is used:

1. In Box 6810, any type of curve fitting procedure is used to fit the data. Such a curve is a function of time, but can also be a function of other variates in rawData.

2. In Box 6820, the data points are divided into two groups: those above and those below the fitted curve.

3. In Box 6830, a curve is fitted through the upper points; another curve is fitted through the lower points. These two curves are termed Rails and are shown in FIG. 67 as Rails 6791 and 6792.

4. In Box 6840, points are projected into destination periods relative to the two Rails. To do this requires:

Determining the point's initial relative position to the two Rails.

Projecting the point into the destination period so that it retains its relative position to the two Rails.

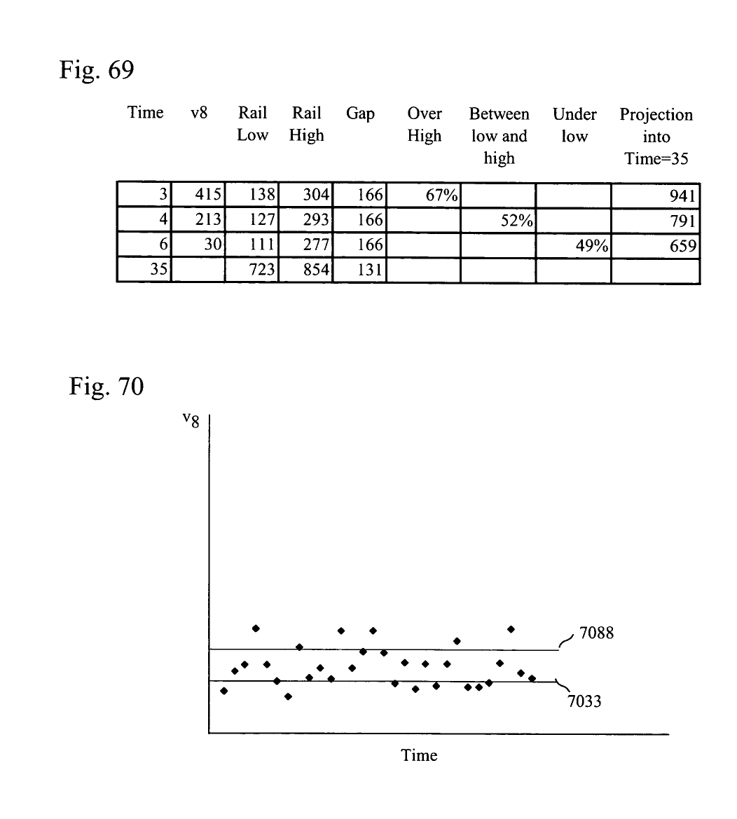

For example, Point 6703, which corresponds to time=3, is over the high Rail by two-thirds of the gap between both Rails at time=3. (See FIG. 67 and FIG. 69.) Accordingly, projecting this point into t=35 means that the point needs to be above the high Rail by two-thirds of the gap between both Rails at time=35. Hence, the projection of point 6703 into t=35 results in Point 6753.

As another example, Point 6704, which corresponds to time=4, is between the two Rails, up from the low Rail by 52%. Accordingly, projecting this point into t=35 means that the point needs to be between the two Rails, up from the low Rail by 52%. Hence the projection of Point 6704 into t=35 results in Point 6754.

As a final example, Point 6706, which corresponds to time=6, is below the low Rail by 49% of the gap between the two Rails at time=6. Accordingly, projecting this point into t=35 means that the point needs to be below the two Rails by 49% of the gap between the two Rails at time=6. Hence, the projection of Point 6706 into t=35 is Point 6756.

Using this technique (Rail-Projection), any point can be projected into any time, particularly future time periods. Now if scenarios are to be generated for periods 30, 31, and 32, then three columns need to be added to rwData.projected: say, v8Period30, v8Period31, and v8Period32. These columns are filled by projecting the v8 value of each rawData row into periods 30, 31, and 32, and then saving the result in the three added rwData.projected columns. Now when a given row in the Foundational Table row is selected to be part of a scenario for time=31, for instance, then the value of v8Period31 is used as the value for v₈.

The Analyst/Forecaster can trigger the creation of rwData.projected columns at any time. Curve fitting specifications are stored in genFormula for reference and possible re-use.

Besides projecting v₈ into future periods, v₈ itself can be detrended as shown in FIG. 70. The two Rails are set equal to the mean v₈ values of the upper and lower groups. Each point is projected (i.e., from FIG. 67) into its same period, except destination Rails 7088 and 7033 serve as guides. Such projected values are stored in an added column of rwData.projected, perhaps named v8Detrend. Besides detrending v₈, detrending v8Period30 could be desirable in order to use v8 in period 30 as explanatory of other variables in period 30.

There is a choice between using Rail-Projection versus using lags, such as columns “Oil Price—Pv 1” and “Oil Price—Pv 2” in FIG. 65. Rail-Projection has the advantage of flexibility, but has the cost of employing curve fitting. The choice can be arbitrated. This is done by initially generating upper and lower Rails for, in the present example, the price of oil as shown in FIG. 65. Next, assuming that FIG. 65 is loaded into rawData, a “oilPriceRailProjection” column is added to rwData.projected. For each iRow row of the rawData, a second row is randomly selected, the Oil Price in the second row is projected into the time-period of row iRow, and rwData.projected.oilPriceRailProjection[iRow] is set equal to the projected value. Once the oilPriceRailProjection column has been populated, The Explanatory-Tracker identifies those variates that are the best predictors of the Oil Price. In doing so, a choice between Rail-Projection(s) and lags is made.

There are two additional important aspects to Rail-Projections. First, besides being functions of time, Rails can be functions of additional variates. Second, besides correcting for trends, Rails can be used to impose necessary structures upon generated data. So, for example, suppose that FIG. 67 regards prices for a particular bond. The curve fitting used to generate the Rails could fit bond prices as a function of the Federal Funds Rate and the time to redemption, with the constraint that the bond's value at maturity equals its redemption value. When projecting a bond price, the source interest rate and time to redemption is noted and used to determine the values of the two source Rails; when projecting into, the destination interest rate and time to redemption is noted and used to determine the values of the two destination Rails. (For the projected point, the relationship between the source and destination Rails is maintained as described previously.)

IV.B.3. Load BinTabs

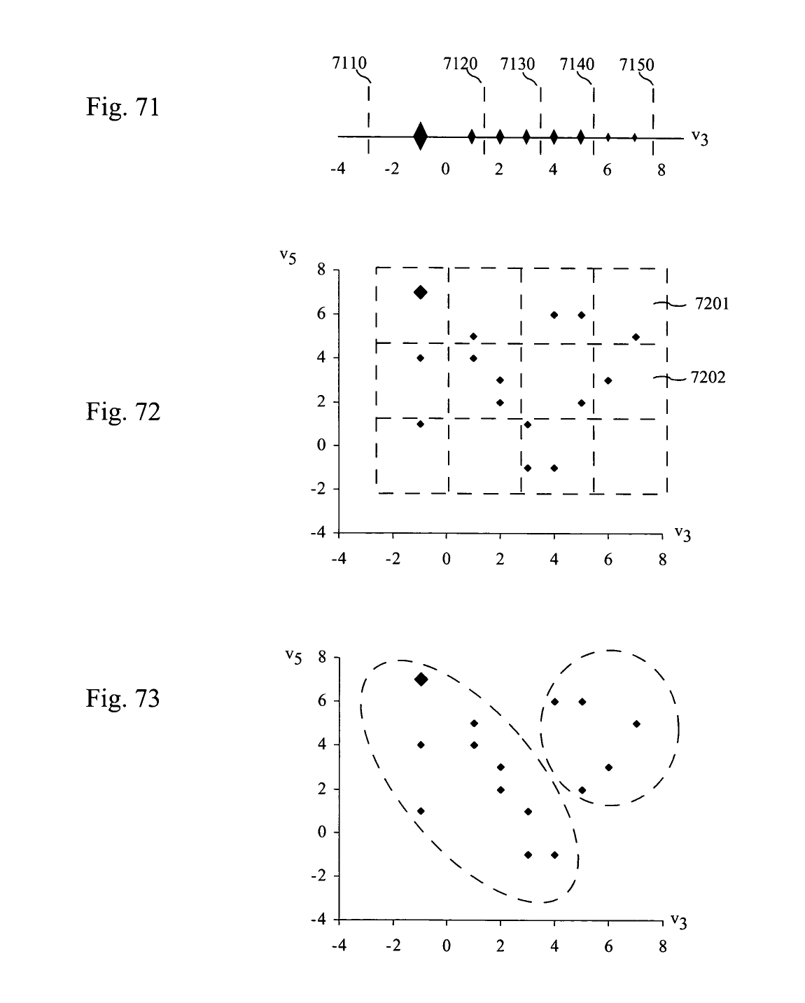

Returning to FIG. 64, once data detrending is complete, the next natural step is to create and load BinTab objects, each of which contains bin counts regarding one or more Foundational Table columns. Object btSpec contains the names of the Foundational Columns that are source data for the BinTab object. It also contains binning specifications, including binning type and binning parameters. FIGS. 71, 72, and 73 will be used as examples.

FIG. 71 shows a line segment with the values of v₃ (from FIG. 10) plotted. Binning v₃ entails setting bin boundaries and in turn the number of bins. This can be done by the system generating a graph like FIG. 71, and then by the Analyst placing bin boundaries where deemed appropriate. Alternatively, bin boundaries could be automatically placed at fixed proportional points along the high-low range of v₃. Once the bin boundaries have been determined, btNBin is set equal to the number of bin boundaries minus one, mDim is set equal to 1, and vectors lo[ ][0] and hi[ ][0] are loaded with the bin boundaries. So, for FIG. 71, the result is btNBin=4, lo[ ][0]=−3, 1.5, 3.5, 5.5, hi[ ][0]=1.5, 3.5, 5.5, 7.5, and mDim=]. Lastly, the v₃ column of the Foundational Table is scanned, each value of v₃ classified using lo[ ][0] and hi[ ][0], and the results stored in btBinVector. The content and sequence of column v3BinB in FIG. 11B, for example, is what could be stored in btBinVector.

FIG. 72 shows an xy-graph with the values of v₃ and v₅ (from FIG. 10) plotted. It also shows a grid of bin boundaries that are determined, analogous to what was previously described, by the Analyst or automatically. Loading this into a BinTab object is analogous to what was previously described, except that mDim=2, btNBin=12, first-bin v₃ boundaries are stored in lo[0][0] and hi[0][0], and second-bin v₅ boundaries are stored in lo[0][1] and hi[0][1], etc. The v₃ and v₅ columns of the Foundational Table are scanned and classified according the stored bin boundaries. Classification IDs, which range from 0 to 11, are stored in btBinVector. Note that the bin boundaries for individual categories do not need to be rigidly Cartesian so, for example, Bins 7201 and 7202 could be combined into a single bin.

Rather than using any rigid Cartesian bin boundaries, clusters could be identified and used. So, for example, FIG. 73 shows the v₃ v₅ data clustered into two clusters. Such clustering could be done visually by the Analyst, or it could be done automatically, for instance, by using the well known K-Mean procedure. Loading this into a BinTab object is analogous to what was previously described, except that mDim=2, btNBin=2. For the first cluster, the v₃ centroid is stored in centroid[0][0] and the v₅ centroid is stored in centroid[0] [1]; for the second cluster, the v₃ centroid is stored in centroid[1] [0] and the v₅ centroid is stored in centroid[1] [1]. Classification (cluster) IDs, which range from 0 to 1, are stored in btBinVector. A data point that is not part of the clustering procedure is classified into the bin with the nearest centroid. (Other clustering procedures could be used instead, but there are particularly desirable properties of the K-Mean procedure for the present invention.)

After btBinVector has been loaded, each element of btBinVector is weighted by the corresponding element in wtRef and frequencies for each bin are tabulated and stored in vector orgProp, which is normalized to sum to 1.0. This is done by the LoadOrg( ) member function.

There are several miscellaneous points about loading the BinTab objects:

1. Any number of Foundational columns can be used as input to a single BinTab object. As the number of columns increases, Cartesian bin boundaries will result in more and more sparseness. As a consequence, using clusters to create bins becomes more and more desirable.

2. Creating individual bins that are based upon increasingly more and more Foundational columns is a strategy for overcoming the Simpson Paradox.

3. The number of bins needs to be at least two and can be as high as nRec.

4. Multiple BinTab objects can be defined using the same Foundational columns.

5. Bins can be created for both roData columns and for rwData columns.

6. BinTab element btBinVector must have nRec elements that correspond to the Foundational Tables rows. Missing data can be classified into one or more “NULL”, “Not Available”, or “Refused” bins. When performing a cross-product of two or more variates or Bin Tabs, “NULL” combined with any other value should result in “NULL”, and similarly for other types of missing data.

7. As bins are created and loaded, btList is updated.

Member function UpdateCur( ) is analogous to LoadOrg( ): each element of btBinVector is weighted by the corresponding element in wtCur and frequencies for each bin are tabulated and stored in vector curProp, which is normalized to sum to 1.0. This function is called every time before data from curProp is displayed and contains smarts to know whether curProp should be updated on account of a change in wtCur.

IV.B.4. Use Explanatory-Tracker to Identify Explanatory Variates

IV.B.4.a Basic-Explanatory-Tracker

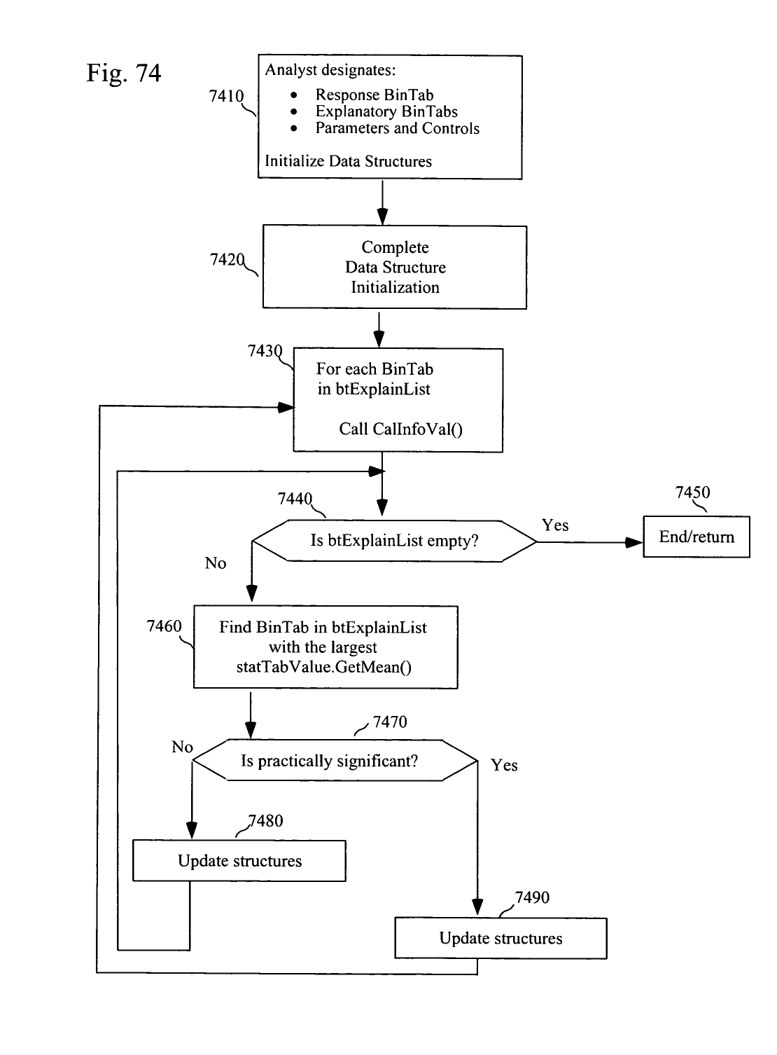

Returning to FIG. 64, once the BinTabs have been created and loaded, the next natural Step is to use the Basic-Explanatory-Tracker to identify explanatory variates/BinTabs. The steps of Explanatory-Tracker are shown in FIG. 74.

In Box 7410, the Analyst designates a Response BinTab. Scalar indexResponse is set so that btList[indexResponse] is the designated Response BinTab, which could be based upon a single or multiple variates. The Analyst also designates BinTabs for the Explanatory-Tracker to consider as possibly explanatory of the identified Response BinTab. Vector btExplainList is loaded with btList indexes of these designated, possibly explanatory, BinTabs. The Analyst also selects the type of valuation (DirectCTValuation or SimCTValuation), indicates how significance is to be judged, and indicates whether wtRef or wtCur should be used for weighting. And finally, the analyst designates a Distribution-BinComparer for use by Distribution-Comparer in comparing refined-Distributions against benchmark-Distributions.

In Box 7420, additional initializations are performed:

| for( | i=0; i < number of elements in btList; i++ ) |
|---|---|
| | btList[i].statTabValue.Init(); |
| for( | i=0; i < nRec; i++ ) |

{
leafID[i] = 0;
idRow [i] = i;
}

All statTabValues of all BinTabs are initialized so that irrespective of what is included in btExplainList, all BinTabs can be checked to gauge their predictive value. If a given BinTab is not included in btExplainList, by this initialization, its statTabValue will contain no entries. Note that statTab Value will contain a sampling used to estimate the value of the BinTab for predicting the Response BinTab.

In Box 7430, the CalInfoVal function of each BinTab in btExplainList is called. CalInfoVal, which will be explained shortly, loads BinTab data member statTabValue with the results generated by DirectCTValuation and SimCTValuation.

In Diamond 7440, a test is made whether btExplainList is empty. If btExplainList is empty, then Explanatory-Tracker is complete and processing moves to Box 7450.

If btExplainList is not empty, then in Box 7460, the BinTab in btExplainList with the largest statTabValue.GetMeano is identified. In other words, the BinTab yielding the highest expected predictive value is identified. Specifically:

iCurExplain = 0;

| for( | i=1; i<number of elements in btExplainList; i++ ) | |
|---|---|---|
| | if( | btList[btExplainList[i ]].statTabValue.GetMean( ) |

>
btList[btExplainList[iCurExplain]].statTabValue.GetMean( ))
iCurExplain = i;

In Diamond 7470, the results contained in btList[btExplainList[iCurExplain]].statTabValue are evaluated. This is done preferably by displaying a weighted histogram of the data contained in btList[btListExplain[iCurExplain]].statTabValue and then by having the Analyst subjectively decide whether the result is significant. Such a displayed histogram would show the distribution of the values of using BinTab btList[btListExplain[iCurExplain]] for predicting the Response BinTab. At a simple level, the Analyst might focus on the histogram's arithmetic mean; at a more advanced level, the Analyst might note and consider the shape of the histogram. And finally, at any level, the Analyst might focus on the magnitude: if the mean and distribution are immaterial, then the Analyst should reject the proposed BinTab on account of practical insignificance; if the mean and distribution are material, then the Analyst should accept the proposed BinTab on account of practical significance.

Note that after the first pass through Diamond 7470 and Box 7490, the distribution of the values of using BinTab btList[btExplainList[iCurExplain]] for predicting the Response BinTab is in light of the BinTabs previously identified (in Diamond 7470) as being significant.

Alternatively, a function member of statTab Value could be called to apply a standard statistical test. The data saved in statTabValue is typically not normally distributed. Hence, rather than using variance/standard error tests of significance, the relative count of positive values is suggested. This entails assuming the null hypothesis that the count of positive values is equal to the count of non-positive values, and then using the binomial distribution to determine statistical significance. Another alternative is to ignore statistical significance tests all together and consider a result significant if btList[btExplainList [iCurExplain]].statTab Value. GetMean( ) is simply positive.

If the test of Diamond 7470 concludes non-significance, then in Box 7480 btExplainList[iCurExplain] is removed from btExplainList. Prior to doing so, however, its statTab Value is re-initialized. Specifically:

btList[btExplainList(iCurExplain]].statTabValue.Init( );

And then processing continues with Diamond 7440.

If the test of Diamond 7470 concludes significance, then in Box 7490 a record of btExplainList[iCurExplain]'s being identified as significant is made for future reference. Afterwards, btExplainList[iCurExplain] is removed from btExplainList. Note that btExplainList[iCurExplain] retains its statTab Value for possible consideration by the Analyst. Then vectors leafID and iRowFT are updated as follows:

```
for (i=0; i<nRec; i++)
  {
  leafID[i] = leafID[i] *
    btList[btExplainList[iCurExplain]].btNBin;
  leafID[i] = leafID[i] +
    btList[btExplainList[iCurExplain]].btBinVector[i];
  }
sort trackingTree by leafID, iRowFT.
```

Processing continues with Box 7430.

Finally, in Box 7450, the recording of significant BinTabs in Box 7490 is reported to the Analyst. The Analyst may want to inspect each BinTab's statTabValue in order to obtain a better understanding of the relationships between the Response BinTab and the Explanatory BinTabs. The Forecaster may want to consider identified BinTabs when entering EFDs. Box 7450 terminates by passing control back to the Analyst/Forecaster, who continues with the Steps as shown in FIG. 64.

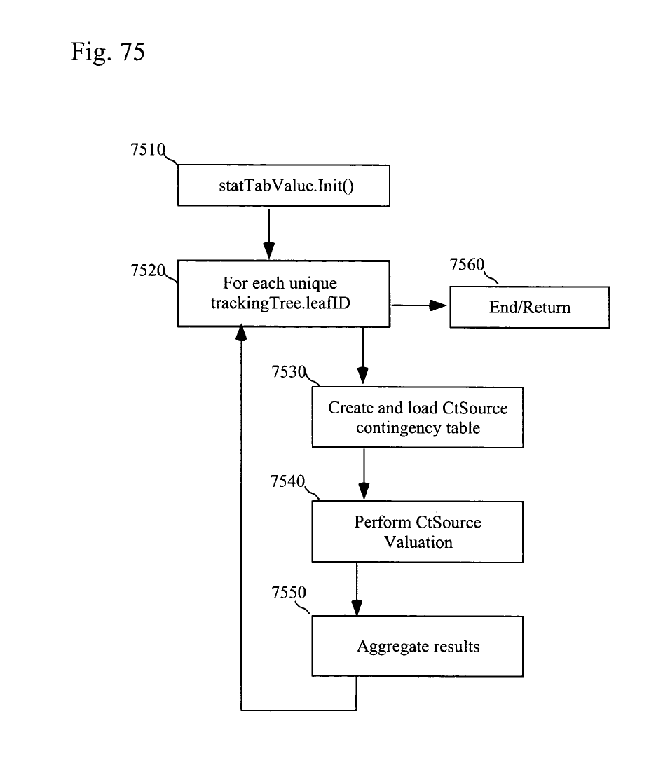

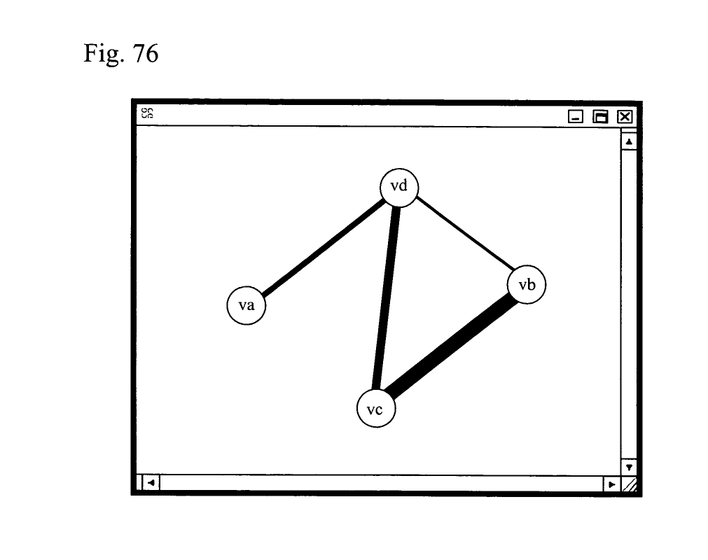

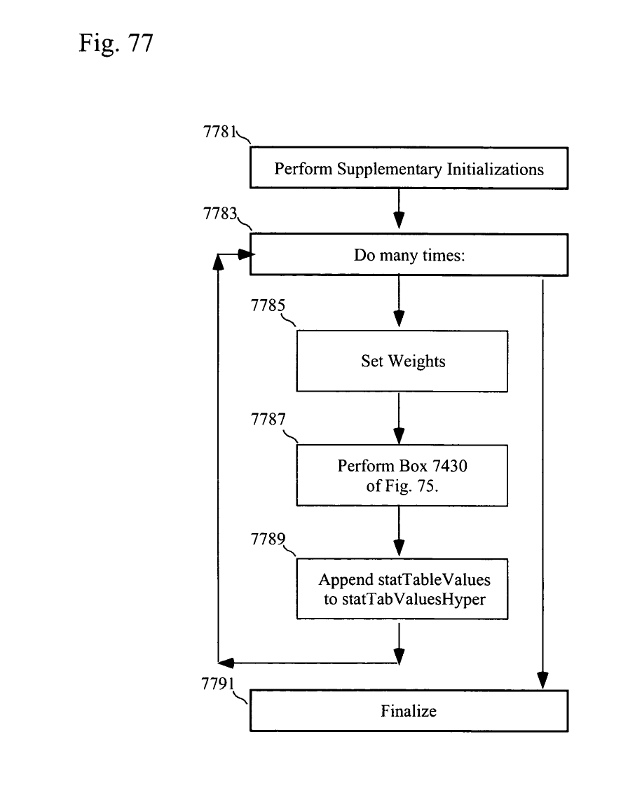

The CalInfoVal member function of BinTab, which is called in Box 7430, is shown in FIG. 75.

In Box 7510, member statTab Value is initialized.

In Box 7520, a do loop is started to iterate through each unique trackingTree.leafID.

In Box 7530, Contingency Table CtSource (of FIG. 27) is loaded. Since leafID is sorted, equal leafID values are adjacent to each other in trackingtree. Assume that indexBegin and indexEnd reference the start and end (plus 1) of the current leafID (as set in Box 7520) under consideration. Table CtSource is loaded as follows:

```
nBin = btList[indexResponse].btNBin;
nEx = btNBin (of *this instance of BinTab);
for(i=0;i<nEx; i++)
  for(j=0;j<nBin; j++)
    CtSource[i][j] = 0;
wtSum = 0;
for(k=indexBegin; k<indexEnd; k++)
  {
  kk = iRowFT[k]
  i = btBinVector[kk]; (of *this instance of BinTab);
  j = btList[indexResponse].btBinVector[kk];
  CtSource[i][j] = CtSource[i][j] + wtCur [kk];
  wtSum = wtSum + wtCur [kk];
  }
```

Note, in the above, weighting wtCur was assumed specified by the Analyst. Vector wtRef could have been specified by the Analyst and used above. As mentioned in the description of Box 7410, the Analysts chooses whether to use wtRef or wtCur. The weighting scheme needs to be judicially chosen since the weights affect the results.

In Box 7540, either DirectCTValuation or SimCTValuation are performed, depending upon what the Analyst chose in Box 7410. Note that the DBC used by the Distribution-Comparer is specified by the Analyst in Box 7410 also.

In Box 7550, each weight of the value-weight pair in ctStatTab is multiplied by wtSum as calculated in Box 7530. The value-weight pairs in ctStatTab are then appended to statTab Value.

Boxes 7530, 7540, and 7550 are applied to each unique leafID set.

Once the steps of FIG. 75 are complete, i.e., Box 7560 has been reached, the statTabValue objects in each BinTab contain simulated values of knowing the variates used to define the BinTab for forecasting btList[indexResponse]. The mean values contained in these statTabValue objects, along with the distributions of values, are analyzed per the discretion of the Analyst.

What is shown in FIGS. 74 and 75 is a general technique for identifying explanatory variates/BinTabs. Some Analysts will want an automatic identification of variates/BinTabs and so will have Diamond 7470 determine significance based upon statistical-significance or a similar criteria. Other Analysts will want to inspect results and control subsequent flow each time Diamond 7470 is reach.

IV.B.4.b Simple Correlations

Besides identifying serial explanatory variates/BinTabs, some Analysts will want to use what is shown in FIG. 74 as a method for determining correlations between variates/BinTabs. Processing proceeds as shown in FIG. 74, except that:

1. In Box 7410, one variate/BinTab is designated as the Response BinTab, the other variate/BinTab is designated as a possible explanatory BinTab (i.e., it is put into btExplainList[0]),

2. In Box 7410, a generic Distribution-BinComparer, such as DBC-FP, DBC-G2, or DBC-D2, is designated,

3. The process is terminated once Diamond 7440 is reached.

The correlation information is in btList[btExplainList[0]].statTabValue. (Note that a general symmetry makes immaterial which variate is designated response and which is designated explanatory.)

In addition, some Analysts will want to use what is shown in FIG. 74 as a technique for determining contingent correlations considering three variates/BinTabs. This is accomplished as follows: the variate/BinTab upon which the two other variates/BinTabs are presumably contingent upon is specified as the first possible explanatory variate/BinTab (i.e., it is put into btExplainList[0]). One of the other two is specified as the Response variate/BinTabs and the other of the two is specified as a second Explanatory variate/BinTab (i.e., it is put into btExplainList[1]). Processing proceeds as shown in FIG. 74, except that:

1. In Box 7460, btExplainList[0] is chosen as if it had the largest GetMean( ).

2. Significance is presumed in Diamond 7470 and processing goes from Box 7460 to Diamond 7470 to Box 7490.

3. Processing stops when Diamond 7440 is reached a second time.

The contingent correlation information is in btList[btExplainList[1]].statTab Value.

There are many techniques for creating and displaying graphs that show relationships between variables based upon their correlations and their contingent correlations. The above can be used to determine correlations and contingent correlations for such graphs. So, for example, given variates/BinTabs va, vb, vc, and vd, correlations between each of the six pairs can be calculated as discussed above. The larger correlations are noted and used to generate a graph like that shown in FIG. 76, which is directly shown to the Analyst. Note the widths of edges connecting two variates are proportional to their correlations as determined in the above.

IV.B.4.c Hyper-Explanatory-Tracker

The Basic-Explanatory-Tracker shown in FIG. 74 implicitly assumes that once a BinTab is identified as significant (in Diamond 7470), its bin proportions should remained fixed while the significance of other BinTabs is evaluated. But such fixed proportions mean that there is a structure, which means valuations that are biased upwards. In a similar way that SimCTValuation breaks the structure of DirectCTValuation, Hyper-Explanatory-Tracker breaks the structure of Basic-Explanatory-Tracker.

The strategy of Hyper-Explanatory-Tracker is to randomize the weights (wtRef or wtCur) so that bin proportions do not remain fixed. Hyper-Explanatory-Tracker builds upon the Basic-Explanatory-Tracker by including both pre- and post-processing for Box 7430. This pre- and post-processing is shown in FIG. 77.

In Box 7781, the following initialization is done:

```
for( i=0; i < nRec; i++ )
  wtCurHold[i] = wtCur [i]
for( i=0; i < number of elements in btList; i++ )
  btList[i].statTabValueHyper.Init( );
```

Vector wtCurHold, being introduced here, is a temporary copy of wtCur. If so designated by the Analyst in Box 7710, wtRefwould be used instead of wtCur.

In Box 7783, a loop controller to cycle through Boxes 7785, 7787, and 7789 is established. The loop count may be pre-set or set in Box 7410. More cycles through Boxes 7785, 7787, and 7789 means a desirably larger sample and more accuracy.

In Box 7785, vector wtCur is populated by randomly drawing, with replacement, from wtCurHold as follows:

```
for( i=0; i < nRec; i++ )
  wtCur [i] = 0
while( sum of wtCur [ ] is less than nRec )
  {
  Randomly select an element in
  wtCurHold, basing probability of
  selection upon each element's
  value.
  Set i equal to the index of the
  randomly selected element.
  wtCur [i] = wtCur [i] + 1;
  }
```

In Box 7787, the same processing as is done in Box 7430 is performed. Namely, the CalInfoVal function of each BinTab in btExplainList is called.

In Box 7789, the statTabValues generated by CalInfoVal are appended to statTabValueHyper, which serves as a temporary storage. Namely:

for( i=0; i < number of elements in btList; i++ )
btList[i].statTabValueHyper.Append(btList[i].statTabValue);

In Box 7791, after the completion of the loops of Box 7783, results are posted for subsequent use and wtCur (wtRej) restored:

```
for( i=0; i < number of elements in btList; i++ )
  btList[i].statTabValue = btList[i].statTabValueHyper;
for( i=0; i < nRec; i++ )
  wtCur[i] = wtCurHold[i]
```

Once Box 7791 is complete, the statTab Value objects in each BinTab contain simulated values of knowing the BinTabs for predicting btList[indexResponse].

Note that after Box 7791, Diamond 7440 of FIG. 74 is executed. Note also the Box 7781 follows Boxes 7420, 7480, and 7490 of FIG. 74. This Hyper-Explanatory-Tracker can be used as well to determine correlations as previously described.

IV.B.5. Do Weighting

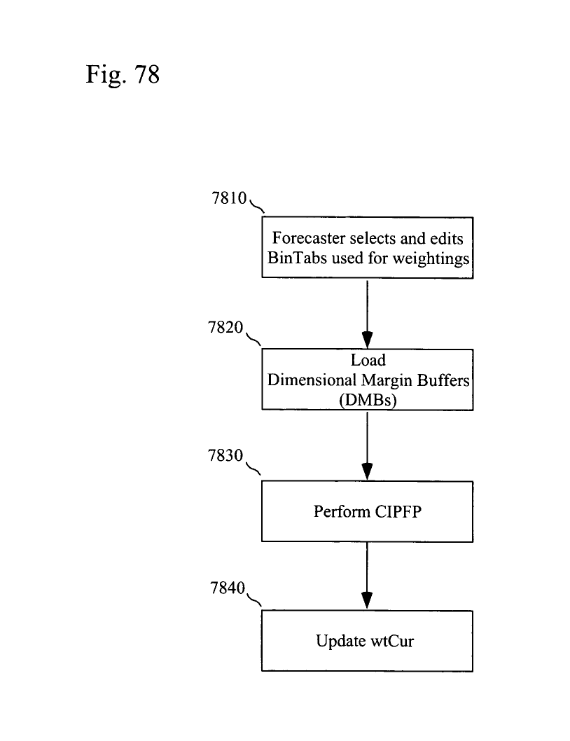

Returning to FIG. 64, once Explanatory-Tracker has been completed, weighting is a natural next step and is done as shown in FIG. 78. If the CPU is sufficiently fast, all steps shown in FIG. 78 would occur simultaneously from the perspective of the Forecaster.

In Box 7810, the Forecaster, perhaps noting the results of Explanatory-Tracker or perhaps using intuition, selects BinTab objects and indicates target proportions (tarProp) to define EFDs.

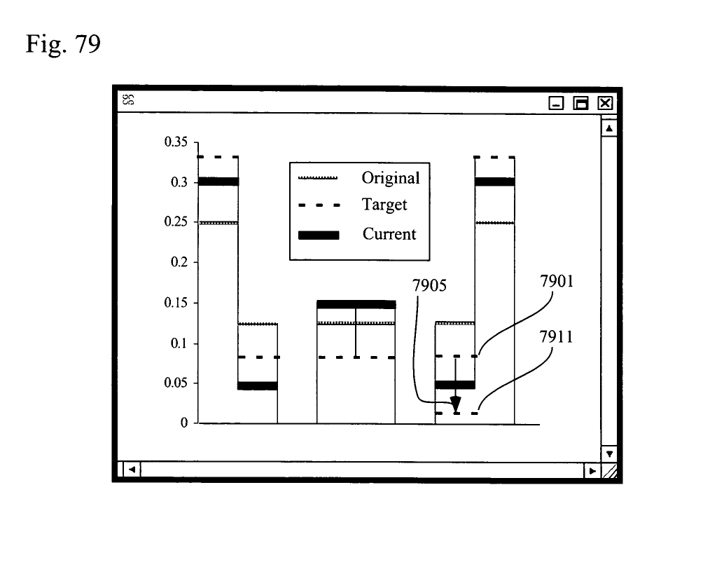

So, for example, the Forecaster could select the BinTab corresponding to v₁ and view the three overlapping histograms as shown in FIG. 79. (These histograms have been previously identified as Histograms 1210, 1810, and 1910.) Using the mouse, menus, and dialogue boxes, the Forecaster moves the tops the of Target Histogram Bins up and down so that the Target Histogram corresponds to the Forecaster's forecast, for, in this case, the value of v₁ in the upcoming period. For example, the Forecaster might move the second-from-the-right Target Histogram Bin's top from Position 7901 to Position 7911 as indicated by Arrow 7905. While the Forecaster is moving the tops of the Target Histogram Bins, BinTab column tarProp is being updated and normalized to sum to one and the window itself is being updated. The CIPFC may also be running and generating updated proportions for the Current Histogram, which in turn would be updated in the Window.

The Original Histogram corresponds to the orgProp vector of BinTab and has original proportions based upon wtRefweighting. The Current Histogram corresponds to the curProp vector of BinTab and has proportions based upon wtCur weighting. The Target Histogram corresponds to the tarProp vector of BinTab. The Forecaster can set the display of FIG. 79 as desired, for instance to hide/unhide the Original Histogram, hide/unhide axis labels, etc.

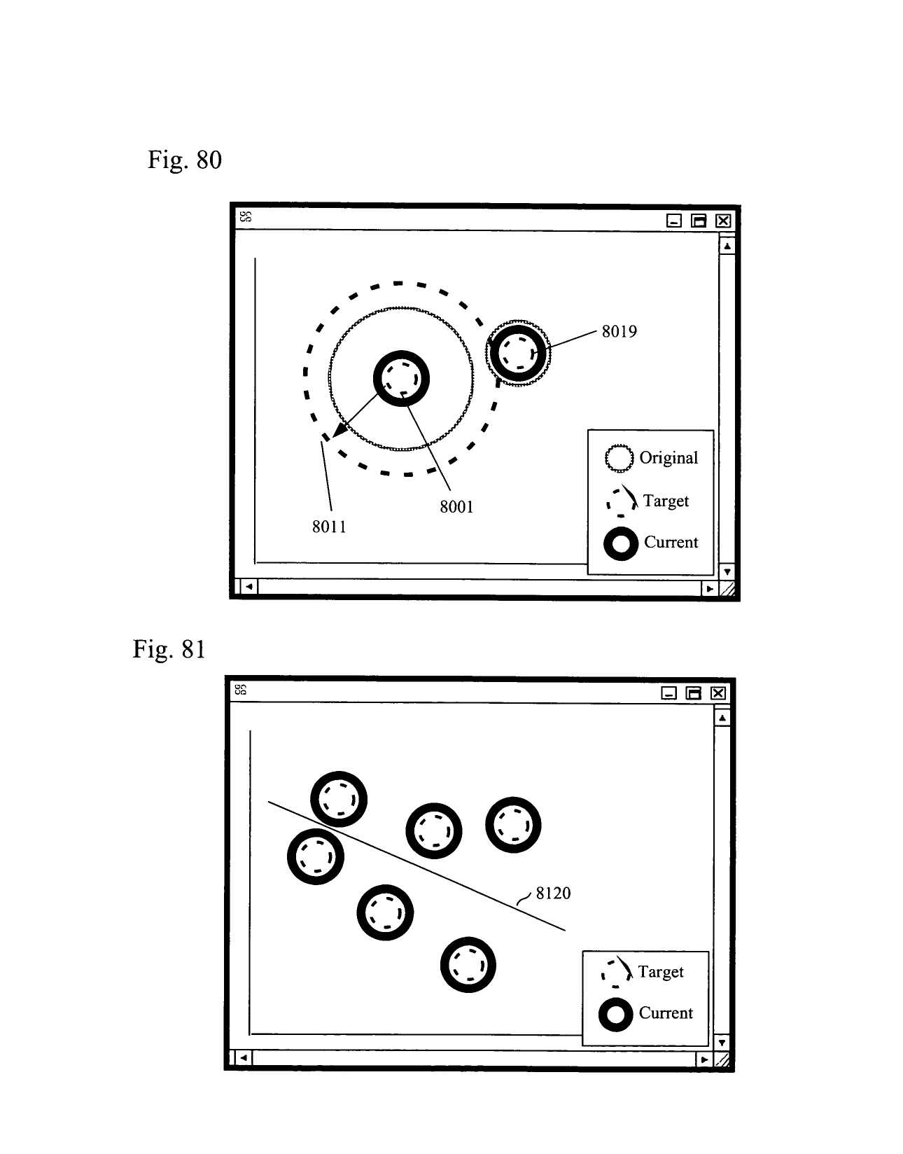

Two dimensional BinTabs, i.e., BinTabs where mDim=2, are displayed as bubble diagrams. (See FIG. 80.) (These bubbles correspond to the clustering, for example, of FIG. 73.) Using the mouse, menus, and dialogue boxes, the Forecaster moves the edges of the Target-Bubbles (8001 and 8019) so that the Target-Bubbles are proportional to the Forecaster's forecast for the upcoming period. So, for example, the Forecaster might move Target Bubble 8001's Edge to 8011. While the Forecaster is moving the Target-Bubbles Edges, BinTab column tarProp is being updated and normalized to sum to one. The CIPFC may also be running and generating updated proportions for the Current Bubbles.

To facilitate editing Target-Bubbles, the Forecaster is allowed to draw a line in the window and have the system automatically alter Target-Bubble proportions depending on how close or far the Target-Bubbles are from the drawn curve. So, for example, to increase the linear correlation between two variates/BinTabs, the:

1. Forecaster draws Line 8120 in FIG. 81

2. System determines the minimum distance between each Target-Bubble centroid and the curve

3. System divides each Target-Bubble proportion by the distance from the curve

4. System normalizes Target-Bubble proportions to sum to one.

Besides histograms and bubble diagrams, other types of diagrams/graphs can be presented to the Forecaster for specifying and editing target proportions. The principle is the same: the diagrams presented to the Forecaster have target proportions displayed and, as desired, original and current proportions. The Forecaster uses the mouse, menus, dialogue boxes, and freely drawn curves, to specify and edit target proportions. One possibility, for instance, is to display a 2×2 panel of bubble diagrams and allow the Forecaster to see and weight up to eight dimensions simultaneously.

As BinTabs are designated and undesignated for use in weighting, vector btListWt, which contains references into btList, is updated so that it has the current listing of BinTabs selected for weighting use.

In Box 7820, DMBs (Dimension Marginal Buffers) are created and loaded. Those BinTabs in btListWt that are not yet in a DMB form the basis of one or more DMBs. (The maximum number of BinTabs that should be the basis for a DMB is not known at this time. It is most likely contingent upon the particular data and size of the Foundational Table and can only be determined based upon actual empirical experience. The minimum number is one.) For illustrative purposes, btList[10], btList[11], and btList[12] will be used as the basis for a DMB. The DMB's dmbSpec (see FIG. 63) is loaded with references to the source BinTabs. A decision is made whether dmbindex should contain index references (as shown in FIG. 30) or whether the indexes should be inferred/implied. Specifically:

dmbSpec.Init( );

dmbSpec.srcList.Append(10);

dmbSpec.srcList.Append(11);

dmbSpec.srcList.Append(12);

dmbSpec.srcList.nSrcBT=3;

nCellSpace=1;

for (i=0; i<dmbSpec.srcList.nSrcBT; i++

nCellSpace=nCellSpace*dmbSpec.srcList[i].btNBin;

create temporary vector is used with

the number of elements equal to nCellSpace,

all elements initialized as zero;

```
for( k=0; k < nRec; k++ )
  {
  iPos = 0;
  for( j=0; j < dmbSpec.srcList.nSrcBT; j++ )
  iPos = iPos * dmbSpec.srcList[j].btNBin +
  dmbSpec.srcList[j].btBinVector[k]
  isUsed[iPos] = 1;
  }
ct = 0;
for( i=0; i < nRec; i++ )
  ct = ct + isUsed[i];
if( ct/nCellSpace is sufficiently small )
  {
  // i.e., use dmbIndex
  dmbSpec.isBinTabIndexInferred = FALSE;
  dmbNBin = ct;
  size dmbIndex to have dmbNBin rows and
  dmbSpec.srcList.nSrcBT columns
  iPos = 0;
  for( q=0; q < nCellSpace; q++ )
  if( isUsed[q] == 1 )
  {
  isUsed[q] = iPos;
  dec = nCellSpace;
  cumw = q;
  for( qq=0; qq < dmbSpec.srcList.nSrcBT; qq++ )
  { // integer arithmetic:
  dec = dec / dmbSpec.srcList[qq].btNBin;
  dmbIndex[iPos][qq] = cumw/dec;
  cumw = cumw % dec;
  }
  iPos = iPos + 1;
  }
  for( k=0; k < nRec; k++ )
  {
  iPos = 0;
  for( j=0; j < dmbSpec.srcList.nSrcBT; j++ )
  iPos = iPos * dmbSpec.srcList[j].btNBin +
  dmbSpec.srcList[j].btBinVector[k];
  iPos = isUsed[iPos];
  dmbBinVector[k] = iPos;
  }
  }
else
  {
  // i.e., as inferred
  dmbSpec.isBinTabIndexInferred = TRUE;
  dmbNBin = nCellSpace;
  size dmbIndex to have 0 rows and columns
  for( k=0; k < nRec; k++ )
  {
  iPos = 0;
  for( j=0; j < dmbSpec.srcList.nSrcBT; j++ )
  iPos = iPos * dmbSpec.srcList[j].btNBin +
  dmbSpec.srcList[j].btBinVector[k];
  dmbBinVector[k] = iPos;
  }
  }
for(i=0; i < dmbSpec.srcList.nSrcBT, i++)
  {
  dmbSpec.srcList[i].tarProp = dmbSpec.srcList[i].curProp
  Spread 1.0s in dmbSpec.srcList[i].hpWeight
  }
Spread 1.0/dmdNBins in curPropB
Spread 1.0s in hpWeightB
```

btList[10].indexDmbListWt=index into dmbList where current instance(*this) is/will be placed.

btList[11].indexDmbListWt=index into dmbList where current instance (*this) is/will be placed.

btList[12].indexDmbListwt=index into dmbList where current instance (*this) is/will be placed.

As the Forecaster unselects BinTabs for use in weighting, DMBs are rendered unnecessary. However, because they can be reused, they are retained in dmbList. Vector dmbListWt is maintained to reflect the DMBs currently active for use in weighting.

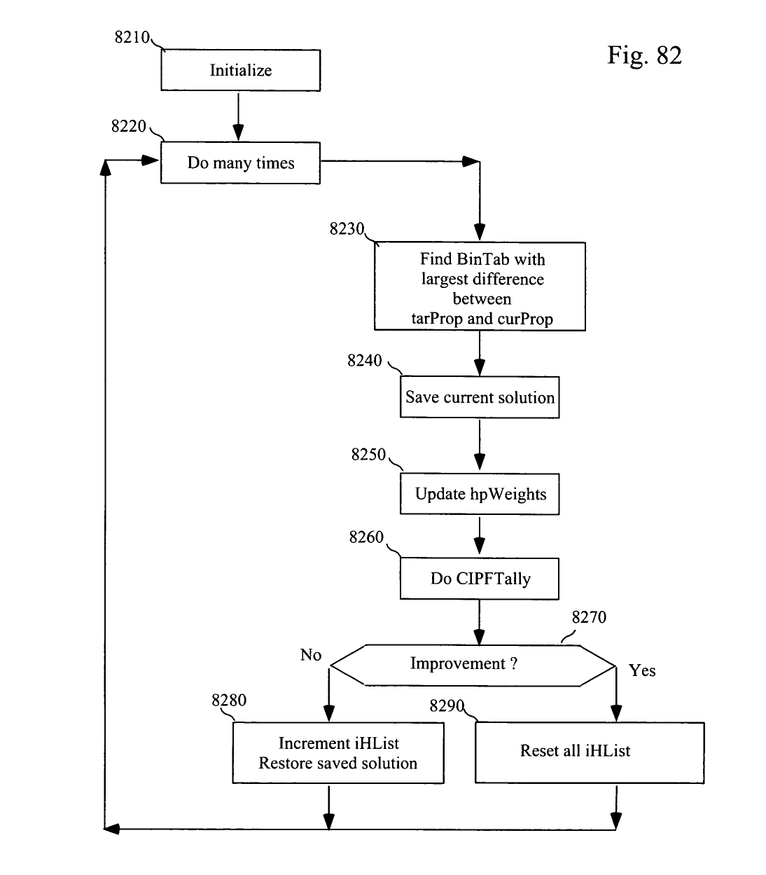

Box 7830 constitutes performing the CIPFP procedure, which is shown in FIG. 82. The number of times the main loop is executed is set in Box 8220. Generally, the more times the loop is executed, the better the solution. If convergence is obtained, then the routine is exited in Box 8230. (This discussion of FIG. 82 assumes that dmbindex contains the relevant indexes and that is BinTabIndexInferred has a value of false. The case for inference directly follows from what is discussed here.)

Box 8210 entails the following initialization:

jL = 0;
Call CIPF_Tally //define below
for(i=0; i<number of elements in btList; i++)
btList[i].iHList = 0;

Box 8220 entails two nested loops:

```
for( iHListMaster = 0;
  iHListMaster < number of elements in hList;
  iHListMaster++)
{
    for( a fixed number of times)
      {
      Apply Boxes 8230 to 8290
```

Box 8230 entails locating the BinTab in btListWt with the largest cipfDiff*hList[iList] that exceeds a tolerance, i.e.:

```
jL = 0; // index of BinTab with largest cipfDiff * hList[iList]
for(i=1; i <number of elements in btListWt; i++)
  if( btListWt[i ].cipfDiff * hList(btListWt[i ].iList] >
    btListWt[jL].cipfDiff * hList[btListWt[jL].iList] )
      jL = i ;
if( btListWt[jL].cipfDiff * hList[btListWt[jL].iList])
    > tolerance)
  continue with Box 8240
else
  exit routine
```

Box 8240 entails saving the current solution:

save copy of aggCipfDiff
save copy of vector btListWt[jL].hpWeight
for(i=0; i <number of elements in btListWt; i++)
save copy of vector btListWt[i].curProp;

Box 8250 entails calling btListWt[jL].GenHpWeight( ), which in turn is defined as:

```
for(i=0; i<btNBin; i++)
  {
  wtAsIs  = hpWeight[i];
  wtFullForce = hpWeight[i] * (tarProp[i]/curProp[i]);
  hpWeight[i] =  hList[iHList] * wtFullForce +
      (1 − hList[iHList]) * wtAsIs
  }
```

(Notice how the previous hpWeight, wtAsIs, is being blended with the current Full-Force weight to create an updated hp Weight.)

In Box 8260, CIPF_Tally is called. This function is defined below.

In Diamond 8270, a test is made whether aggCipfDiff is smaller than it was when saved in Box 8240. In other words, whether aggCipfDiff improved.

In Box 8280, if aggCipfDiff is not smaller, then btListWt[jL].iHList is incremented by 1. What was saved in Box 8240 is restored; in other words, what was done in Boxes 8250 and 8260 is reversed.

In Box 8290, if aggCipfDiff is smaller, then all iHist are set equal to iHListMaster. Specifically:

for(i=0; i<number of elements in btListWt; i++)
btListWt[i].iHList = iHListMaster;

Based upon the hpWeights, CIPF_Tally tallies curProp and triggers computation of cipfDiff and aggCipfDiff. Specifically:

```
for(i=0;i<number of elements in dmbListWt; i++)
  Spread zeros in vector dmbListWt[i].curPropB;
dmbListWt[btListWt[jL].indexDmbListWt].LoadHpWeightB( );
for(k=0; k<nRec; k++)
  {
  wt = wtRef[k];
  for(i=0;i<number of elements in dmbListWt; i++)
    {
    iBin = dmbListWt[i].dmbBinVector[k];
    wt = wt * dmbListWt[i].hpWeightB[iBin];
    }
  for(i=0;i<number of elements in dmbListWt; i++)
    {
    iBin = dmbListWt[i].dmbBinVector[k];
    dmbListWt[i].curPropB[iBin] =
      dmbListWt[i].curPropB[iBin] + wt;
    }
  }
for(i=0;i<number of elements in dmbListWt; i++)
  dmbListWt[i].PostCurPropB( );
aggCipfDiff = 0;
for(i=0;i<number of elements in btListWt; i++)
  {
btListWt[i].GenCipfDiff( );
aggCipfDiff = aggCipfDiff + btListWt[i].cipfDiff;
}
```

DMB function member LoadHpWeightB is defined as:

```
for(i=0; i< dmbNBin; i++)
  {
  wt = 1;
  for(j=0; j<dmbSpec.srcList.nSrcBT; j++)
    wt = wt * dmbSpec.srcList[j].hpWeight[dmbIndex[i] [j]];
  hpWeightB[i] = wt;
  }
```

DMB function member PostCurPropB is defined as:

```
for(j=0; j<dmbSpec.srcList.nSrcBT; j++)
  Spread zeros in vector dmbSpec.srcList[j].curProp;
for(i=0; i< dmbNBin; i++)
  {
  for(j=0; j<dmbSpec.srcList.nSrcBT; j++)
    dmbSpec.srcList[j].curProp[dmbIndex[i] [j]] =
    dmbSpec.srcList[j].curProp[dmbIndex[i] [j]] +
      curPropB[i];
  }
```

BinTab function member GenCipfDiff is defined as:

Normalize curProp to sum to one.

cipfDiff=Distribution-Comparer(tarProp, curProp);

cipfDiff=absolute value (cipfDiff);

As a rule of thumb, it is best to use either the DBC-G2 or the DBC-FP as the Distribution-BinComparer for GenCipfDiff. Conceivably, one could use other DBCs, but they may require customization for each dimension of each DMB in dmbListWt.

Returning to FIG. 78, Box 7840 entails:

```
for(k=0; i<nRec; k++)
{
wt = wtRef[k];
for(i=0;i<number of elements in dmbListWt; i++)
  {
  iBin = dmbListWt[i].dmbBinVector[k];
  wt = wt * dmbListWt[i].hpWeightB[iBin];
  }
  wtCur [k] = wt;
}
```

IV.B.6. Shift/Change Data

Returning to FIG. 64, Box 6411, the purpose of Data-Shifter is to refine forecasts beyond what can be accomplished with weighting alone.

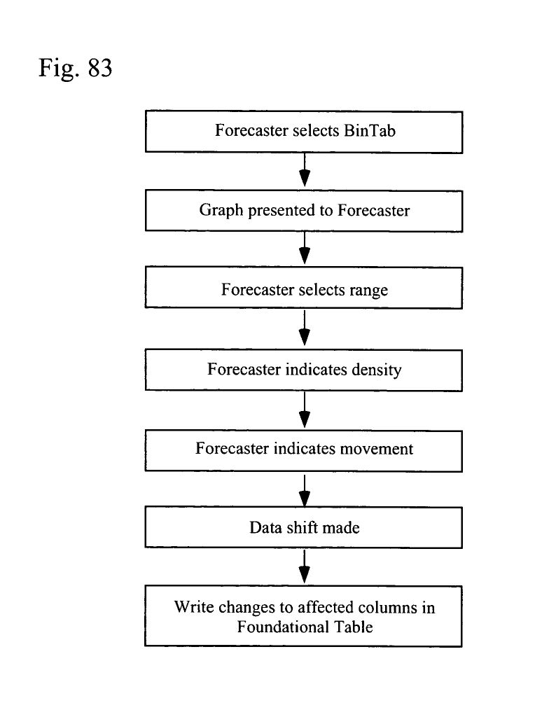

The steps are shown in FIG. 83. Initially, a Forecaster selects a BinTab. If it has not been previously done, Foundational Table columns used as the basis for the selected BinTab are duplicated and place in the shifted-group of the Foundational Table. The selected BinTab is then duplicated, except for btBinVector. The btBinVector of the duplicated BinTab is then loaded as previously described, except that it is based upon shifted-group column data. Note that this duplicate BinTab is temporary and lasts only for the life of the steps shown in FIG. 83.

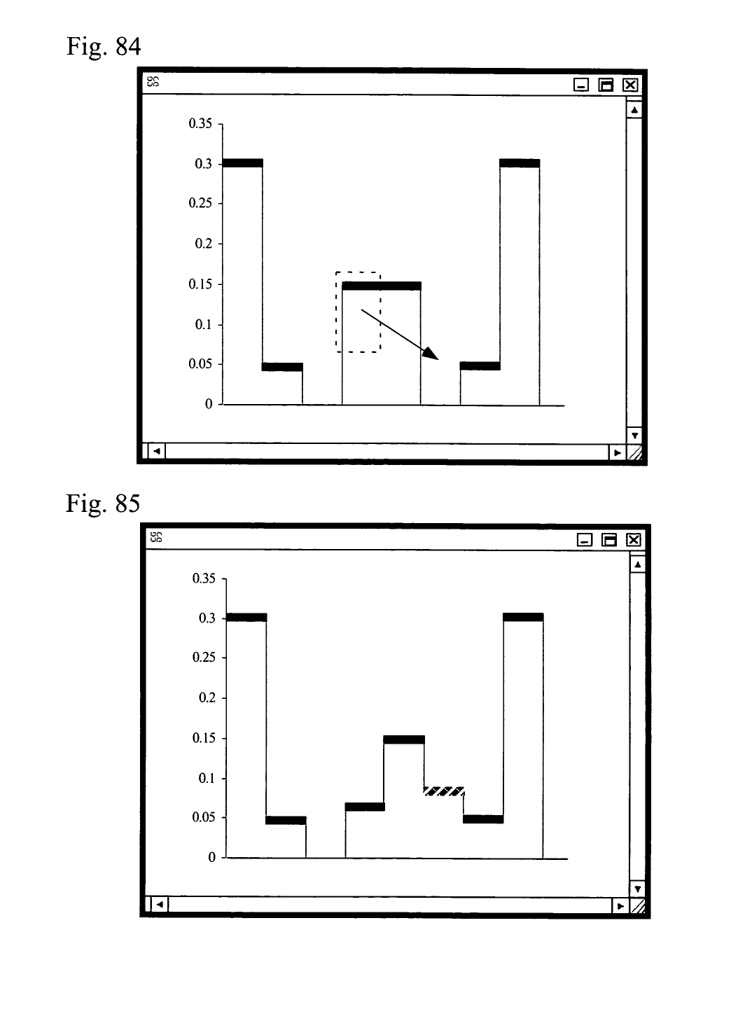

Given the duplicate BinTab, a graph like FIG. 84 or 87 is presented to the Forecaster, who directly edits the graph as if it were a collection of individual datum points. The Forecaster selects a range of the displayed data by using a mouse, menu items, and/or dialogue box(es). In FIG. 84, the rectangle with dashed edges is an example of a selected range; in FIG. 87, the circle with dashed edges is another example of a selected range. After the range has been selected, the Forecaster can indicate a density, which is the percentage of points in the selected range that are subjected to shift. And then, the Forecaster indicates a, as is termed here, shift.

Internally, with the range specified, identified points (in certain rows of Foundational Table) in the shifted-group can be accessed. Based on the indicated density, a random proportion of these points are accessed and their values changed based upon the shift indicated by the Forecaster.

The resulting distribution of the data is termed here as a Shift EFD. For example, the dashed rectangle in FIG. 84 is a range selected by the Forecaster, who chose a 100% density. The arrow in the figure shows the shift. FIG. 85 shows the result (Shift EFD) after the shift-column in Foundational Table has been updated and curProp updated.

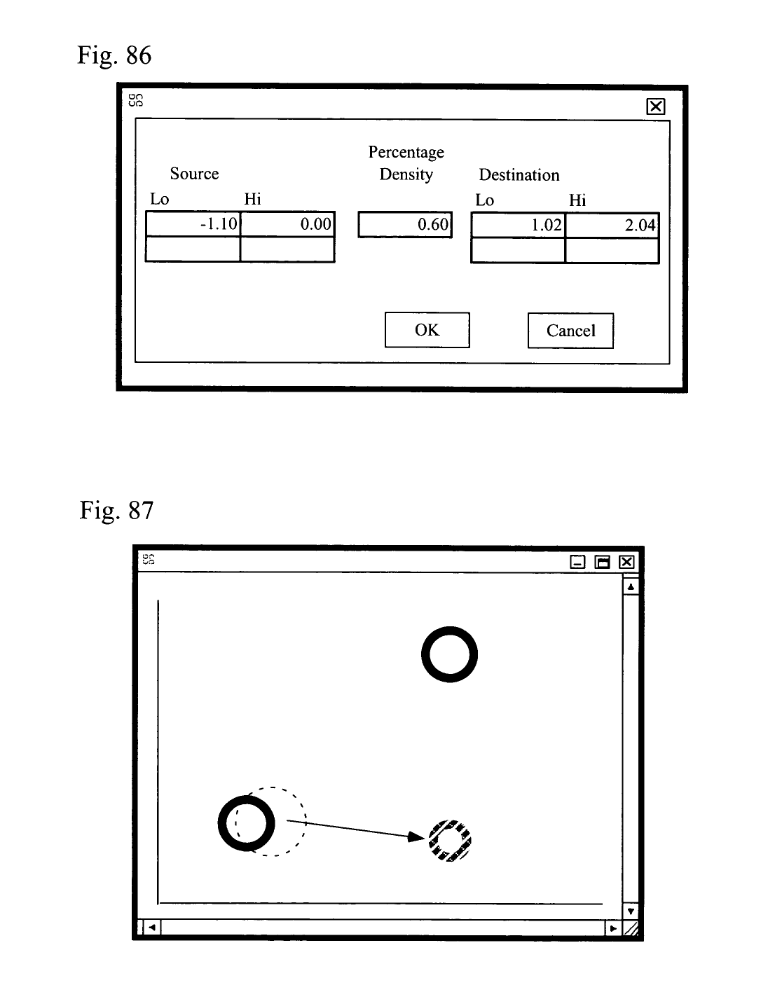

FIG. 86 shows a dialogue box that defines a range, density, and shift. Note that only one row of source/destination is used, since only one underlying variate is used to define the BinTab. If two variates were used to define the BinTab, then there would be two rows. If three varies, then three rows, etc.

The specified shift can be interpreted literally or figuratively. The shift indicated in FIG. 84 could mean that the horizontal distance of the arrow is added to the points of the range (literal interpretation). The shift could also mean that twice the bin width should be added to the range points (figurative interpretation). FIG. 86 could require that Source.hi minus Source.lo equal Destination. In minus Destination.lo so that a literal interpretation can be made. Alternatively, a linear mapping could be used so that value −1.10 is mapped to value 1.02 and value 0.00 is mapped to 2.04. Whether a shift is interpreted literally or figuratively is ideally indicated by the Forecaster, though it could be hardwired in an implementation of the present invention.

Displayed data is weighted by wtCur.

The graph can be considered as a set of data-point objects and the Forecaster's actions as being the selection and shift of some of these data-point objects. How to display objects, accept object selections, accept object shifts (as is termed here), and update an underlying structure is well known in the art and consequently will not be discussed here.

After shifted-group column data has been re-written to the Foundational Table, member function UpdateShift of the original, non-temporary, BinTab is called. This function reads the shifted-group column data, weights it by wtCur, classifies it into bins using lo, hi, and/or centroid, and tabulates frequencies that are stored in vector shiftprop. Once frequencies have been tabulated, vector shiftProp is normalized to sum to 1.0.

A special extension to that has been presented here is in order: A column might be added to rwData.shift and initially randomly populated. Several multi-variate BinTabs are created using this randomly populated column and other, termed for the moment as fixed, columns of Foundational Table. Data shifting is done as described above, such that only the randomly populated column is shifted and the fixed columns of Foundational Table remain unchanged. This is ideal for constructing hypothetical data: suppose a new type of security: A column is added to rwData.shift and randomly populated. This column is then shifted to subjectively align with fixed column data, such as the prices of similar securities. (Note that any means can be used to generate the initial random data, since Data Shifting corrects for most, if not all, distortions.)

IV.B.7. Generate Scenarios

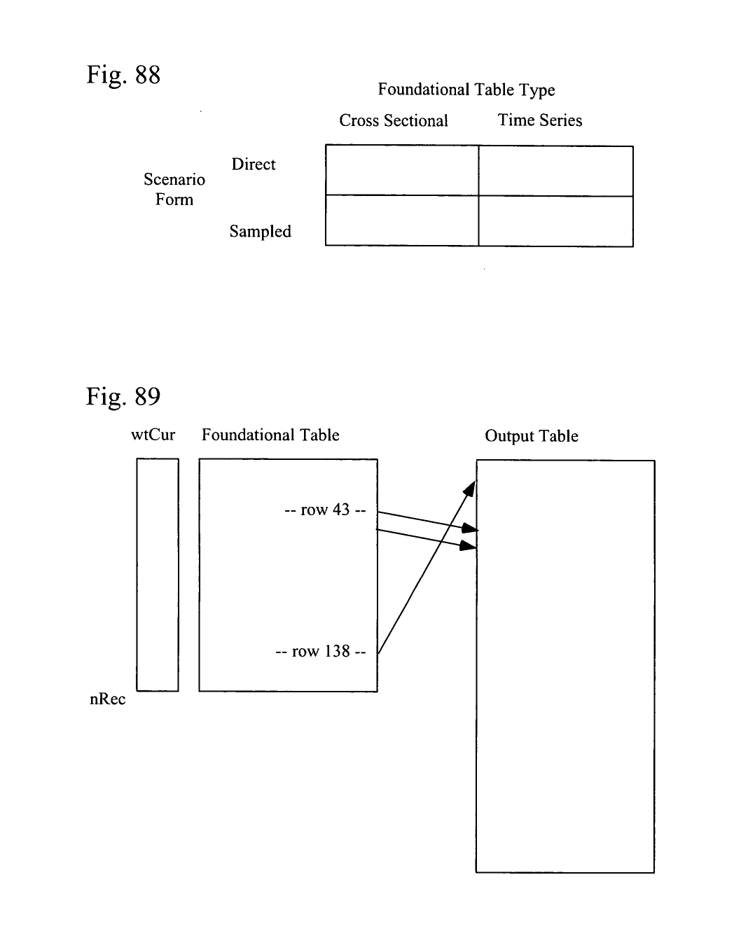

Returning to FIG. 64, Box 6413, Scenario-Generator directly or indirectly uses the Foundational Table along with vector wtCur. As shown in FIG. 88, there are two forms of scenario generation and two types of Foundational Tables.

The Sampled Form entails randomly fetching rows from the Foundational Table based upon the weights (probabilities) contained the wtCur and then passing such fetched rows onto an entity that will use the fetched rows as scenarios. Such sampling is implicitly done with replacement. So, for example, based upon the weights in wtCur, a row 138 is initially randomly drawn from the Foundational Table. It is appended to an Output Table as the first row, as shown in FIG. 89. Next, based upon the weights in wtCur, a row 43 is randomly drawn from the Foundational Table. It is appended to an Output Table as the second row, as shown in FIG. 89.

The Direct Form of scenario generation entails directly using the Foundational Table and the weights or probabilities contained the wtCur. So, for example, a simulation model might sequentially access each Foundational Table row, make calculations based upon the accessed row, and then weight the row results by wtCur.

The choice between these two forms depends upon the capability of the entity that will use the scenarios: if the entity can work with specified weights or probabilities, then the Direct Form is preferable since sampling introduces noise. If the entity cannot work directly with wtCur weights, then random fetching as previously described is used to create a set of equally-probable scenarios.

Handling the Cross Sectional Foundational Table type is implicitly done in the immediately preceding paragraphs.

For Time-Series Foundational Tables, row sequencing is considered and each row represents a time period in a sequence of time periods. Selection is done by randomly selecting a row based upon the weights or probabilities contained the wtCur. Once a row has been selected, the row is deemed to be the first-period of a scenario. Assuming that the Foundational Table is sorted by time, the row immediately following the first-period row is deemed the second-period of a scenario, the next row is deemed the third-period of a scenario, etc. The set is termed a multi-period scenario. So, for example, coupling sampled and time series generations of scenarios, might result in a row 138 being initially randomly drawn from the Foundational Table. It is appended to the Output Table as the first row. Rows 139, 140, and 141 of the Foundational Table are also appended, thus completing a scenario set of four time periods. Next, a row 43 is randomly drawn from the Foundational Table. Foundational Table rows 43, 44, 45, 46 are appended to the Output Table as the second scenario set, etc.

If the Scenario Form is Direct, as opposed to Sampled, then what is described in the immediately preceding paragraph is simplified, an Output Table is not written, and Foundational Table rows are directly accessed: the first-period row is randomly drawn from Foundational Table based upon wtCur; the second-, third-, etc. period sequentially follow and are accessed until a complete multi-period scenario has been assembled. Then the process repeats for the next multi-period scenario, etc.

Whether the form is direct or sampled and whether the Foundational Table Type is cross-sectional or time series, generated scenario data may need to be Grounded. Grounding is initializing generated scenario data into suitable units based upon current initializing conditions. A Foundational Table column may contain units in terms of change; but in order to be used, such change units may need to be applied to a current initializing value or level. So, for example, suppose that a Foundational Table column contains the percentage change in the Dow Jones Industrial Average (DJIA) over the previous day and that today the DJIA stands at 15,545.34. When generating the scenarios, the percentage change is applied to the 15,545.34 to obtain a level for the DJIA.

When generating a scenario, Rail-Trended data overrides Non-Rail-Trended data and Shifted data overrides both Non-Shifted and Rail-Trended data. This follows, since both Rail-Trended data and Shifted data are refinements to what would otherwise be used. Conceivably, an Analyst could individually designate Foundational Table columns to be included in the generated scenarios.

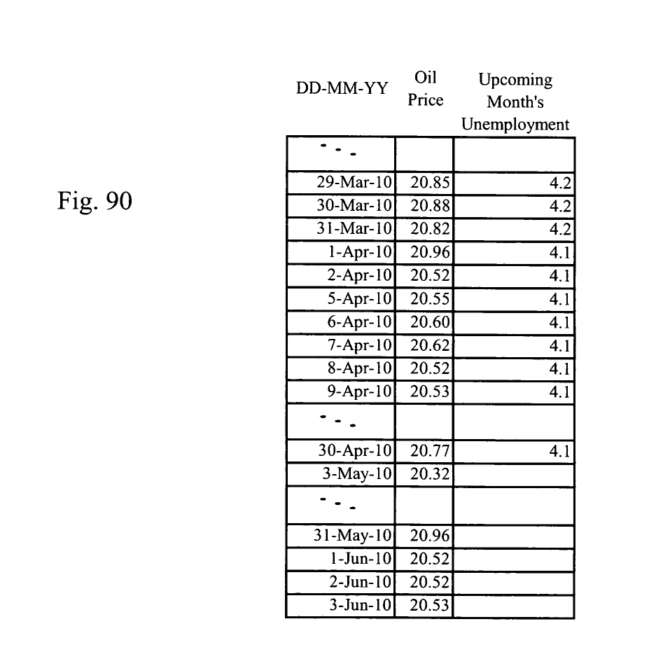

When generating multi-period scenarios, weighting implicitly applies only to the first period, since subsequent periods necessarily follow. This can be overcome by including future data in Foundational Table rows—in a manner analogous to including lagged data. So, for example, suppose that the data of FIG. 90 is loaded into the Foundational Table. The “Upcoming Month's Unemployment” column references the unemployment that proves to occur for the upcoming month. So, in this example, which has the perspective that the current date is Jun. 4, 2010:

unemployment proved to be 4.2% in April 2010, and so is associated with March 2010;

unemployment proved to be 4.1% in May 2010, and so is associated with April 2010;

data for June 2010 is not yet available, so nothing is associated with May 2010;

With the Foundational Table having data like this, target distribution proportions (tarProp) for the upcoming period (month in this case) can be specified, thus defining an EFD for use in weighting.

Whether the scenario generation form is direct or sampled, whether the Foundational Table type is cross sectional or time series, generated scenario data can be analyzed directly, used as input for computer simulations, and/or used as scenarios for scenario optimizations. In fact, the generated scenarios can be used in the same way that the original raw inputted data (roData) might be (might have been) used apart from the present invention. Regarding scenario generation, the value added by the present invention is identifying explanatory variates, proportioning the data, projecting the data so that probability moments beyond variance are preserved, and allowing and helping the Forecaster to make forecasts by directly manipulating data in a graphical framework (Data Shifting).

Though BinTab bins boundaries could be so narrow as to admit only a single unique value, generally they will be sized to admit multiple values. In addition, though BinTabs could have a single bin with a 100% target probability, generally they will have multiple bins with fractional target probabilities. For some applications, the result of this, however, is too much scenario-generated data that has not been sufficiently refined. This occurs particularly when exogenous variates are point values that are known with certainty. The solution is to use Probabilistic-Nearest-Neighbor-Classifier, which starts with a weighted (by wtCur) Foundational Table.

IV.B.8. Calculate Nearest-Neighbor Probabilities

Probabilistic-Nearest-Neighbor was previously introduced with the promise of pseudo code to the problem of FIG. 31. Pseudo code to span Boxes 3230 to 3250 of FIG. 32 follows.

Prior-art techniques were used to identify both the County and Town, which consists of eight and five points respectively as shown in FIG. 31. Suppose the County Points are placed a countyPts structure, the associated wtCur weights are placed in a vector named wtCurExtract, a vector inTown has Boolean values indicating whether a County Point is also a Town Point, and the coordinates of the Open Point 3101 are stored in openPt. Given these assumptions, the following pseudo code determines the probabilities that each of the eight Counties is the nearest neighbor to the Open Point 3101:

| probNN[8]; // probability of being nearest neighbor | |
|---|---|
| openPt | // v6 and v7 coordinates of open point |
| countyPts[8]; | // v6 and v7 coordinates of 8 points |
| inTown[8]; | // Boolean indicating whether point |
| | // is in town |

```
ctInterleaving[8];
for(i=0;i<8;i++)
  ctInterleaving[i] = 0;
for(i=0;i<8;i++)
  if(inTown[i])
    {
    for(j=0;j<8;j++)
      if(i!=j)
        {
        if( openPt.v6 < countyPts[j].v6 &&
          countyPts[j].v6 < countyPts[i].v6 )
          {
          ctInterleaving[i] = ctInterleaving[i] + 1;
          }
        else if( openPt.v6 > countyPts[j].v6 &&
          countyPts[j].v6 > countyPts[i].v6 )
          {
          ctInterleaving[i] = ctInterleaving[i] + 1;
          }
        else if( openPt.v7 < countyPts[j].v7 &&
          countyPts[j].v7 < countyPts[i].v7 )
          {
          ctInterleaving[i] = ctInterleaving[i] + 1;
          }
        else if( openPt.v7 > countyPts[j].v7 &&
          countyPts[j].v7 > countyPts[i].v7 )
          {
          ctInterleaving[i] = ctInterleaving[i] + 1;
          }
        }
    ctInterleaving[i] = ctInterleaving[i] + 1;
    }
for(i=0;i<8;i++)
  if(inTown[i])
    for(j=0;j<8;j++)
      if(inTown[j])
        if(i!=j)
          {
          v6i = countyPts[i].v6
          v6j = countyPts[j].v6
          v7i = countyPts[i].v7
          v7j = countyPts[j].v7
          v60 = openPt.v6
          v70 = openPt.v7
          if( v60 < v6i && v6i < v6j &&
            v70 < v7i && v7i < v7j )
            {
            inTown[j] = FALSE;
            }
          if( v60 < v6i && v6i < v6j &&
            v70 > v7i && v7i > v7j )
            {
            inTown[j] = FALSE;
            }
          if( v60 > v6i && v6i > v6j &&
            v70 > v7i && v7i > v7j )
            {
            inTown[j] = FALSE;
            }
          if( v60 > v6i && v6i > v6j &&
            v70 < v7i && v7i < v7j )
            {
            inTown[j] = FALSE;
            }
          }
for(i=0;i<8;i++)
  probNN[i] = 0;
for(i=0;i<8;i++)
  if(inTown[i])
    probNN[i]= 1.0/ctInterleaving[i];
Normalize(probNN) // Normalize to sum to 1.0.
for(i=0;i<8;i++)
  if(inTown[i])
    probNN[i] = probNN[i] * wtCurExtract[i];
Normalize(probNN); // Normalize to sum to 1.0.
```

The final resulting probNN vector contains probabilities that each of the Town points is individually the nearest neighbor to openPt. The eight county points (some have zero probabilities) are used in the same way that any set of nearest-neighbor points are presently being used apart from the present invention, except probabilities in probNN are also considered. So, for example, suppose that the value of v0 is desired for Open Point 3101. Rather than simply computing an average value of v0 across all nearest-neighbors, one could use probNN with the County points as a distribution of the possible values of v0 for Open Point 3101. Alternatively, one could compute a weighted average for v0. Specifically:

estimatedV0 = 0;
for(i=0;i<8;i++)
estimatedV0 = estimatedV0 + countyPts[i].v0 * probNN[i];

Note that wtCur is used to determine the probabilities. Hence, Weighting EFDs can be used to proportion the Foundational Table and thus make an environment for any nearest neighbor calculation that is either current or forecast, as opposed to historic. As an example, suppose that a dataset is obtained in the year 2000 and has an equal number of men and women. If the current year is 2003 and if the proportion of men and women has changed, then to use the 2000 dataset without any correction for the proportion of men and women would result in inaccuracies. If the dataset were loaded into the Foundational Table and if an EFD regarding gender were specified, then the inaccuracies on account of incorrect men/women proportions would be corrected for. Hence, a weighted Foundational Table should be used for any nearest-neighbor calculation that uses an outdated dataset. Both the weighted Foundational Table and Probabilistic-Nearest-Neighbor are contributions of the present invention to the field of nearest-neighbor estimation. Ideally, Probabilistic-Nearest-Neighbor uses the Foundational Table as described, though it can use any dataset.

IV.B.9. Perform Forecaster Performance Evaluation

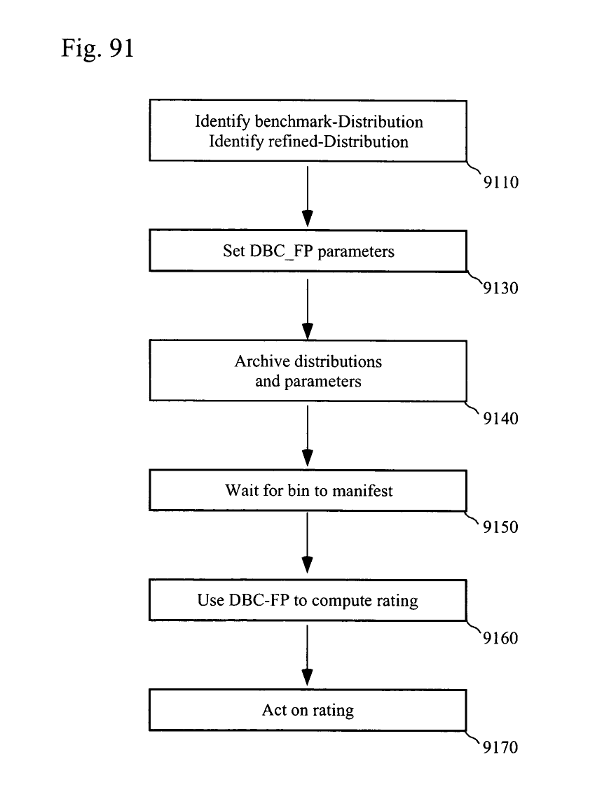

Returning to FIG. 64, Box 6417, Perform Forecaster Evaluation, in the process of the foregoing, the Forecaster provided two types of forecasts: Weighting EFDs and Shift EFDs. FIG. 91 shows the steps for evaluating a weight forecast and a shift forecast, given a BinTab.

In Box 9110, both benchmark-Distribution and refined-Distributions are identified:

For a weight-forecast, orgProp is the benchmark-Distribution and tarProp is the refined-Distribution—the Forecaster is specifying an override of orgProp, so it is appropriate to compare tarProp against orgProp.

For a shift-forecast, curProp is the benchmark-Distribution and shiftProp is the refined-Distribution—the Forecaster is specifying a subjective-override of curProp, so it is appropriate to compare shiftProp against curProp.

In Box 9130, DBC-FP parameters, fpBase and fpFactor are set by an Analyst. If only a raw forecast-performance rating is desired, then the defaults (fpBase=0 and rFactor=1) are adequate. However, DBC-FP can be used to compute an actual monetary compensation and the two parameters can be set so to that DBC-FP yields desired targeted minimum and maximum values. The following determines fpBase and fpFactors so that DBC-FP yields targeted minimums (tarMin) and maximums (tarMax):

PCDistribution B=benchmark-Distribution of box 9110

PCDistribution R=refined-Distribution of box 9110

find i, such that B[i]-R[i] is maximized, where 0<=i<nbin;

lowRt=DBC-FP(B, R, i);

find i, such that R[i]-B[i] is maximized, where 0<=i<nBin;

highRt=DBC-FP(B, R, i);

fpFactor=(tarMax−tarMin)/(highRt−lowRt);

fpBase=tarMin−fpFactor*lowRt;

These targeted minimums (tarMin) and maximums (tarMax) can be subjectively set, set based upon analyses exogenous to the present invention, or could be based upon the valuations yielded by Explanatory-Tracker.

In Box 9140, the benchmark-Distribution and refined-Distribution of Box 9110, along with fpFactor and fpBase of Box 9130, are archived for future use.

In Box 9150, a wait occurs. The wait could be for a fraction of a second or for up to decades.

In Box 9160, once j BinManifest becomes known, DBC-FP is used to compute the performance rating. Specifically:

PCDistribution B=benchmark-Distribution of box 9110

PCDistribution R=refined-Distribution of box 9110

fpFactor=fpFactor of Box 9130

fpBase=fpBase of Box 9130

rating=DBC-FP(B, R, jBinManifest, fpBase, fpFactor)

In Box 9170, the rating is acted upon. The rating could be used for appraisal: is the Forecaster accurately forecasting? It could also be used as a monetarily amount to pay the Forecaster.

FIG. 91 implicitly assumes that the Forecaster made only a single forecast. To evaluate multiple forecasts, the results of individual forecast evaluations are aggregated by summation. Note that the above prevents a double counting: so, for example, if the Forecaster provided a Weight-forecast for GDP-growth and provided a Shift-forecast for new-car-sales, the above evaluation procedure would determine the value of the new-car-sales forecast in-light-of/contingent-upon the GDP-growth forecast. The GDP-growth forecast, meanwhile, is evaluated independently of the new-car-sales forecast.

Sometimes, both the Weight-forecasts and the Shift-forecasts of Box 9110 will be undergoing revisions while the DBC-FP parameters are being set. There also might be bargaining between the Forecaster and the Analyst regarding appropriate tarMin and tarMax to be used. Nevertheless, because of the properties of Equation 3.0, the Forecaster is compelled to reveal what the forecaster thinks. Nothing more can be expected of the Forecaster.

IV.B.10. Multiple Simultaneous Forecasters

Since the introduction of FIG. 57, a single Forecaster has been assumed. If multiple Forecasters attempted to use the same BinTabs and the same Foundational Table shift-columns, both access and subjective-opinion conflicts would likely arise. Disentangling performance ratings would be impossible.

There are several philosophical issues that need to be addressed regarding multiple Forecasters: How to aggregate their EFDs? Should the performance of each EFD should be evaluated as previously described, or should they be compared against each other? If EFDs are to be compared against each other, how should such a comparison be made? In answer, here it is considered preferable to:

Aggregate multiple weighting EFDs by computing arithmetic-means for each bin.

Aggregate multiple shift EFDs by random consistent sampling.

Compare EFDs against each other.

The central idea of random consistent sampling is to provide responsibility for a consistent set of Foundational Table shift entries to each Forecaster, the set initially being randomly determined. This prevents conflict between different Forecasters regarding different shift datums.

To compare Forecaster performances each against the other, here it is considered preferable to create a delphi-Distribution based upon EFDs and then compare each EFD against the delphi-Distribution. It is deemed preferable to set each bin of the delphi-Distribution equal to the geometric mean of the corresponding bin in the EFDs.

Calculating a delphi-Distribution using geometric means, however, raises two issues. First, geometric means calculations can result in the sum of the delphi-Distribution bins being less than 1.0. Fortunately, this can be ignored. Second, if zero EFDs bins are allowed, then the previously discussed agency problems occur. Further, with any EFD bin having a zero probability, the corresponding delphi-Distribution bin would have a zero probability. A simple, direct way to handle this possibility is to require that each Forecaster provide positive probabilities for all btfTarProp and btfShiftProp bins. Another, perhaps fairer and more considerate way is to assume that the Forecaster claims no special knowledge regarding zero-probability bins, calculate and substitute a consensus mean bin probability, and then normalize the sum of bins to equal 1.0.

Bringing all of this together, the solution for handling multiple Forecasters is to provide each with a BTFeeder. As previously discussed (See FIG. 61), Forecasters privately own BTFeeders, which can be merged with the underlying BinTab so that the Forecaster can perform operations as if the Forecaster owned the BinTab.

When a Forecaster accesses a BTFeeder, a temporary virtual merger occurs: btfTarProp temporarily virtually replaces the tarProp in the underlying BinTab and forecasterShift temporarily virtually replaces BinTab's shifted columns in the Foundational Table. For other users, a read-only lock is placed on the BTManager, the BinTab, and the BinTab 's shift-columns in the Foundational Table.

The Forecaster uses the merged virtual result as if the BinTab were accessed directly and as described above. Once the Forecaster is finished, the BTManager assumes responsibility for updating the underlying BinTab and the shifted columns in the Foundational Table.

Upon assuming update responsibilities, the first task for the BTManager is to update tarProp of the underlying BinTab. This is done as follows:

```
for(i=0;i<btNBin;i++)
  tarProp[i] = 0;
for(iBTFeeder=0;
  iBTFeeder<number of associated BTFeeders;
  iBTFeeder++)
    for(i=0;i<btNBin;i++)
      tarProp[i] = tarProp[i] +
          BTFeeder[iBTFeeder].btfTarProp[i];
for(i=0;i<btNBin;i++)
  tarProp[i] = tarProp[i] / number of associated BTFeeders;
```

The next task is to update the shifted column in Foundational Table. This is done as follows:

```
for (shift-column id = each shifted column addressed by BinTab)
  {
  rndSeed = id;
  for(i=0; i<nRec; i++)
    {
    iBTFeeder = (based on rndSeed, randomly
          generate a number between
          0 and the number of associated
          BTFeeders);
    set iForecaster = the ID of the forecaster
            who owns BTFeeder[iBTFeeder];
        // BTFeeders in BTManager, barring additions or
        // subtractions, are assumed to be accessible
        // in the same order.
    set tForecasterShift = iForecaster's forecasterShift
    FoundationTable[i][shift-column id] =
      tForecasterShift[i][shift-column id]
    }
  }
```

Note that by updating Foundational Table shift-columns, those columns become available to other Forecasters and Analysts. The private shift-columns in the Forecaster's forecasterShift are also available to the Forecaster, via other BTFeeders that the Forecaster owns.

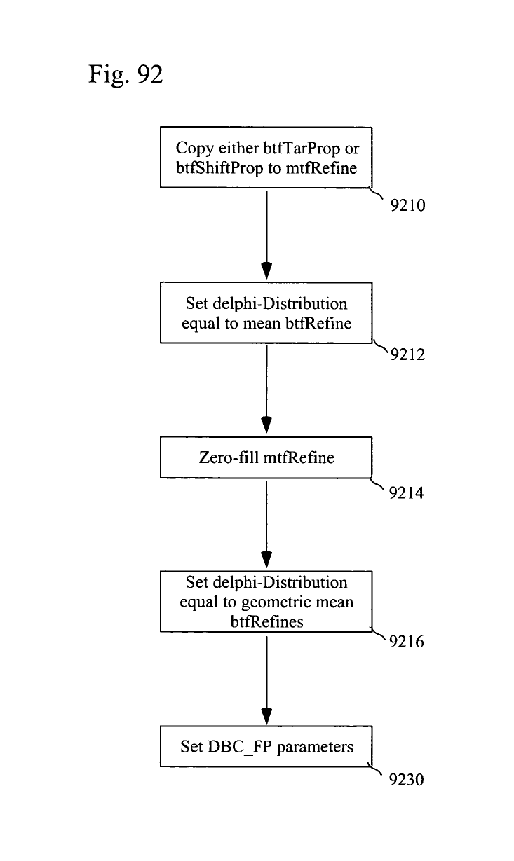

Performing Forecaster-Performance Evaluation with multiple Forecasters is analogous to the single Forecaster case discussed in regards to FIG. 91. The start, however, is different as shown in FIG. 92.

In Box 9210, if shifting has been done, then btShiftProp is copied to btfRefine. Otherwise, btfTarProp is copied to btfRefine. (The assumption, of course, is that the Forecaster made a Weight- and/or a Shift-forecast.)

In Box 9212, the vector delphi-Distribution is set to the arithmetic mean bin values. Specifically:

```
for(i=0;i<btmNBin;i++)
  {
  delphi-Distribution[i] = 0;
  ct = 0;
  for (iBTFeeder=0;
    iBTFeeder<number of associated BTFeeders;
    iBTFeeder++)
      if(BTFeeder[iBTFeeder] .btfRefine[i] > 0)
        {
        delphi-Distribution[i] = delphi-Distribution[i] +
            BTFeeder[iBTFeeder] .btfRefine[i];
        ct = ct + 1;
        }
  delphi-Distribution[i] = delphi-Distribution[i] / ct;
  }
```

In Box 9214, btfRefine bins with zero values are set to the arithmetic mean bin value of delphi-Distribution. Specifically:

```
for(iBTFeeder=0;
  iBTFeeder<number of associated BTFeeders;
  iBTFeeder++)
  {
    for (i=0;i<btmNBin;i++)
      if( BTFeeder[iBTFeeder] .btfRefine[i] == 0)
        BTFeeder[iBTFeeder] .btfRefine[i] =
                delphi-Distribution[i];
    Normalize BTFeeder[iBTFeeder] .btfRefine[i] to sum to 1.
  }
```

In Box 9216, the vector delphi-Distribution is set to the geometric-mean bin values. Specifically:

```
for(i=0;i<btNBin;i++)
  delphi-Distribution[i] = 1;
for(iBTFeeder=0;
  iBTFeeder<number of associated BTFeeders;
  iBTFeeder++)
    for (i=0;i<btmNBin;i++)
      delphi-Distribution[i] = delphi-Distribution[i] *
              BTFeeder [iBTFeeder] .btfRefine[i];
for (i=0;i<btNBin;i++)
  delphi-Distribution[i] = pow(
  delphi-Distribution[i] , 1.0 / number of associated
BTFeeders);
```

Once delphi-Distribution (benchmark-Distribution) and mtfRefine (refined-distribution) have been determined, Box 9230 is excluded. Since a geometric mean is being used, the sum of info Val across all BTFeeders of a given BTManager is constant! The ratings vary from Forecaster to Forecaster, but the overall total is constant. Hence, no risk or uncertainty for the entity compensating the Forecasters.

The Forecasters themselves bear risk, and in Box 9230, as in Box 9130, the Analyst sets DBC-FP parameters, fpBase and fpFactor so as to adjust the level of risk and reward for the Forecasters. Like before, the following determines fpBase and fpFactor so that DBC-FP yields targeted minimums (tarMin) and maximums (tarMax):

```
StatTab statTab;
for(iBTFeeder=0;
  iBTFeeder<number of associated BTFeeders;
  iBTFeeder++)
    {
    for(i=0;i<btmNBin;i++)
      {
      val = DBC_FC(delphi-Distribution,
          BTFeeder[iBTFeeder] .btfRefine,
          i);
      statTab.Note( val, 1);
      }
    }
fpFactor = (tarMax − tarMin) /
      (StatTab.GetMax( ) − statTab.GetMin( ));
fpBase = tarMin-fpFactor * statTab.GetMin( );
```

After fpFactor and fpBase have been determined, multiple Forecasters performance evaluation continues as shown in FIG. 91, Box 9140.

Thus far, the discussion has focused almost exclusively upon a Private-Installation of the present invention. As introduced in FIG. 6, the focus will now shift to risk sharing and trading and the Risk-Exchange.

IV.C. Risk Sharing and Trading

The Risk-Exchange is an electronic exchange like a stock exchange, except that rather than handling stock trades, it handles risk sharing and trading. It is analogous to the IPSs, which are electronic exchanges for trading publicly-traded securities. It is also analogous to the eBay Company, which provides a website for the general public to auction, buy, and sell almost any good or service. Knowledge of how to operate exchanges, regarding, for instance, who can participate and how to handle confidentiality, settlements, charges, transaction fees, memberships, and billing is known in the art and, consequently, will not be discussed or addressed here.

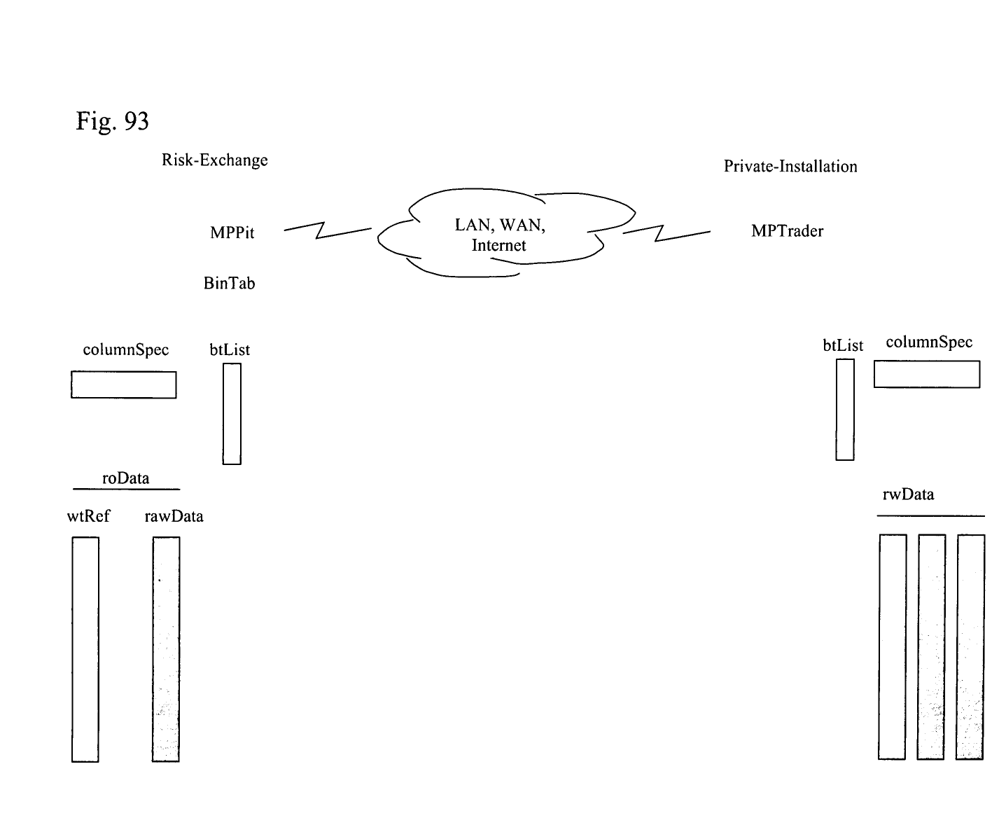

As shown in FIG. 6, the Risk-Exchange is the Hub in a Spoke-and-Hub network of computer systems. The Spokes are the many Private-Installations. FIG. 93 shows details regarding the Risk-Exchange, a single Private-Installation, and their interaction.

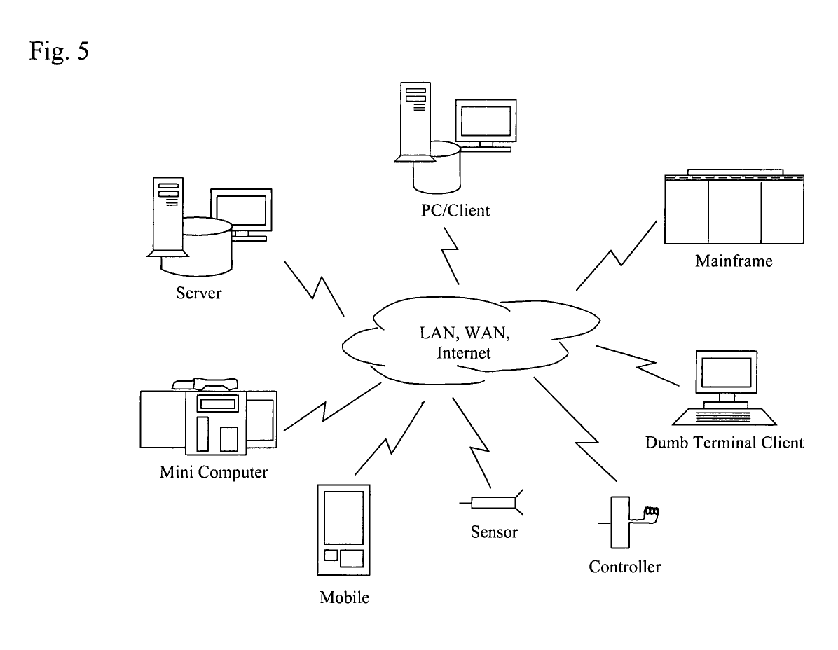

Regarding risk sharing and trading, the MPPit (Market Place Pit) object is the essence of the Risk-Exchange and MPTrader (Market Place Trader) object is the essence of the Private-Installation. Through a LAN, WAN, or the Internet, the MPTrader connects with the MPPit. Ideally, the Risk-Exchange is always available to any MPTrader. The converse is not necessary and in fact the Risk-Exchange operates independently of any individual MPTrader. The Risk-Exchange can have multiple MPPits and the Private-Installation can have multiple MPTraders. (And there can be multiple Private-Installations). The MPPit contains a reference to a BinTab object, while MPTrader contains a reference to a BTManager. Both sit-on-top-of different halves of what is shown in FIG. 57. The Risk-Exchange has roData and associated columnSpec, btList, and BinTabs; while the Private-Installation has everything else, including rwData and associated btList and columnSpec and BTManagers. (The Private-Installation is used by Analysts and Forecasters as described above. The roData happens to reside on the Risk-Exchange. Since Spoke-and-Hub architectures are well known and appreciated, and since FIG. 5 implicitly includes such a configuration, this aspect of the Risk-Exchange and Private-Installation relation will not be considered further.)

IV.C.1. Data Structures

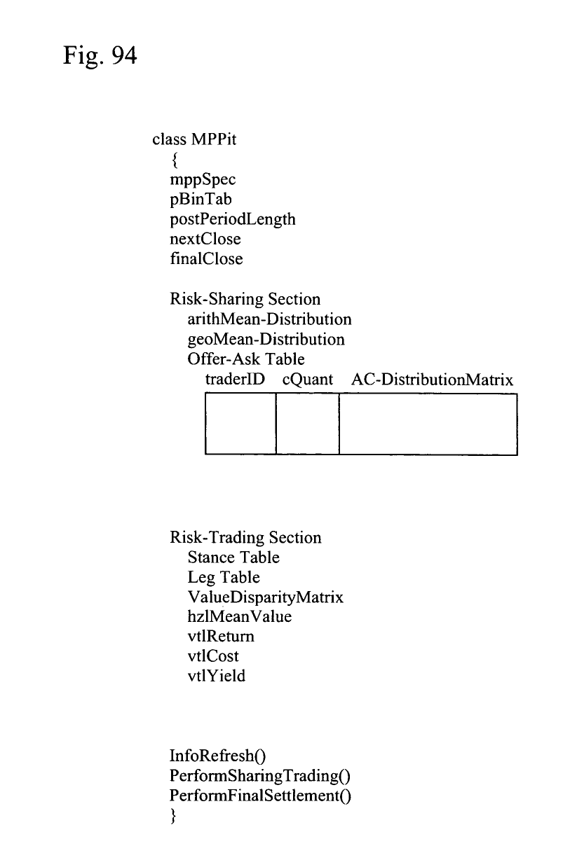

The MPPit class header is shown in FIG. 94:

Component mppSpec contains general specification information. In particular, it contains instructions/parameters so that member function PerformFinalSettlement can determine which bin manifests.

Component pBinTab is a pointer to a BinTab object. The essential function of this BinTab is to define bin bounds.

Component postPeriodLength is the time interval between successive nextCloses.

Component nextClose is a closing date-time when all ac-Distributions are converted into PayOffRows and when PayOffRows are traded.

Component finalClose is the date-time when, based upon the manifested bin, contributions are solicited and disbursed.

The Risk-Sharing Section contains:

Component arithMean-Distribution corresponds to FIG. 35 and was previously described.

Component geoMean-Distribution corresponds to FIG. 38 and FIG. 49 and was previously described.

Component Offer-Ask Table contains traderID, cQuant and AC-DistributionMatrix. It corresponds to FIG. 34 as previously described. (If FIG. 48 had an AC-DistributionMatrix, rather than a C-DistributionMatrix, it would constitute an Offer-Ask Table.)

The Risk-Trading Section contains:

Stance Table, which is like that shown in FIG. 52. (The number of bins for VB-DistributionMatrix and MaxFutLiability equals nBin ofpBinTab (i.e., pBinTab->nBin) and may be different from the five-count as shown.)

Leg Table, which is like that shown in FIG. 51.

ValueDisparityMatrix, hz/Mean Value, vtlReturn, vtlCost, and vtlYield, which are like those shown in FIG. 54:

hzlMean Value is the horizontal mean value of positive values and suggests average Leg Table row value.

vtlReturn is the vertical sum of positive values, divided by two.

vtlCost is the sum of cashAsk values that correspond to positive ValueDisparityMatrix values, plus vtlReturn.

vtlYield, which is vtlReturn divided by vtlCost, suggests an average return that could be realized if Farmer FA, Farmer FB, etc. were to purchase Leg Table rows. Note if vtlCost is negative, then vtlYield is infinity.)

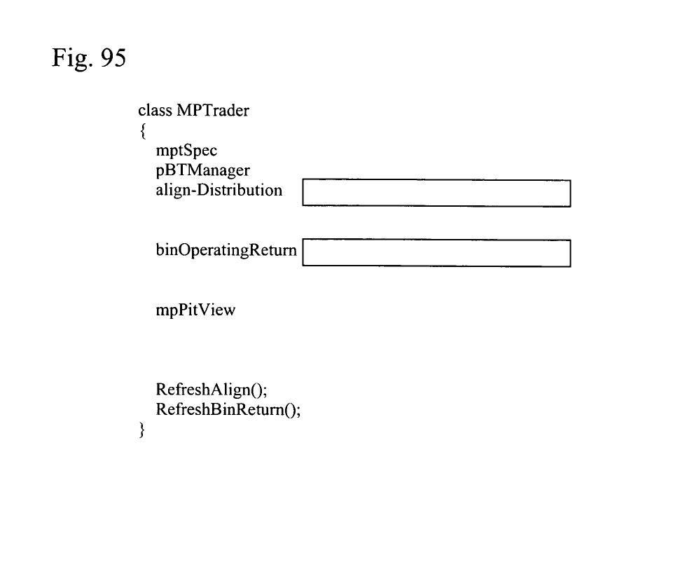

The MPTrader class header is shown in FIG. 95:

Component mptSpec contains specifications, in particular specifications for connecting with the MPPit object on the Risk-Exchange.

Component pBTManager is a pointer to a BTManager object residing on the Private-Installation.

Component align-Distribution is as shown in FIGS. 40 and 45, and similar to the ac-Distributions shown FIG. 34. It is the Trader's current best forecast.

Component binOperatingReturn is as shown in FIG. 41. It contains forecasted net profits, contingent upon which bin manifests.

Component mpPitView is a view into MPPit. The following are available for a Trader and MPTrader to read and as indicated, edit:

pBin Tab

postPeriodLength

nextClose

finalclose

Risk-Sharing Section

arithMean-Distribution

geoMean-Distribution

Offer-Ask Table rows that correspond to the Trader; such rows are editable.

Risk-Trading Section

Stance Table rows that correspond to the Trader; such rows are editable.

Leg Table rows that correspond to the Trader; such rows are editable, with restrictions.

Elements of vtlYield and hzlMean Value that correspond to the Trader.

IV.C.2. Market Place Pit (MPPit) Operation

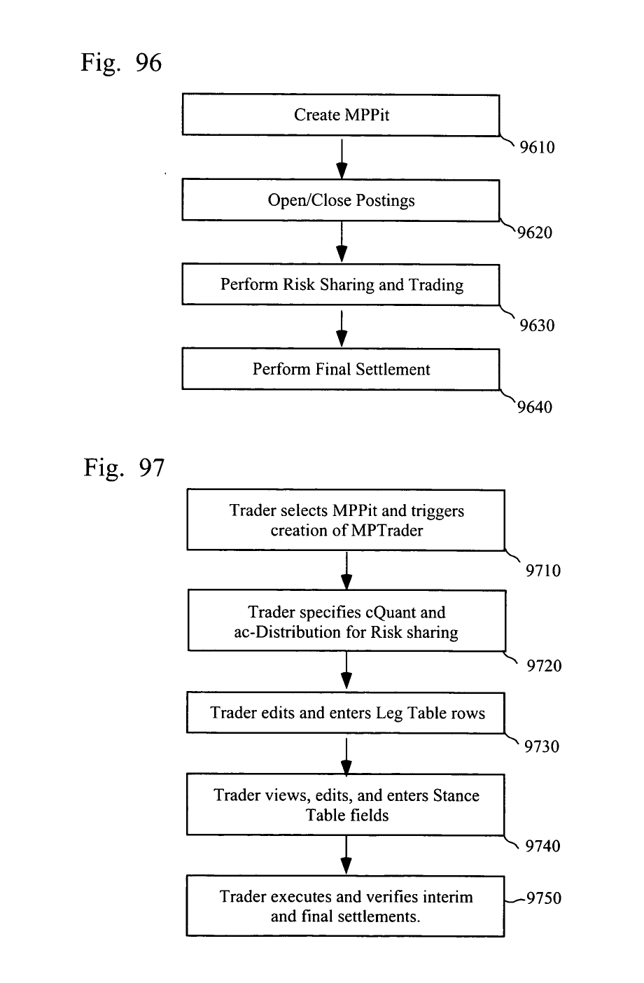

The operation of the MPPit is shown in FIG. 96.

In Box 9610, an MPPit is created.

Component pBinTab is set to reference a BinTab.

A final-close date and time need to be determined and stored infinalClose. This is a future date and time and ideally is the moment just before the manifest bin becomes known to anyone.

An open posting period length is determined and stored in postPeriodLength. Typically, this would be a small fraction of the time between MPPit creation and finalClose.

Scalar nextClose is set equal to the present date and time, plus postPeriodLength.

Within the operating system, time triggers are set so that:

Function InfoRefresh is periodically called after a time interval that is much smaller than postPeriodLength.

Function PerformSharingTrades is called the moment of nextClose and nextClose is incremented by postPeriodLength.

Function PerformFinalSettlement is called the moment of finalClose.

Finally, a procedure needs is put into place so that once Function PerformFinalSettlement is called, it can determine which bin manifested. Such a procedure could entail PerformFinalSettlement accessing mppSpec to determine a source from which the manifested bin could be determined. Alternatively, it could entail PerformFinalSettlement soliciting a response from a human being, who would have determined the manifested bin though whatever means. The most straight forward approach, however, would be for PerformFinalSettlement to fetch the appropriate value from the Foundational Table, which would be continuously having new rows added, and then, from this fetch value, determining the manifested bin.

As can be seen, MPPits objects can be easily created using manual or automatic means. What distinguishes MPPits objects is the pBinTablfinalClose combination. Multiple MPPits could have the same pBinTab, but different finalCloses; conversely, multiple MPPits could have the same finalClose, but different pBinTabs. Ideally the Risk-Exchange would automatically generate many MPPits and would manually generate MPPits because of ad hoc needs and considerations.

In Box 9620, Traders are allowed to make entries in the Offer-Ask, Stance, and Leg Tables. As the InfoRefresh function is called, arithMean-Distribution, geoMean-Distribution, and ValueDisparityMatrix are recalculated as previously described. This provides Traders with updated information.

For improved numerical accuracy, the following technique for calculating the geoMean-Distribution is used:

```
void GetGeoMean(vector cQuant,
        Matrix& C-DistributionMatrix,
        PCDistribution& geoMean-Distribution)
  {
  Calculate the sum of entries in cQuant;
  divide each entry by this sum.
  (In order words, apply Norm1 ( ) of PCDistribution to cQuant.)
  for(jBin=0;jBin<nBin;jBin++)
    geoMean-Distribution[j] = 1;
  for(i=0;i<number of rows in C-DistributionMatrix;i++)
    for(jBin=0;jBin<nBin;jBin++)
      geoMean-Distribution[j] =
        geoMean-Distribution[j] *
        pow( C-DistributionMatrix[i][j], cQuant[i] );
  }
```

In Box 9630, function PerformSharingTrading is called. It, in turn, initially calls the previously mentioned InfoRefresh function.

Based upon the data contained in the Offer-Ask Table, a PayOffMatrix is calculated as previously described. It, together with cQuant, are appended to the Leg Table. For these rows appended to the Leg Table, tradable and cashAsk are set to “No” and “0” respectively.

Based upon the data contained the Risk-Trading Section of MPPit, the ValueDisparityMatrix is calculated. Trades are made as described before, but specifically as follows:

```
find iSeller and jBuyer such that
  ValueDisparityMatrix[iSeller][jBuyer] is maximal.
while(ValueDisparityMatrix[iSeller][jBuyer] > 0)
  {
  factor = 1;
  if(0<cashAsk[iSeller] &&
    cashAsk[iSeller] > cashPool[iBuyer] )
    factor = cashPool[iBuyer] / cashAsk[iSeller];
  for (k=0;k<nBin;k++)
    if(  PayOffMatrixMaster[iSeller][k] < 0)
      if(−PayOffMatrixMaster[iSeller][k] * factor >
          MaxFutLiability[iBuyer ][k])
        factor = factor *
            (−PayOffMatrixMaster[iSeller][k])/
              MaxFutLiability[iBuyer ][k];
  trigger means so that jBuyer pays iSeller:
    ValueDisparityMatrix[iSeller][jBuyer] * factor * 0.5 +
                cashAsk[iSeller] * factor
  decrement cashPool [jBuyer] by amount paid to iSeller
  Append row q to Leg Table:
    set traderId[q] = trader id corresponding to jBuyer
    set tradable[q] = FALSE
    set cashAsk[q] = 0
    for(k=0;k<nBin;k++)
      {
      PayOffMatrixMaster[q][k]  =
        PayOffMatrixMaster[iSeller][k] *  factor;
      PayOffMatrixMaster[  iSeller][k] =
        PayOffMatrixMaster[iSeller][k] * (1.0 − factor)
      }
    cashAsk[iSeller] = cashAsk[iSeller] * (1.0 − factor)
  for(k=0;k<nBin;k++)
    MaxFutLiability[iBuyer][k] += PayOffMatrixMaster[q][k];
  for(j=0;j<number of columns in ValueDisparityMatrix;j++)
    ValueDisparityMatrix[iSeller][j] =
    ValueDisparityMatrix[iSeller][j] * (1−factor)
  ValueDisparityMatrix[iSeller][iBuyer] = 0;
  find iSeller and jBuyer such that
    ValueDisparityMatrix[iSeller][jBuyer] is maximal.
  }
```

As a result of all these trades, net cash payments to and from each buyer and seller are aggregated, and arrangements to make such payments are made. Ideally, such arrangements entail electronically crediting and debiting, buyer and seller cash accounts.

Finally, nextClose is incremented by postPeriodLength and Box 9620 resumes operation to begin another round of risk sharing and trading.

In Box 9640, function PerformFinalSettlement is called. It, in turn, initially calls the previously mentioned InfoRefresh function.

Based upon what was established when the present instance of MPPit was created, PerformFinalSettlement initially determines which bin manifested. Based upon the corresponding manifested column in PayOffMatrixMaster, contributions are solicited and withdrawals are made. Once all contributions and disbursements have been made, the present instance of MPPit inactivates itself.

IV.C.3. Trader Interaction with Risk-Exchange and MPTrader

How the Trader interacts with both the Risk-Exchange and the MPTrader object is outlined in FIG. 97.

In Box 9710, the Trader identifies an appropriate MPPit. An MPTrader object is created and mptSpec loaded with proper references to the MPPit.

If a BTManager on the Private-Installation exists, such that the bin boundaries of its underlying BinTab are identical to the bin boundaries of the MPPit's BinTab, then pBTManager is set as a reference to that BTManager on the Private-Installation. Otherwise, pBTManager is set to NULL.

If pBTManager is not NULL, then the Trader can trigger execution of function RefreshAlign at any time. This function references, depending upon the Trader's choice, either:

pBTManager->delphi-Distribution

pBTManager->pBinTab->orgProp,

pBTManager->pBinTab->tarProp,

pBTManager->pBinTab->curProp, or

pBTManager->pBinTab->shiftProp

and copies the distribution to align-Distribution of MPTrader.

At any time, the Trader can also trigger execution of function RefreshBinReturn to obtain and load binOperatingReturn with values that correspond to latest-forecasted operating gains and losses for each bin. If stochastic programming is used for Explanatory-Tracker, then the links are in place to determine such gains and losses for each bin.

Whether or not align-Distribution and binReturn are loaded using pBTManager, the Trader can directly enter values for each bin. The idea of automatic loading is to provide the Trader with reasonable starting values to edit.

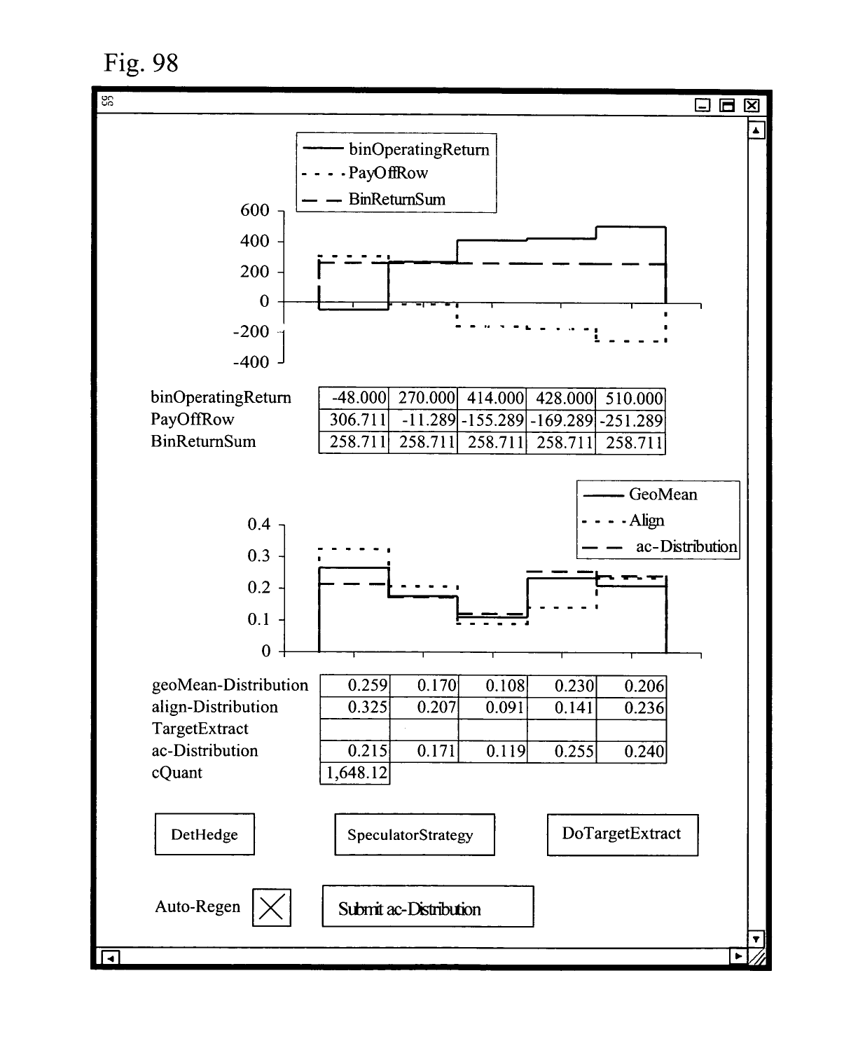

In Box 9720, the Trader specifies a cQuant and ac-Distribution for risk sharing using a GUI Window as shown in FIG. 98.

Both align-Distribution and binOperatingReturn originate from the underlying MPTrader. Their bin values can be changed using this window, and afterwards stored back in the underlying MPTrader.

The geoMean-Distribution is obtained from the MPPit. If previously posted to the Offer-Ask Table, the previous cQuant and ac-Distribution are retrieved and included in the associated fields of the Window.

Given geoMean-Distribution, cQuant and ac-Distribution, PayOffRow is calculated and shown below binOperatingReturn. BinReturnSum is the summation of binOperatingReturn and PayOffRow and is shown below PayOffRow. A graph of binOperatingReturn, PayOffRow, and BinReturnSum is shown in the top of the Window.

Both ac-Distribution and cQuant are shown below align-Distribution. A graph of geoMean-Distribution, align-Distribution, and ac-Distribution is shown in the lower middle of the Window.

Now the Trader can change any binOperatingReturn, align-Distribution, ac-Distribution, or cQuant value and see the result, holding geoMean-Distribution fixed. Clicking on “DetHedge” or “SpeculatorStrategy” triggers executing the respective functions and loading cQuant and ac-Distribution with function results. Once the Trader is satisfied with the displayed cQuant and ac-Distribution, “Submit AC-Distribution” is clicked and the Offer-Ask Table is appended/updated with traderID, cQuant, and ac-Distribution.

Though not previously discussed, another way of generating cQuant and ac-Distribution is for the Forecaster to specify a desired PayOffRow in TargetExtract and click the DoTargetExtract button. This triggers a call to the DetForExtract function to compute cQuant and ac-Distribution. Both DetHedge and SpeculatorStrategy also use this function, and by specifying TargetExtract, the Trader can sometimes more directly obtain a desired result.

By clicking on the Auto-Regen box, the Trader can have the system automatically handle obtaining updated geoMean-Distributions, applying either “DetHedge”, “SpeculatorStrategy”, or “DoTargetExtract” and posting cQuant and ac-Distribution to the Risk-Exchange. When multiple, even if fundamentally adversarial, Traders use this feature, a desirable overall Nash Equilibrium will result.

The particulars of the DetHedge and SpeculatorStrategy functions, along with DetForExtract, follow:

```
void DetHedge( )
  {
  double meanValue = 0;
  PCDistribution rt;
  for (jBin=0;jBin<nBin;jBin++)
    meanValue = meanValue +
      binOperatingReturn[jBin] *
      align-Distribution[jBin];
  for(jBin=0;jBin<nBin;jBin++)
    rt[jBin] = meanValue − binOperatingReturn[jBin];
  DetForExtract( geoMean-Distribution, rt,
            cQuant, ac-Distribution);
    }
  void SpeculatorStrategy( )
    {
    PCDistribution rt;
    for(jBin=0;jBin<nBin;jBin++)
      rt[jBin] = log(align-Distribution[jBin] /
            geoMean-Distribution[jBin]);
    if( smallest element of rt < 0)
      DetForExtract(geoMean-Distribution, rt,
            cQuant, ac-Distribution);
    else
      cQuant = 0;
    }
  void DetOffSetGenP( PCDistribution& geoMean-Distribution,
            PCDistribution& tarReturn,
            double cQuant,
            PCDistribution& ac-Distribution,
            double& pSum)
    {
    for(jBin=0;jBin<nBin;jBin++)
      if(tarReturn[jBin])
        {
        double vVal;
        vVal = tarReturn[jBin];
        vVal = − vVal / cQuant;
        vVal = vVal + log(geoMean-Distribution[jBin]);
        vVal = exp(vVal);
        ac-Distribution[jBin] = vVal;
        }
      else
        ac-Distribution[jBin] =
            geoMean-Distribution[jBin];
    pSum = ac-Distribution.GetSum( );
    }
  void DetForExtract(PCDistribution& geoMean-Distribution,
          PCDistribution extract,
          double& cQuant,
          PCDistribution& ac-Distribution)
    {
    double tolerance = very small positive value
    double cBase = 0;
    for(jBin=0;jBin<extract.nRow;jBin++)
      if( cBase < abs(extract[jBin]) )
        cBase = abs(extract[jBin]);
    extract.MultiIn(1.0/cBase);
    double cHiSum, cLoSum;
    double pSum=1;
    double cLo = 0;
  double cHi = 0;
  cQuant = very small positive value;
  do
    {
    cQuant *= 2;
    DetOffSetGenP( geoMean-Distribution, extract,
            cQuant, ac-Distribution, pSum );
    if(1 < pSum)
      {
      cLo = cQuant;
      cLoSum = pSum;
      }
    else if(1 > pSum)
      {
      cHi = cQuant;
      cHiSum = pSum;
      }
    }
  while(!BETWEEN(1−tolerance, pSum, 1+tolerance) &&
              (!cLo ∥ !cHi));
  while(!BETWEEN(1−tolerance, pSum, 1+tolerance))
    {
    cQuant = (cLo + cHi)/2;
    DetOffSetGenP( geoMean-Distribution, extract,
              cQuant, ac-Distribution, pSum );
    if(1 > pSum)
      cHi = cQuant;
    else if (1 < pSum)
      cLo = cQuant;
    }
  ac-Distribution.Norm1( );
  cQuant *= cBase;
  }
```

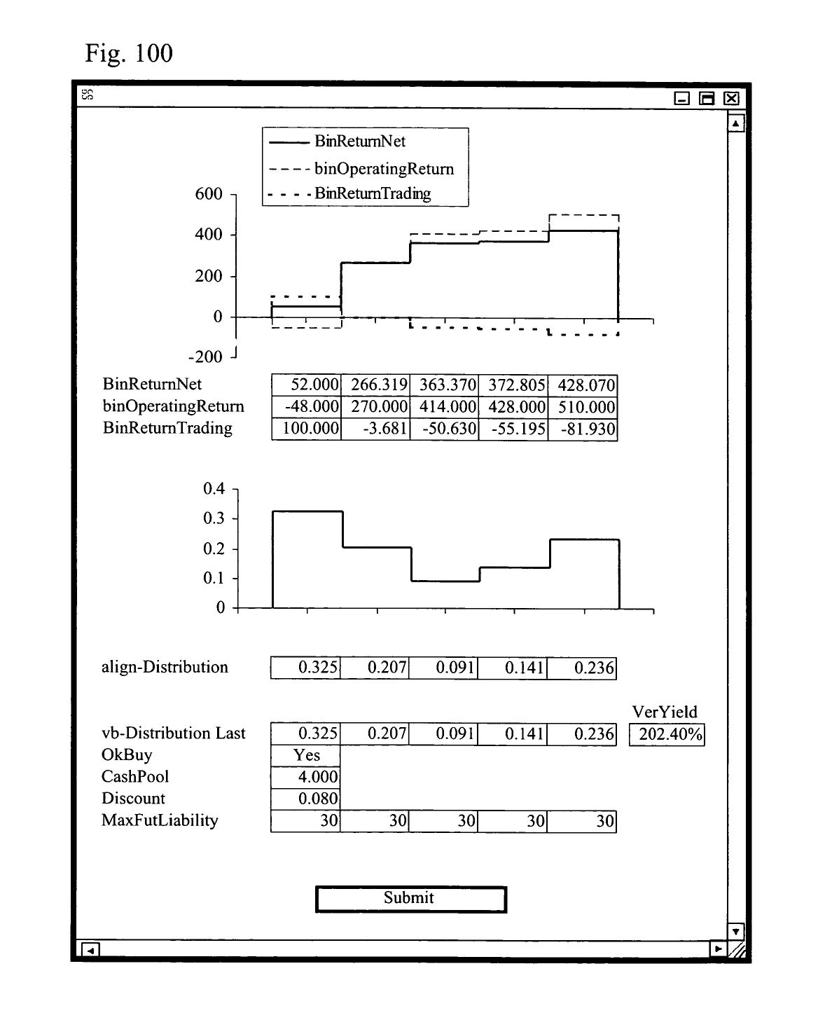

In Box 9730, using a GUI Window like that shown in FIG. 100, the Trader reviews his or her net position and sets Stance Table rows values.

Vector binOperatingReturn is the same as in FIG. 98 and, as in FIG. 98, can directly be edited. BinReturnTrading is an aggregation of the Trader's PayOffRows in the Leg Table. BinReturnNet is an aggregation of binOperatingReturn and BinReturnTrading. At the top of the window is a graph of these three vectors.

The align-Distribution, which is also shown as a graph, originates from the underlying MPTrader. Its bin values can be changed using this window, and afterwards stored back in the underlying MPTrader. Similarly, okBuy, cashPool, discount, and MaxFutLiability originate from the Stance Table and, after possibly being changed, are stored back in the Stance Table.

VerYield is obtained from the Trader's element in vtlYield, which is the result of the most recent calculation of ValueDisparityMatrix. The vb-Distribution last used for calculating VerYield is shown in the Window.

Now seeing FIG. 100, the Trader can decide whether to purchase PayOffRows: VerYield provides an average estimate of potential return. The Trader indicates authorization to buy by setting okBuy. Cash for buying PayOffRows is indicated in cashPool, as is a discount for future contributions and disbursements. Maximum potential liabilities for each bin are specified in MaxFutLiability.

Once the Trader is satisfied, “Submit” is pressed. The Trader's Stance Table row is updated. The align-Distribution is copied to the Trader's vb-Distribution in the Stance Table and the copy is used when determining ValueDisparityMatrix.

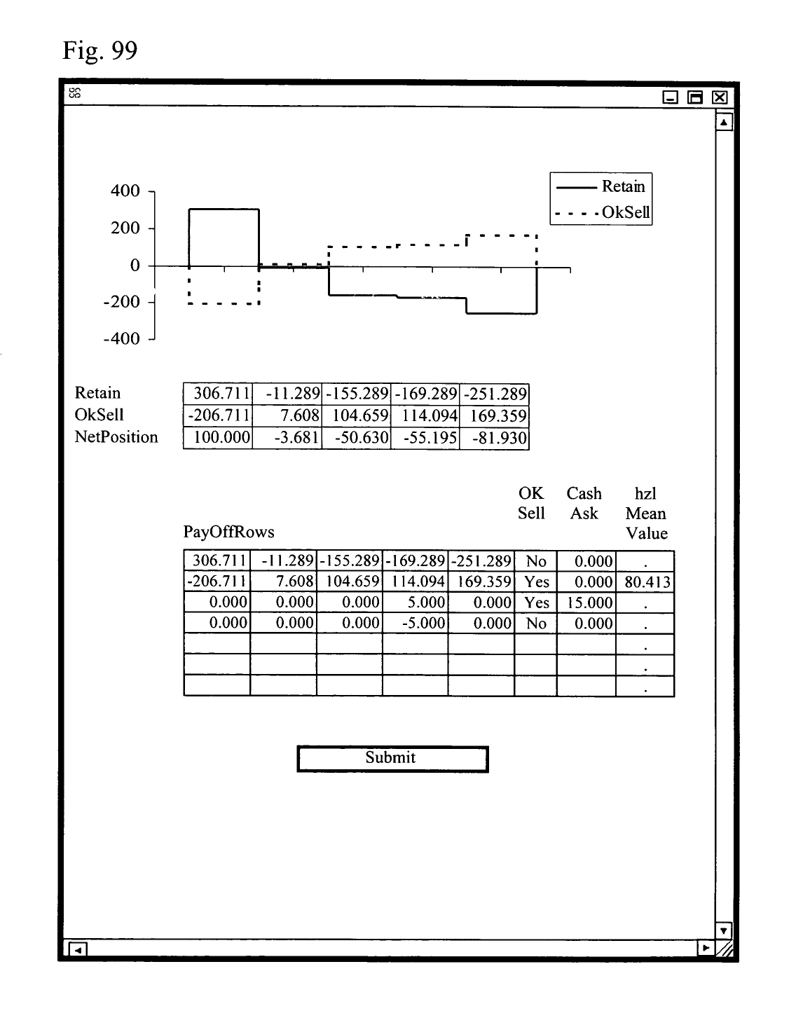

In Box 9740, using a GUI Window like that shown in FIG. 99, the Trader reviews his or her PayOffRows and sets Leg Table rows trading controls.

The following are obtained from the Trader's Leg Table rows and are loaded into the window:

PayOffRows

okSell

cashAsk

hzlMeanValue is the mathematical dot product of the PayOffRow with the align-Distribution.

With restrictions, the Trader can specify and edit these fields at will. Once the Trader is finished, these Leg Table field/rows written to the Leg Table as either an update or an append.

A distinction between PayOffRows that the Trader wants to sell, versus those PayOffRows that the Trader wants to retain, is made. An aggregation of these two types of PayOffRows is made and these aggregations are shown in the top portion of the Window. NetPosition shows the net contribution or disbursement that the Trader can expect for each bin.

By considering hzlMeanValue and other implicit factors, the Trader sets both “OkSell” and “CashAsk” as desirable. (hzlMean Value is read-only.)

The Trader can freely edit PayOffRows, OkSell, and CashAsk and can even create additional rows. The two rows with the fourth bin having +5 and −5 are two such created rows. An advantage here is that the Trader can create PayOffRows with the intention of selling some, while keeping others. (The example shown here regards Farmer FF's seeking the previously described hedge.) The editing and creation of PayOffRows is completely flexible, except that NetPosition must not change. In other words, the column totals for each PayOffRow bin must remain constant. If the totals were to change, then the position of the Trader vis-a-vis other Traders would unfairly change and result in an imbalance between contributions and disbursements.

Once the Trader is satisfied, “Submit” is pressed. The Trader's Leg Table row(s) is updated and additional rows appended. In other words, PayOffRows, OkSell, and CashAsk in the window replace the previous contents of the Trader's portion of the Leg Table.

Finally, in Box 9750, the Trader, or perhaps Analyst, verifies and executes interim and final cash settlements.

IV.D. Conclusion Ramifications, and Scope

While the above description contains many particulars, these should not be construed as limitations on the scope of the present invention; but rather, as an exemplification of one preferred embodiment thereof. As the reader who is skilled in the invention's domains will appreciate, the invention's description here is oriented towards facilitating ease of comprehension. Such a reader will also appreciate that the invention's computational performance can easily be improved by applying both prior-art techniques and readily apparent improvements.

Many variations and many add-ons to the preferred embodiment are possible. Examples of variations and add-ons include, without limitation:

1. The above procedure for storing both benchmark-Distributions and refined-Distributions and then calculating a payment to a Forecaster can be applied to employees whose jobs entail both forecasting and acting to meet forecasts. So, for example, consider a salesman. The salesman could be required to provide an EFD for expected sales. The salesman would then be paid an amount as calculated by Equation 3.0. However, because the salesman is paid according to forecast accuracy, a situation might arise wherein it is not in the interest of the salesman to make sales beyond a certain level. The solution is to set each Motᵢ to positive values so that it is in the interest of the salesman to make evermore sales, even at the cost of forgoing a compensation-component based upon forecast accuracy. In other words, each Motᵢ is set so that the value of Equation 3.0 for all jBinManifest is less than the value for jBinManifest+1.

2. The example of sharing and trading of risk regarding the artichoke market addressed what might be considered a public variate. A private variate could be handled similarly, though auditors may be required. So, for example, an automobile company that is about to launch a new model might have Risk-Exchange establish a MPPit for the new model's first year sales. Everything is handled as described above, except that an auditor, who is paid by the automobile company, would determine the manifested bin. Note that the automobile company could use the MPPit for hedging its position, but it could also use the MPPit for raising capital: it could sell, for immediate cash, PayOffRows that pay if the new model is successful. Note also that the general public would be sharing and trading risk associated with the new model, and this is desirable for two reasons. First, some general public members are directly affected by the success or failure of the new model and the Risk-Exchange would provide them with a means to trade their risk. Second, the company would be getting information regarding the general public's expectations for the new model.

3. In terms of parallel processing, when multiple processors are available, the CIPF_Tally function should work with a horizontally partitioned LPFHC (consisting of wtCur and dmbBin Vectors), wherein each processor is responsible for one or more partitions. For example, one processor might work with rows 0 through 9,999, a second processor might work with rows 10,000 through 19,999, etc.

When Explanatory-Tracker is operating, the various BinTab CalInfoVal function executions should be spread across multiple processors.

These are the two major strategies for using parallel processing. There are standard and known techniques for using parallel processing, and many of these techniques can be employed here as well.

4. There is a clear preference here for using geometric means for calculating PayOffRows. Other means, in particular, arithmetic means, could be used. In addition, other formula could be used to determine contributions and disbursements. If the sum of contributions is different from the sum of disbursements, then one or both need be normalized so that both totals are equal.

5. The DetHedge, SpeculatorStrategy, and DetForExtract functions could execute on the Risk-Exchange rather than the Private-Installations. This provides a possible advantage since the Risk-Exchange could better coordinate all the recalculations. The disadvantage is that Traders need to provide the Risk-Exchange with what might be regarded as highly confidential information.

6. In order to avoid potentially serious jockeying regarding magnitude of changes to cQuant and c-Distributions, the Risk-Exchange many need to impose restrictions regarding the degree to which cQuant and c-Distributions can be changed as nextClose is approached.

7. Scalar postPeriodLength could be set to such a small value, or means employed to cause the same effect, that at most only two Traders participate in each MMPCS and that ValueDisparityMatrix is re-calculated and potential trades considered each time a change is made to the Leg Table.

8. MPPit and MPTrader can function without the underlying structures shown in FIG. 57. MPPit minimally needs a BinTab to define bin boundaries, but such bin boundaries can be specified independently of any Foundational Table. Both MPTrader, and associated windows, can be independent of everything shown in FIG. 57.

9. The contents of FIGS. 98, 99, and 100 can be rearranged in an almost infinite number of ways. They can also be supplemented with other data.

In particular, for risk sharing between private individuals, these three windows of FIGS. 98, 99, and 100 might be compressed and simplified into a single window containing, as per FIG. 98, only PayOffRow, TargetExtract, and DoTargetExtract. This spares the private individual of considering details regarding probabilities, distributions, cQuant, etc.

10. As shown in FIG. 27, the Anticipated Contingency Table was loaded by collapsing the rows of the CtSource Contingency Table. The advantage of such collapsing is to mitigate possible distortions caused by possibly arbitrary bin boundaries. In the same way the rows were collapsed, the columns could be collapsed also. This would mitigate possible distortions caused by arbitrary bin boundaries of ry.

11. As shown above, the Risk-Exchange 's PayOffMatrix was determined according to the following formula:

rating=−log(Cᵢ/Gᵢ)

Instead, the negative sign could be changed to a positive sign and the PayOffMatrix determined according to

rating=+log(Cᵢ/Gᵢ)

This forgoes the advantage of “the presumably fortunate, paying the presumably unfortunate.” On the other hand, there are several advantages with this reformulation:

a. Infinitesimally small bin probabilities are permitted.

b. Each trader has a positive mathematically expected return.

c. The need to revise c-Distributions might be lessened, since expectations and rewards are more aligned.

The DetHedge, SpeculatorStrategy, and DetForExtract functions can be adapted to handle this change.

12. U.S. Pat. No. 6,321,212, issued to Jeffrey Lange and assigned to Longitude Inc., describes a means of risk trading, wherein investments in states are made and the winning state investments are paid the proceeds of the losing state investments. (Lange's “states” correspond to the present invention's bins; his winning “state” corresponds to the present invention's manifested bin.) The differences between Lange's invention and the present invention are as follows:

Lange requires investments in states/bins, while the present invention requires specified probabilities for states/bins and specified number of contracts.

Lange determines payoffs such that the investments in the manifested bin are paid the investments in the non-manifested bins; while the present invention determines payoffs based upon relative c-Distribution bin probabilities.

Computer simulation suggests that the approach described here yields greater utility (superior results) for the Traders. Hence, replacing Lange's required investments in states/bins with the present invention's specified probabilities for states/bins and specified number of contracts, together with replacing Lange's payoffs with the payoffs described here is likely advantageous. Note that given that these two replacements to Lange's invention are made, then the present invention can be applied to all of Lange's examples and can work in conjunction with the foundation of Lange's invention.

13. MPPit bins can be divided into smaller bins at any time, thus yielding finer granularity for c-Distributions, and in turn, Traders. After a bin has been split, the split bin's c-Distribution probabilities are also split. Since both Ci and Gᵢ in Equation 6.0 are in effect multiplied by the same value, the expected payoffs are not affected.

14. Credit and counter-party risk is handled by two means. First, if the legal owner of a Leg Table row is unable to make a requisite payment, then the deficiency is born on a pro-rata basis by those who would have shared the requisite payment. Second, the Risk-Exchange should have MPPits concerning credit and counter-party risk. So, for example, an MPPit might have two bins: one corresponding to an international bank declaring bankruptcy between January and March; another corresponding to the bank not declaring bankruptcy.

15. Besides what is shown here, other types of graphs could be used for target proportional weighting and data shifting.

16. Both Weighting EFDs and Shift EFDs could be provided by electronic sensors and/or computer processers separate from the present invention. Such is implied by FIG. 5.

17. Though it is considered preferable for the Risk-Exhange to transfer monetary payments between Traders, other forms of compensation could be used: For example, an MPPit could regard annual rice production, and rice is transferred from those who overestimated manifest-bin probability to those who underestimated manifest-bin probability.

18. When clustering is used to define bins, the resulting bins should be given recognizable names. Such recognizable names then can be used to label the graphs and diagrams of the present invention.

19. In order to correct for asymmetries in information as recognized by economists, and to promote risk sharing and trading, an MPPit could be based upon a BinTab that is based on two variates. So, for example, the BinTab 's first variate could be the annual growth in the artichoke market. The second variate could be the annual growth in the celery market. In this case, the ac-Distribution is actually the joint distribution of growth in both markets. Now, presumably, some Traders know the artichoke market very well and do not know the celery market very well. Other Traders know the celery market very well and do not know the artichoke market. Hence, all the Traders have roughly the same amount of information. Hence, they would all be willing to share and trade risks regarding both markets. A potential real advantage comes into play when one market does well, while the other does not: those experiencing the fortunate market compensate those experiencing the unfortunate market.

Note that more than two markets could be handled as described above. Note also that partial ac-Distribuitions, one concerned with the artichoke market and the other concerned with the celery market, could be submitted by the Traders, each being allowed to submit one or the other. The Risk-Exchange, in turn, could use historical data and the IPFP to determine full ac-Distributions, which would serve as the basis for contracts.

Six additional examples of the operation of the present invention follow next:

### EXAMPLE #1

Medical records of many people are loaded into the Foundational Table as shown in FIG. 57. These records are updated and columns created as more information becomes available, as are the BinTabs and DMBs.

During a consultation with a patient, a medical doctor estimates EFDs that regard the patient's condition and situation, which are used to weight the Foundational Tables rows. The CIPFC determines row weights. The doctor then views the resulting distributions of interest to obtain a better understanding of the patient's condition. The doctor triggers a Probabilistic-Nearest-Neighbor search to obtain a probabilistic scenario set representing likely effects of a possible drug. Given the scenario probabilities, the doctor and patient decide to try the drug. During the next visit, the doctor examines the patient and enters results into the Foundational Table for other doctors/patients to use.

A medical researcher triggers Explanatory-Tracker to identify variates that explain cancer of the mouth. The DBC-GRB is employed since the medical researcher is concerned with extending the lives of people at risk.

### EXAMPLE #2

The trading department of an international bank employs the present invention. The Foundational Table of FIG. 57 contains transaction, in particular pricing, data regarding currencies, government bonds, etc. Data-Extrapolator projects bond prices using Rails in order to meet certain necessary conditions.

Employee-speculators (commonly called traders, and corresponding to the Forecasters and Traders generally referenced in through-out this specification) enter EFDs. The CIPFC determines Foundational Table row weights. Scenarios are generated and inputted into Patents '649 and '577. Patents '649 and '577 optimizes positions/investments. Trades are made to yield an optimal portfolio. Employee-speculators are paid according to Equation 3.0.

### EXAMPLE #3

A manufacturer is a Private-Installation, as shown in FIG. 93.

The Foundational Table consists of internal time series data, such as past levels of sales, together with external time series data, such a GDP, inflation, etc.

Forecasters enter EFDs for macro economic variates and shift product-sales distributions as deemed appropriate. Scenarios are generated. Patent '123 and Patents '649 and '577 are used to determine optimal resource allocations. Multiple versions of vector binOperatingReturn are generated using different BinTabs. A Trader considers these binOperatingReturn vectors, views a screen like that shown in FIG. 98, and enters into contracts on the Risk-Exchange in order to hedge risks.

### EXAMPLE #4

A voice-recognition system embeds a Foundational Table as shown in FIG. 57. The user reads a prepared passage and a recording is made and stored in the Foundational Table, along with the corresponding pronounced phonemes. When the user dictates, sounds are noted as both discrete values and as empirical distributions. The CIPFC uses the noted data to weight the Foundational Table rows and the Probabilistic-Nearest-Neighbor-Classifier is used to generate scenarios of possible words uttered. The most likely scenario has the uttered word.

### EXAMPLE #5

A Hollywood movie producer has the Risk-Exchange create an MPPit regarding possible box-office sales for a new movie. (One bin corresponds to zero sales—representing the case that the movie is never made.) The producer promotes the movie and sells PayOffRows on the Risk-Exchange. People who think the movie is promising buy the PayOffRows; the producer uses the proceeds to further develop and promote the movie.

The producer judiciously sells more and more PayOffRows—hopefully at higher and higher prices—until the movie is distributed, at which time, depending on box-office sales, the producer pays off the PayOffRow owners. A Big-4 international accounting firm monitors the producer's actions. All along, PayOffRows are being traded and the producer is deciding whether to proceed. Knowledge of trading-prices helps the producer decide whether to proceed.

### EXAMPLE #6

An individual investor both logs onto a website that contains a Foundational Table and specifies EFDs that reflect the investor's assessments of future possibilities regarding general economic performance and specific possible investments. On the website, the CIPFC determines Foundational Table row tables weights (wtCur) and scenarios are generated. These scenarios are used by Patents '649 and '577 to determine an optimal investment portfolio, which is reported back to the individual investor.

### EXAMPLE #7

Returning to the earlier example of three balls floating in a pen, assuming data has been loaded into the Foundational Table, a bubble diagram like FIG. 80 is displayed showing the distribution of the possible locations of Ball bB relative to the pen. (The bubble centroids are likely to form a rectangular pattern to reflect a systematic sampling across the pen, such a sampling is not required.) A concerned party alters one or more target bubble sizes to be reflective of a 50% probability that Ball bB is within three ball lengths of the lower-left-hand corner. The CIPDC weights the Foundational Table rows. The concerned party then views the resulting distributions of the locations of Balls bA and bC and takes appropriate actions.

From the foregoing and as mentioned above, it will be observed that numerous variations and modifications may be effected without departing from the spirit and scope of the novel concept of the invention covering a self-contained device incorporating an internal bladder positioned within the device and in fluid communication with and a nozzle into a single device. It is to be understood that no limitation with respect to the specific methods and apparatus illustrated herein is intended or inferred. It is intended to cover by the appended claims all such modifications as fall within the scope of the claims.

I claim:

1. A computer-implemented method for generating scenarios for subsequent use comprising the following steps:
Obtaining at least two Weighting EFDs;
Accessing data contained in a Foundational Table;
Determining bin weights that resolve non-convergence conflicts between two said Weighting EFDs and said accessed data contained in said Foundational Table;
Using said bin weights to determine a first at least one weight for a first at least one row of said Foundational Table;
Using said bin weights to determine a second at least one weight for a second at least one row of said Foundational Table;
Providing said first at least one weight, said second at least one weight, said first at least one row of said Foundational Table, said second at least one row of said Foundational Table as at least two scenarios in a form suitable for an entity that subsequently uses said at least two scenarios.

2. A computer-implemented method to share risk between at least two parties comprising the following steps:
Accepting an ac-Distribution, comprising at least two bins, from each of said at least two parties;
Accepting a contract quantity from each of said at least two parties;
Using said accepted ac-Distributions and said accepted contract quantities to determine a PayOffMatrix comprising at least two rows and at least two columns;
Determining which of said at least two bins subsequently manifests;
Arranging a transfer of consideration based upon said PayOffMatrix amongst said at least two parties.
